(19) United States
(12) Patent Application Publication
(10) Pub. No.: US 2012/0143383 A1
(43) Pub. Date: Jun. 7, 2012

(54) ENERGY-EFFICIENT UTILITY SYSTEM UTILIZING SOLAR-POWER

(75) Inventors: PAUL H. COOPERRIDER, GARDEN CITY, ID (US); DAVID GONZALEZ, BOISE, ID (US); SETH JAMISON MYER, MERIDIAN, ID (US)

(73) Assignee: INOVUS SOLAR, INC., BOISE, ID (US)

(21) Appl. No.: 13/293,094

(22) Filed: Nov. 9, 2011

Related U.S. Application Data
(63) Continuation-in-part of application No. 13/128,395, filed on Oct. 6, 2011.
Application No. 13/128,395 is a continuation-in-part of application No. 12/533,701, filed on Jul. 31, 2009.
Application No. 12/533,701 is a continuation-in-part of application No. 12/025,737, filed on Feb. 4, 2008, now Pat. No. 7,731,383.
(60) Provisional application No. 61/456,579, filed on Nov. 9, 2010.
(60) Provisional application No. 61/456,549, filed on Nov. 9, 2010.
(60) Provisional application No. 61/456,574, filed on Nov. 9, 2010.
(60) Provisional application No. 61/456,575, filed on Nov. 9, 2010.
(60) Provisional application No. 61/456,576, filed on Nov. 9, 2010.
(60) Provisional application No. 61/456,547, filed on Nov. 9, 2010.
(60) Provisional application No. 61/456,548, filed on Nov. 9, 2010.
(60) Provisional application No. 61/456,554, filed on Nov. 9, 2010.
(60) Provisional application No. 61/456,555, filed on Nov. 9, 2010.
(60) Provisional application No. 61/456,556, filed on Nov. 9, 2010.
(60) Provisional application No. 61/456,577, filed on Nov. 9, 2010.
(60) Provisional application No. 61/456,578, filed on Nov. 9, 2010.
(60) Provisional application No. 61/114,993, filed on Nov. 14, 2008.
(60) Provisional application No. 61/137,437, filed on Jul. 31, 2008.
(60) Provisional application No. 61/137,434, filed on Jul. 31, 2008.
(60) Provisional application No. 61/137,433, filed on Jul. 31, 2008.
(60) Provisional application No. 61/190,192, filed on Aug. 27, 2008.
(60) Provisional application No. 60/888,002, filed on Feb. 2, 2007.

(51) Int. Cl. G05F 5/00

(52) U.S. Cl. 700/295

(57) ABSTRACT

Utility units each have a pole, a solar engine, lighting or other loads, and a controller. The controller senses and controls processes mainly on-pole, but a unit/pole may additionally communicate and/or receive/send control signals from/to poles with which they are networked and/or from a control station. Each pole/network may be adapted for energy-efficient operation of various loads; energy-metering; grid-cooperation; self-diagnostics; overriding of errors/signals to prevent abnormal operation; and/or coordinated activities between poles. Networks may be wireless or wired, or a portable temporary device may monitor pole(s). Active control includes detection of sensor signals or other operational data, which triggers the controller to modify operation of one or more devices/systems on the pole to maintain energy efficiency and operability in spite of malfunctions, abnormal signals or environments, cloudy/diffuse-light weather, or other non-standard conditions.

This application claims benefit of Provisional Application Ser. No. 61/456,579, filed Nov. 9, 2010, entitled “Infrastructure (or light) pole with intelligent override methods”, Application Ser. No. 61/456,549, filed Nov. 9, 2010, entitled “Infrastructure (or light) pole with self-diagnostics”, Application Ser. No. 61/456,574, filed Nov. 9, 2010, entitled “Network of poles with coordinated activities”, Application Ser. No. 61/456,575, filed Nov. 9, 2010, entitled “Device for temporary remote monitoring of solar-powered infrastructure (or light) poles”, and Application Ser. No. 61/456,576, filed Nov. 9, 2010, entitled “Device that converts solar energy to metered power for peripherals”, the disclosures of which are all incorporated herein by this reference. This application also claims benefit of Provisional Application Ser. No. 61/456,547, 61/456,548, 61/456,554, 61/456,555, 61/456,556, 61/456,577, and 61/456,578, all filed on Nov. 9, 2010, the disclosures of which are all incorporated herein by this reference. This application is a continuation-in-part of U.S. Non-Provisional Application Ser. No. 13/128,395, which is a 371 National Phase Entry of PCT/US2009/64659 claiming priority of U.S. Provisional Patent Application Ser. No. 61/114,993, filed Nov. 14, 2008, entitled “Energy Efficient Lighting Control,” wherein the entire disclosures of applications Ser. Nos. 13/128,395 and No. 61/114,993 are incorporated herein by this reference; and this application is also a continuation-in-part of U.S. Non-Provisional application Ser. No. 12/533,701, filed Jul. 31, 2009, entitled “Wireless Autonomous Solar-Powered Outdoor Lighting and Energy and Information Management Network”, which claims benefit of U.S. Provisional Patent Application Ser. No. 61/137,437, filed Jul. 31, 2008, Ser. No. 61/137,434, filed Jul. 31, 2008, Ser. No. 61/137,433, filed Jul. 31, 2008, and Ser. No. 61/190,192, filed Aug. 27, 2008, and is a continuation-in-part of Non-Provisional application Ser. No. 12/025,737, filed Feb. 4, 2008 and issued as U.S. Pat. No. 7,731,383 on Jun. 8, 2010, claiming benefit of Serial No. 60/888,002, filed Feb. 2, 2007, wherein the entire disclosures of the provisional and non-provisional applications of which Ser. No. 12/533,701 claims benefit/priority are incorporated herein by this reference.

### BACKGROUND OF THE INVENTION

The invention relates to utility systems for various services comprising one or more infrastructure poles supporting electric-powered devices and apparatus and methods for efficient energy-management of said devices. Aspects of the invention may be applied to one, multiple, or an array of outdoor lighting or other electric-powered devices, wherein apparatus and methods are provided for monitoring and managing said device(s) as a means to provide lighting, security, environmental monitoring, and/or other utilities or services, and, optionally, for analyzing information gathered from said devices/array for dissemination to customers such as the public, commercial entities, or government.

### SUMMARY OF THE INVENTION

The invention is an energy-efficient utility system comprising at least one utility unit comprising an infrastructure pole and at least one electrical load powered by one or more power sources, such as a solar panel, an electrical grid, and/or an energy storage unit (ESU) that may be charged by the solar panel, the electrical grid and/or other power sources. The electrical load may be one or more lights, security cameras or other security equipment, sensors, electronic displays, alarms, and/or other electrically-powered devices.

Certain embodiments comprise a controller located on or in the utility unit that conducts two-way communication (typically wired) with the electrical load(s) and two-way communication (typically wireless) with one or more other utility units in a network. Certain embodiments may include one or more controllers of utility units, or of a network of utility units, conducting two-way communication with a control station comprising, for example, a multiple-protocol gateway and internet access, and/or other computer(s)/server(s), and which may or may not comprise a headquarters, lab, or control room building. Certain embodiments utilize different bandwidth transmissions between said one or more controllers and the control station, and/or between the multiple utility units of a network, for example, wherein the bandwidth depends on the nature and requirements of the two-way communications of particular electric load(s) installed on the units/poles/network.

In certain network embodiments, multiple utility units may be networked by a wireless mesh network, for communication between the utility units, and between one or more of the utility units and the control station. For example, each utility unit may be a node in a wireless mesh peer-to-peer network, wherein each node can send a message to another node, group of nodes or the entire network. This nearly-instant peer-to-peer communication allows nodes to share information, all while minimizing the amount of energy used via solar-powered batteries (or other ESUs) when off-grid or solar generation offsetting consumption when on-grid. Alternatively, but less preferably a master-slave network may be used, wherein a master unit is the coordinating node that is adapted for the two-way communication between the network and the control station, In either type of network, various types of data may be communicated from the network to a control station, for example, weather and environmental data, energy usage data for all or individual loads, and data from self-monitoring of one or more loads or other systems. In either type of network, various types of data may be communicated from the control station to the network, for example, software, firmware, set-points or sub-routines, video, sound, or other data.

Certain embodiments actively control the utility unit(s)/network, especially the electrical load(s) supported by the units, by a “detect—trigger—action” (or “sense—trigger—control”) model. Detecting conditions in/of the unit(s)/network (self-monitoring or self-diagnostics, for example) and/or detecting conditions around/outside the unit(s)/network (motion, light, weather, pollutants, etc. for sensors, for example) trigger one or more controllers to perform at least one action that changes operation of one or more systems. For example, changing operation of one or more systems typically is done by a change of control setting(s), including, for example:
a) reducing or raising power; turning on or turning off power; selecting/implementing/transmitting data, software, firmware, set-points, sub-routines; and/or alarms;
b) selecting/changing/implementing timing and content of data transmissions from the utility unit(s)/network(s) to a control station;
c) selecting/implementing/transmitting sensor signals or other data communication between utility units of a network for coordinated activities; and/or
d) monitoring load(s) or other systems for overriding/resetting signals, set-points, or sub-routines that may be in error or otherwise abnormal.

Therefore, certain embodiments of the detect-trigger-action model actively control energy usage, and provide public safety, information, and/or other services, while protecting the operability, effectiveness, and energy-efficiency of the utility units. For example, services and actions may be appropriately-timed and prioritized by the detect-trigger-action model, with the most important being sustained even in low-sun-shine periods. Energy storage units, conventionally a vulnerable system for systems not tied to an electrical grid, may be protected from damage, for example, by preventing the ESU(s) from draining below their low-end threshold. Different customers, such as individual, commercial, or government entities, may be served by different electrical loads on the same or multiple utility units, with energy consumption for each load or customer metered for appropriate billing/cost-sharing. Certain embodiments tied to a grid economically manage and meter energy to and from an electrical grid, for example, with load devices being powered by the grid during certain periods and solar-panel(s) contributing energy to the load devices and/or back to the grid during certain periods.

### BRIEF DESCRIPTION OF THE DRAWINGS

FIG. 1 is a front perspective view of one embodiment of a light pole system according to the invention, the light pole being anchored to a concrete base.

FIG. 2 is a side view of the embodiment in FIG. 1, with the decorative light fixture removed.

FIG. 3 is top, cross-sectional view of the light pole of FIGS. 1 and 2, viewed along the line 3-3 in FIG. 2, and illustrating to best advantage one embodiment of an adjustable connection between the light pole and the concrete base, and one embodiment of a battery system provided in the lower section of the pole.

FIG. 4 is a top, cross-sectional view of the battery compartment of FIG. 4, shown with pole and sleeve access doors removed for access to the batteries.

FIG. 5 is a top, cross-sectional view of an alternative battery compartment, without a sleeve and with a single access door through a side of the pole.

FIG. 6 is a top, cross-sectional view of a middle section of the pole of FIGS. 1 and 2, illustrating the preferred flexible photovoltaic panel applied to the outside of the pole, and a sleeve system for cooling the photovoltaic panel and allowing air flow to continue up to the LED light fixture.

FIG. 7 is a top, cross-sectional view of the LED fixture of the embodiment of FIGS. 1 and 2.

FIG. 8 is a side, perspective view of the LED Fixture of FIGS. 1, 2, and 7.

FIG. 9 is a partial, cross-sectional side view of the bottom section of the light pole containing a cooling sleeve and one or more batteries, illustrating natural air flow up through the sleeve. The rain skirt has been removed from this embodiment.

FIG. 10 is a side perspective view of an alternative embodiment of the invention, which comprises a portable light pole with LED fixture, said light pole being hinged to a portable base and so being pivotal from a generally horizontal position for transport or storage to a vertical position for use.

FIG. 11 is a side, perspective view of another embodiment comprising a decorative light fixture at the top of the pole plus an arm and traffic light extending from the pole.

FIG. 12 is a side, perspective view of another embodiment of the invented light pole system for use by a highway, wherein the battery system is buried in the ground instead of being contained inside the pole or inside the base, and wherein the pole may be a break-away pole, both features being for improved safety in the event of a vehicle hitting the pole.

FIG. 13 is a schematic illustration of sunlight hitting the preferred vertical, flexible photovoltaic panel adhered to the light pole, wherein morning and evening light hit the sheet at close to perpendicular to the sheet surface and the noon sunlight hits the sheet surface at an acute angle.

FIG. 14 illustrates the common conception of power production (for example, watt-hours) vs. time that is expected to be produced from a light-active device over a day.

FIG. 15 schematically illustrates the actual power produced (for example, watt-hours) vs. time, by embodiments of the invention, wherein power production from the morning and evening sun is higher than expected. The curve illustrates a power production increase from early morning until mid or late morning, and then a dip in production due top the sharp incident angle of sunlight around noon when the sun rays hit the pole at sharp angles to the photovoltaic panel.

FIG. 16 schematically illustrates that the preferred photovoltaic panel is provided around most of the circumference of the pole, so that said panel is available and catches the suns rays during the entire day.

FIG. 17 is a partial detail view of an alternative, especially-preferred lower pole vent, wherein air is taken in between the pole flange and the base, through spaces between the bolts that secure and raise the pole slightly above the base.

FIG. 18 is a perspective view of an alternative solar-powered light system including a connection (shown schematically) to a utility grid.

FIG. 19 is a schematic of one embodiment of a wireless mesh network according to the invention.

FIGS. 20A-D are schematics of example network processes according to embodiments of the invention, wherein an event is raised and subsequently “passed along” to multiple poles that comprise the best connection pathway at the time, until the NOC coordinator pole (also called the “master node” or “coordinator pole/node”) communicates the event/information to headquarters (also called Network Operations Center or “NOC”).

FIG. 21 is a schematic of a “look-ahead” traffic lighting system according to one embodiment of the invention.

FIG. 22 is a schematic of one lighting unit that may be installed on a pole for one, but not the only, embodiment of a peak load delay energy conservation system, wherein said lighting unit does not comprise a solar panel due to the pole/unit's particular cooperative connection to the electric grid. In alternative embodiments, as discussed later in this document, pole/units that cooperate with the grid may also comprise a solar panel or other renewable energy source for generating energy.

FIG. 23 is a schematic that portrays the general architecture of the preferred population of light poles and other device on or near the light poles and the preferred network according to one embodiment of the invention. The devices at the far left of the figure are devices powered by the solar engine; secure two-way communication is provided by the smart mesh from the far left to the far right of the figures and wide-area aggregation of data/information is performed by content services and provided to customers by the Network Operations Center (NOC) at the far right of the figure.

FIG. 24 is a schematic that portrays various “layers” of the preferred embodiments of the invented array and network systems.

FIG. 25 is a schematic that portrays an “Event Delivery Pipeline” according to one embodiment of the invention.

FIG. 26 is a schematic that portrays a “Device Management Pipeline” according to one embodiment of the invention.

FIG. 27 is a schematic portrayal of a “Light Delivery Stack” comprising reflection, generation, focusing, distribution, and shaping, with the result being light delivered “to the ground”.

FIG. 28 is a schematic portrayal of modular approaches to solar-based electricity generation in embodiments of the invention.

FIG. 29A is one embodiment of a collar that may be used to retrofit a pole with a solar-panel and energy storage. It may be noted that the solar panel is preferably flexible and may be installed on/incorporated into a flexible, semi-rigid, or even a rigid structure as desired for attachment to the pole.

FIGS. 29B and C illustrate connection of the half-cylindrical retrofit collar onto an existing pole, wherein the solar PV panel is on the outside surface of the collar, the collar is mounted to the pole with the PV panel typically facing south in the northern hemisphere, and with wiring from the solar collar to the light fixture.

FIG. 30 is a portrayal of one embodiment of an integral light unit, comprising solar collector fabric panel, LED light engine, battery pack and charger, controller/code unit(s) and modem, so that the entirely or substantially self-contained (“integral”) unit may be attached to a pole without modification of the pole or insertion of apparatus into the pole.

FIG. 31A-C are views of the preferred, but not the only, invented LED module, shown with mounting bracket, wherein multiple of said modules are used to form an LED engine.

FIGS. 32 A-D are views of multiple of the LED modules of FIGS. 31A-C arrangement on a plate/baffle for pointing in one direction or multiple different directions (here, shown pointing in three directions) and for installation in a lighting fixture.

FIGS. 33 A-E illustrates the plate with multiple LED modules of FIGS. 32 A-D installed into a square “shoe-box-style” light fixture.

FIGS. 34 and 35 illustrate basic logic flow diagrams of some embodiments of the active lighting control process, including error/alert indication processes.

FIG. 36 schematically summarizes the operation of the preferred active control system according to embodiments of the invention.

FIG. 37 is a schematic wiring diagram of the preferred active control system.

FIGS. 38 and 39 are side views of the preferred solar-powered pole assembly, with an photovoltaic panel “wrapped” around the round pole, and with a shoe-box-style LED-module luminaire supported at the top of the pole.

FIG. 40 is a plot of the preferred battery charging control process of the active control system.

FIG. 41 is a plot of battery voltage vs. remaining amp-hours, used in preferred embodiments of the active control system.

FIG. 42 is a plot of the current/voltage curve and the power output curve (watts vs. volts) for the preferred charge controller using Maximum Power Point Tracking (MPPT) technology/algorithms, to transfer maximum power to batteries even though PV array and batteries are operating at different volts.

FIG. 43 is a perspective view of the preferred LED module, removed from any attachment bracket and containing four of the preferred LEDs.

FIG. 44 is a plot of expected lifetime vs. junction temperature plot for the preferred LEDs contained in the module of FIG. 42, wherein the preferred LEDs operate close to the 350 mAmp curve for an expected life of over 50,000 hours, and probably approximately 60,000 hours.

FIG. 45A-C are bottom views (looking up from the ground) of three alternative LED modules arrangements, wherein a number of the LED modules of FIG. 43 may be chosen, arranged, and tilted in various ways, to achieve a desired lighting pattern.

FIG. 46 is a plot of luminaire power vs. time, in a normal operating mode for the preferred outdoor lighting system, wherein the preferred active control system turns the light on to full power at dusk for a predetermined amount of time, then dims the light, except for motion-detection events, and the raised light power to full-on for a predetermined amount of time before dawn. This normal operation mode saves energy compared to conventional lighting controls, wherein the light is on all night, and may be further modified according to energy-savings modes that further reduce/control luminaire and other peripheral power.

FIG. 47 is a schematic example of the normal operating mode of FIG. 46 (N1), and example further modifications (E1, E2) for further energy savings. Details of E1 and E2 are given later in this document.

FIG. 48 is a schematic of an example of load-shedding, which may be required for further energy savings, if dimming of the light is not sufficient to protect the batteries and operability of the system.

FIG. 49 is a plot of photovoltaic cell efficiency vs. time, for many types of PV cells, wherein the currently-preferred PV materials are in the range of about 10 to about 20 percent efficiency, for example, material C1 at about 12-19 percent efficiency.

FIG. 50 is a plot of test data from a solar-powered pole operating without any tie to the grid, wherein the light met lighting needs through many weeks of sky cover (clouds, overcast) in a safe range for the batteries.

FIGS. 51A and B are a plot (split onto two sheets) of operation of six solar-powered poles, without any tie to the grid, operating according to an embodiment of the active control system, wherein the poles successfully met lighting needs through many weeks of low sunshine days, even through January, when the light poles met said lighting needs by being dimmed according to energy-savings modes described later in this document.

FIGS. 52A-D are schematics of one embodiment of a coordinated activity of networked poles of a utility system, that is, one embodiment of a one “light halo” that may be conducted by a peer-to-peer network, for example.

FIG. 53 is a schematic of another embodiment of a coordinated activity of networked poles, that is, one embodiment of a “video following” activity.

FIG. 54 is a schematic of another embodiment of a coordinated activity of networked poles, that is, one embodiment of “pollutant mapping”.

FIG. 55 is a schematic of one embodiment of elements, connections, and functionality of a temporary monitoring device, wherein the device may be taken to a utility unit/pole (typically a unit/pole not comprising wireless communication to a control station or the internet) for temporary or occasional monitoring/testing of the unit/pole.

FIGS. 56A and B are perspective views of one embodiment of the temporary monitoring device portrayed in FIG. 55, wherein FIGS. 56A and 56B are a front perspective and a rear perspective view of the device, respectively.

FIG. 57 is a schematic of one embodiment of elements, connections, and functionality of an energy metering system for metering and reporting the energy consumption of various electrical loads.

FIG. 58 is a schematic of one embodiment of a multi-load peer-to-peer network, comprising both narrowband and broadband communication mesh networks matched to the requirements of the various loads, and a multi-protocol gateway to an internet and cloud service.

FIGS. 59A and B are side perspective views of an autonomous utility unit without a grid tie, and a grid-tied utility unit, respectively, such as may be used in the network of FIG. 58.

FIG. 60 is a side perspective view of a grid-tied utility unit, generally of the type of FIG. 59B, wherein multiple loads and load connection-points are portrayed.

### DETAILED DESCRIPTION

A utility system comprises one or more utility units, which each comprise a pole, plus one or more solar panels, one or more electrically-powered loads, one or more energy storage units (ESU) and/or an electrical grid tie, and a control system, which are preferably on or in the pole or closely adjacent to the pole. Each utility unit is also called herein a “pole” due to a pole being the preferred infrastructure holder/support for most or all of the elements of the utility unit. In most instances wherein the term “pole” is used, therefore, the term refers to the utility unit with its various elements of apparatus, controller(s) and adaptations for providing services, rather than only the upending elongated pole member. Instances in which the upending pole member itself is being referred to will be readily apparent from the context.

The control system may comprise built-in intelligence for energy-saving processes, energy-storage management, array-grid cooperation, public-safety services, WIFI, advertising or information dissemination, and environmental data gathering. Said built-in intelligent control may supplement the operation of a single unit/pole or multiple units/poles, and is especially effective in networked arrays.

Certain embodiments of intelligent control may take the form of “detect-trigger-action” apparatus and control, which allows responses to changes in the environment of the unit or array, or to changes in or abnormal performance of the equipment of the unit/array. Certain embodiments of detect-trigger-action apparatus and control may even anticipate changes or problems in the environment or equipment, for example, based on historical data and/or algorithms. Certain embodiments of intelligent control for some or all individual utility units/poles, or for various types of networked arrays, manage energy-consumption and/or energy-storage to ensure that priorities are maintained even in low-sunshine periods and that important systems such as energy storage units (ESUs) are protected. Certain embodiments of intelligent control, especially those providing task- and information-sharing for networked arrays, allow self-diagnostics, signal/error overriding capabilities, and/or coordinated activities that enhance operation of the utilities/services in general, and specifically, in many embodiments, energy conservation and public safety.

One or more utility units may be provided in a wide range of environments, ranging from remote/underdeveloped rural and village area and public lands, to individual properties desiring solar-powered services, to well-developed towns and cities. The services provided by the utility units may include, for example, one or more of lighting, security, alarms, displays, advertising, WIFI, environmental sampling/sensing stations, or other utilities/services. In remote or relatively-undeveloped areas, one or more units typically will work independent of each other or may be networked, and, in many embodiments, the independent or networked units will typically be independent of any grid. In populated or relatively-well-developed areas, multiple units will typically be networked, and optionally linked to a control station (broadly defined as a gateway, computer/server and/or internet entity, with or without a building) and/or the grid.

Whether the installation comprises a single unit/pole, multiple units/poles, or a networked array of units/poles, certain embodiments of these installations may provide efficient infrastructure for physical and electrical support of multiple utilities/services. This may be very beneficial for many environments, as the multiple utilities/services may be supported and made operable in one format, that is, on a single unit/pole or the units/poles of a networked array, instead of in different formats and structures. In other words, certain embodiments of the invention may replace or prevent the clutter and confusion of having a separate infrastructure system for each utility/service. Multiple electrically-powered devices may be “plugged in” by operative-connections to one or multiple units/poles, in effect, creating a modular and universal utility system that is operable and controllable in an organized and efficient manner. Certain embodiments of the networked arrays of the invention may accept a virtually unlimited number of units/poles, with some or all of the units/poles may be connection points for lights and/or other electrical devices, further adapting the networked arrays to be efficient and organized infrastructure for utilities. Grid-tied embodiments may cooperate with a conventional electrical grid by supplementing the grid with renewable power production and receiving energy back during non-peak-grid-usage hours, further enhancing reliability and economy of the utilities provided on the units/poles and of the electrical grid itself. Metering of energy to the grid, energy from the grid, and/or energy consumed by the individual electrically-powered devices (whether they are supported on a single or different poles), allows appropriate bookkeeping and billing for the energy different parties who provide or use the energy, and provide or use the different devices, for example.

Certain networked arrays operate in an independent mesh network, wherein sensing, communication, and control processes take place between the various utility units/poles of the array but not between the array and a control station. These arrays may be called “independently-networked-arrays” or “independent networks”, for example. Certain networked arrays operate in a remote-control mode, or at least a remote-monitor mode, wherein, besides sensing, communication, and control taking place between units/poles of the array, further communication and/or control take place between the array's mesh network and a control station (for example, remote computer/server, gateway and/or internet entity, with or without a building) These arrays may be called “control-station-networked-arrays” or “control-station networks”, for example. The intelligent control supplied by the control station may be supplemental to, or replace portions of, independent-mode intelligence of the array.

An example of a wireless mesh network comprises multiple wireless nodes (said utility units/poles) that communicate bi-directionally with each other and/or with the control station using narrowband data transmission rates or broadband data transmission rates, wherein communications are peer-to-peer. Any wireless node can communicate with any other wireless node, including the control station, for two-way gathering and dissemination of data and/or analysis of data. In turn, the control station may communicate bi-directionally with the internet. As each unit/pole/wireless node may have one or more load devices that may sense or otherwise gather data, and because the units may be spread out over large regions and operate over large expanses of time, the data-gathering capabilities of these networks are great.

Another example of a mesh network linked to a control station may comprise multiple slave nodes that communicate with each other, and wherein some or all of the slave nodes also communicate with a master node that transmits and receives signals to/from the control station preferably via wireless transmission such as cell phone and/or satellite. The slave nodes may also be called “slave units”, “slave poles” or “slave devices”, and the master node may also be called “coordinating node”, “master unit”, “master pole” or “master device”. Thus, the control station may communicate with the master node, and the master node communicates to the multiple slave nodes of the array (optionally, with some slave nodes being intermediaries between the master node and other slave nodes) rather than each slave node being controlled individually and directly by the control station. Thus, the multiple slave nodes of the array are preferably connected to, and engage in two-way communication with, only the master node (or with an intermediary slave node), rather than each slave node being connected directly to, and communicating directly with, a control station. This way, the networked array may be tied to the control station server for two-way gathering and dissemination of data and/or analysis of data. Again, the units of such a network may be spread out over large regions, the data-gathering capabilities of certain networks are great.

An intelligent control feature that may be included in networked arrays is adaptation to allow nodes to be added in the future, that is, after the initial system has been installed, and for these nodes to be automatically integrated to the network via “self-discovery” in which they are each assigned a unique location identification (ID). The self-discovery system, and assignment of location ID, may be accomplished via a global positioning system (GPS) system tool that identifies the latitude and longitude of the node location.

Therefore, certain embodiments of the invention may comprise solar panels, one or more loads (such as lighting, security equipment, environmental sensing equipment, transmitters/transceivers, WIFI equipment, advertising or informational display, alarms, and/or other electrically-powered load devices), energy storage equipment, and control systems (or broadly “a controller”) comprising hardware, firmware and/or software for intelligent control and operation of individual units/poles or networks. Preferred embodiments are described in the following disclosure, but it is to be understood that the invention may be embodied in many different ways within the broad scope of the claims, and the invention is not necessarily limited to these details, materials, designs, appearances, and/or specific interrelationships of the components.

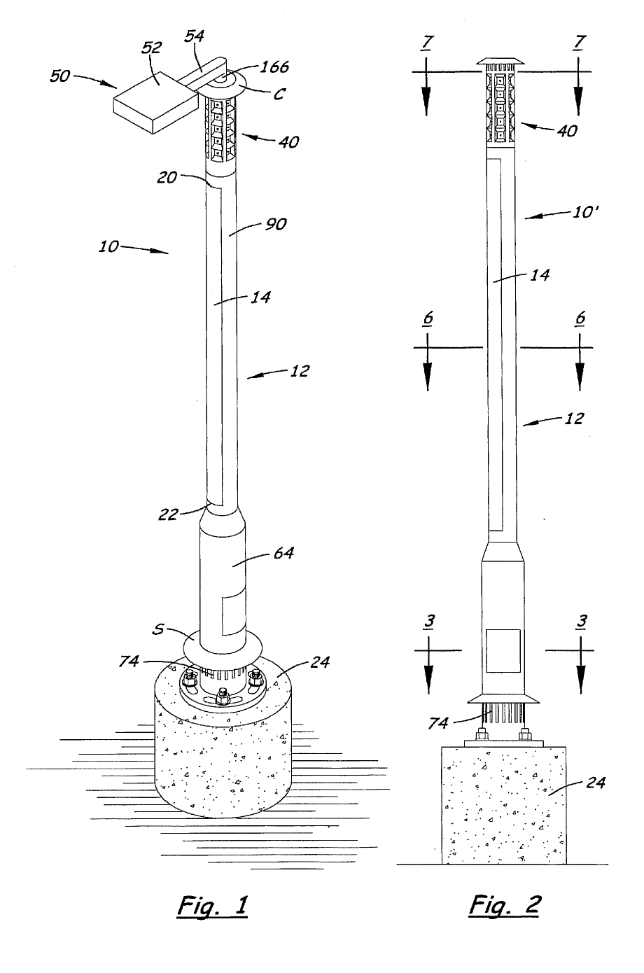

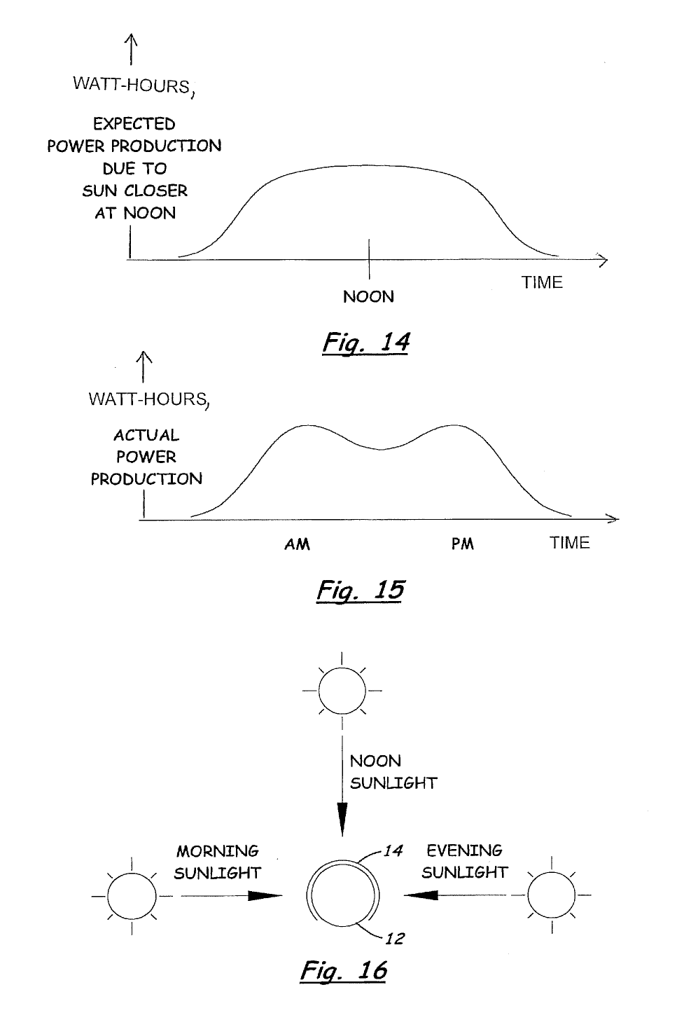

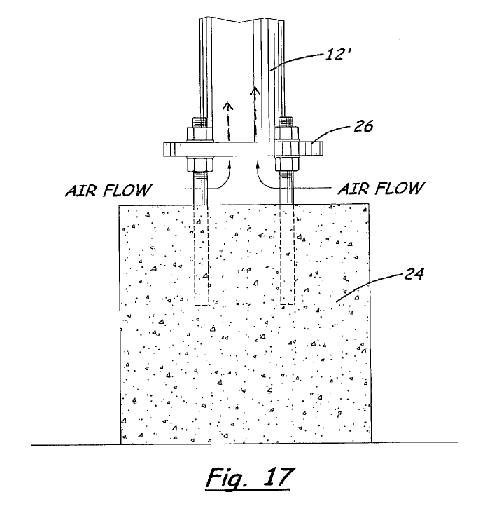

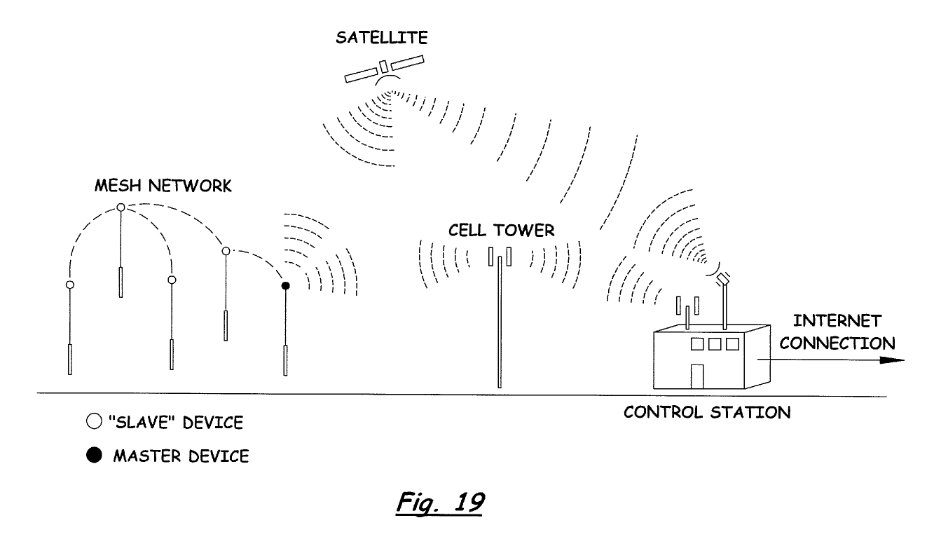

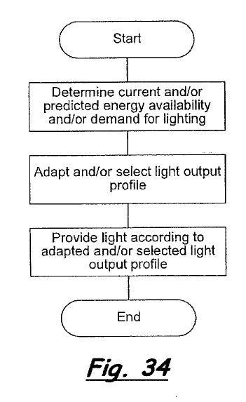

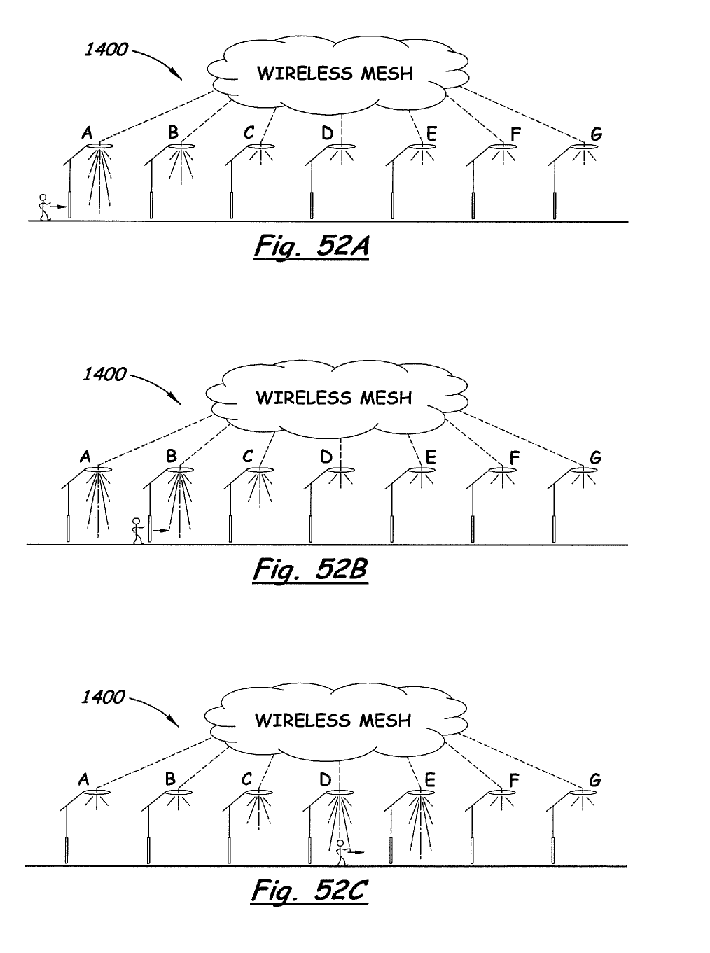

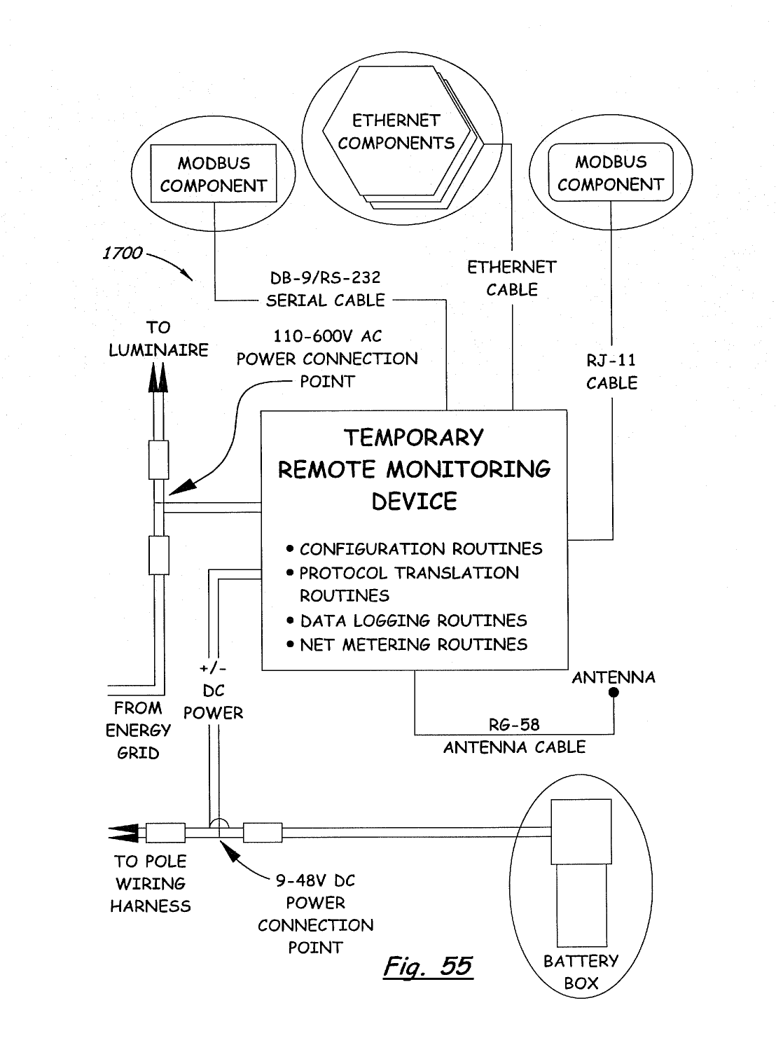

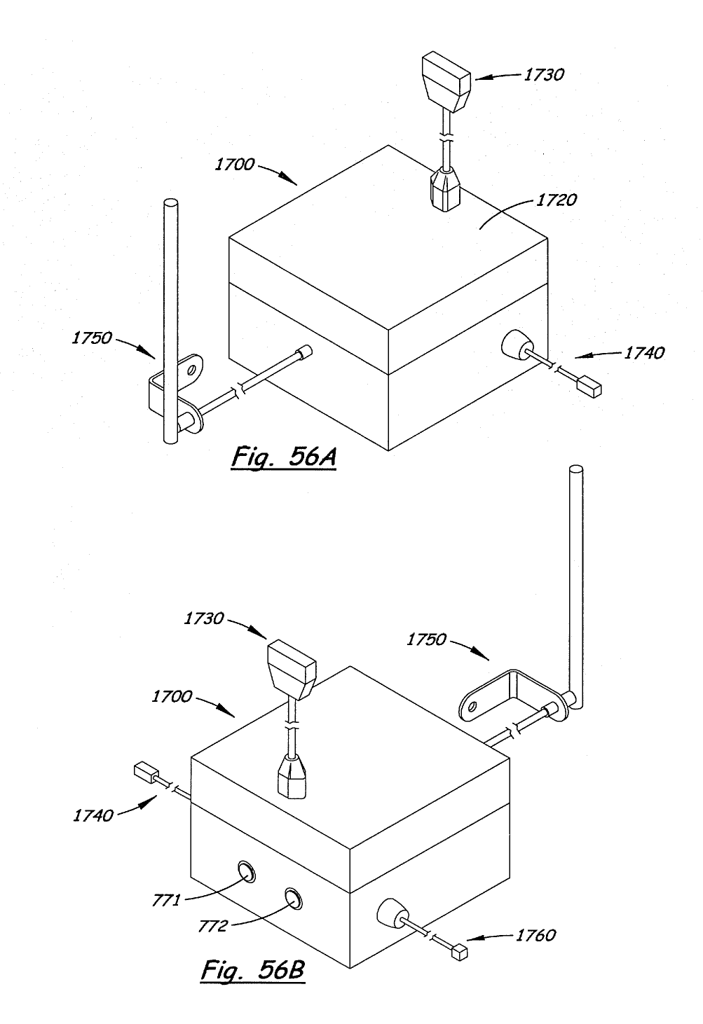

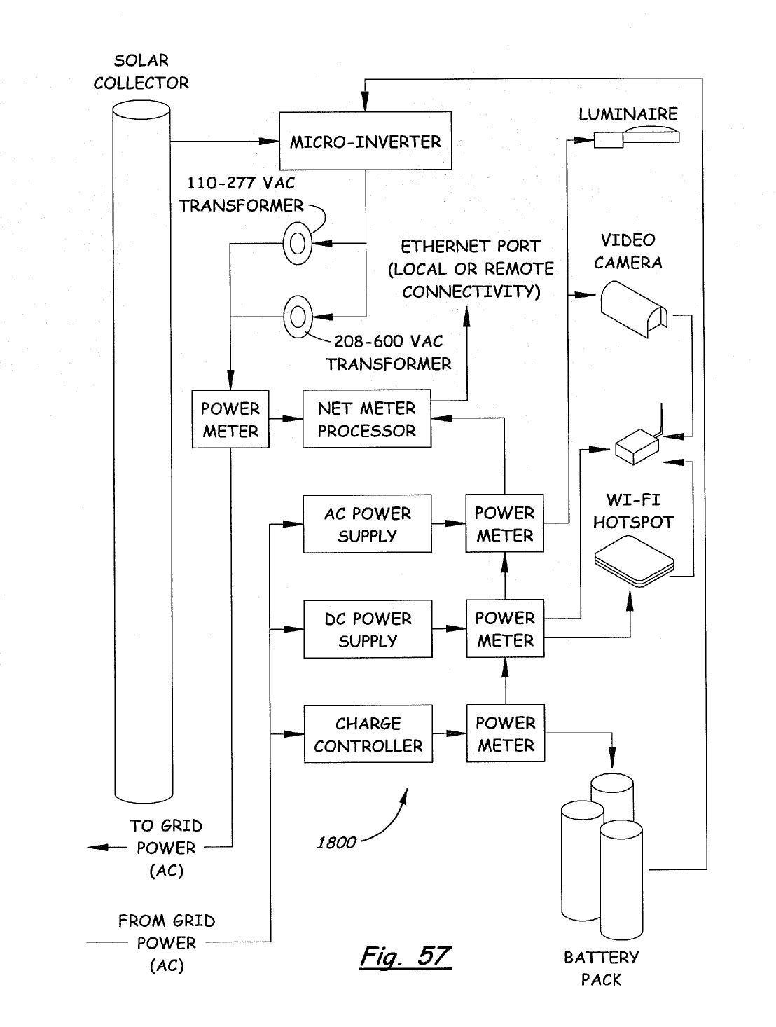

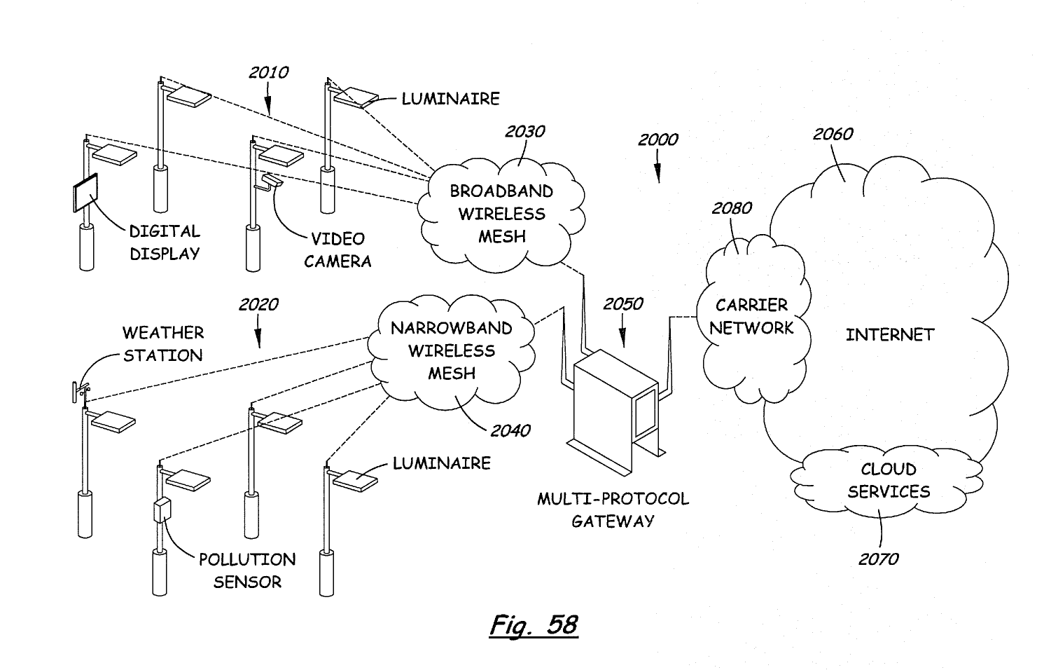

Referring specifically to the Figures, there may be seen some, but not the only, embodiments of the invention. FIGS. 1-18 portray some, but not the only, embodiments of solar-powered utility poles and lights that may form a “population” of poles for arrays and networks and/or that may be implemented as single or multiple, non-networked utility poles. FIGS. 19-33E schematically portray some, but not the only, embodiments of arrays of outdoor lighting and other powered devices that are preferably managed as embodiments of the invented wireless intelligent outdoor lighting system (WIOLS) and that are preferably autonomous in that they may be operated at least part of the time by power other than the electrical grid. Included in FIGS. 19-33E are portrayals of management and monitoring processes, layering of capabilities and apparatus that make the preferred network possible, light-capture schemes, and LED module and light fixture options. The LED-module-light-fixture options may comprise conventional-appearing light fixture housings fit with embodiments of the invented LED modules, which may be used in addition to, or in place of, the “in-pole” LED light fixture featured in FIGS. 1-18, for example. Included in FIGS. 34-51B are portrayals of method steps, programming, and apparatus for the preferred outdoor lighting/utility system that is actively controlled to achieve surprising results even over extended periods of cloudy and overcast winter days. FIGS. 34-51B include examples of the results achieved with the preferred embodiments of active control, even while using a photovoltaic cell material that is nominally low-efficiency when compared to many non-amorphous PV cell materials, but that is very effective in cloudy or overcast (“shady”) environments. FIGS. 52A-C through 54 include examples of coordinated activities of networked utility units. FIGS. 55 and 56A and B portray an example of a temporary monitoring device that may be taken to a utility unit/pole to check performance of, or gather data from, the unit/pole, especially for units/poles not having the capability to communicate diagnostics and other data wirelessly to a distant computer/station. FIG. 57 portrays an example of an energy metering system that allows multiple loads to be metered and billed separately. FIGS. 58-60 portray examples of wirelessly-meshed utility units that are linked to internet/cloud services, wherein the utility units may be autonomous or connected to the grid and may comprise multiple connection points for multiple loads.

### Solar-Powered Light Pole Apparatus:

There is a need for an outdoor utility system, for example an outdoor lighting system, that is highly efficient in collecting and storing energy from the suns rays, and in using said energy over several nights to light a surrounding area even through inclement, overcast periods of time. Certain embodiments utilize a cooling system that may greatly increase battery life and efficiency of the entire system. Certain embodiments also utilize efficient, versatile LED light fixtures that may be used for all or nearly all street light styles without the need to separately engineer LED fixtures for each lamp/fixture style desired by the public, government, or neighborhood. Certain embodiments have a visually-integrated appearance, preferably without flat panels of solar cells, and preferably with minimal or no unaesthetic protuberances and exposed equipment.

The preferred solar-powered outdoor lighting utilizes a photovoltaic panel(s), for example photovoltaic laminate (PVL), and light-emitting diodes (LEDs) to produce light, over a several-night period even during inclement, cloudy, or overcast weather conditions. In one embodiment, the invention comprises a light pole having a vertical portion covered by a flexible photovoltaic panel for being contacted by sunlight, and an LED light fixture powered by said photovoltaic panel via a battery or other energy storage device. The preferred flexible panel is a sheet of flexible thin-film photovoltaic material(s) surrounding a significant portion of the circumference of the pole at least in one region along the length of the pole, and, preferably along the majority of the length of the pole. The light pole is specially-adapted for cooling of the photovoltaic panel and the batteries contained within the pole, if any. In embodiments wherein the LED light fixture is “in-pole,” as described below, the pole also may be specially-adapted for cooling the LED light fixture. Said cooling may be important for achieving the high efficiencies of power production and storage, over long equipment lives.

The pole may be similar in exterior appearance to conventional light poles, in that the pole profile is generally smooth and of generally the same or similar diameter all the way along the length of the pole. The photovoltaic panel fits snugly against the pole outer surface and requires no brackets, racks or other protruding structure. In FIGS. 1, 2, 7, 8, 10-13, and 18, the LED fixture is at or near the top of the pole, is generally a vertical cylinder of the same or similar diameter as the pole, and may be convectively cooled by air flow up through the pole. This “in-pole” style of LED fixture eliminates the need for the difficult engineering task of adapting the many common styles of outdoor light fixtures to use LEDs. Further, because the preferred battery system is concealed either inside the pole, inside a base holding the pole, or buried below the grade level of the ground or street, there is no need for a large box or protruding battery structure on or near the pole.

In the event that the purchaser or public wish the lighting system to match or be reminiscent of previously-installed or other conventional street lights, a conventional-looking lighting fixture may be provided in addition to or instead of the preferred LED fixture. Said conventional-looking lighting fixture may extend horizontally or from atop the pole, and may be purely decorative, may have a minimal or token light-emitting device therein, or may be the main or only light source. Decorative or traditional light fixtures may more easily meet with approval from the public and/or may blend in with traditional street lights that remain in an area. By using a combination of the LED fixture and a decorative fixture, the single LED light-producing section may be engineered and installed, while preserving various aesthetic options for the city, county, or neighborhood and/or while allowing the new solar-powered lights to “blend in” with the street lights already in place. Further, decorative-only light fixtures may be light-weight and designed to break-away in high winds or storms, thus minimizing the damage to the pole, surrounding property, and/or people.

In the “in-pole” light fixture of FIGS. 1, 2, 7, 8, 10-13, and 18, the array of LEDs emit light from at least three and preferably four generally vertical sides of the fixture. The LED light fixture may emit light out in patterns extending 180 degrees-360 degrees around the fixture, for example. The LED fixture comprises heat exchange or other cooling means in order to lower the temperature of the LEDs and the associated equipment.

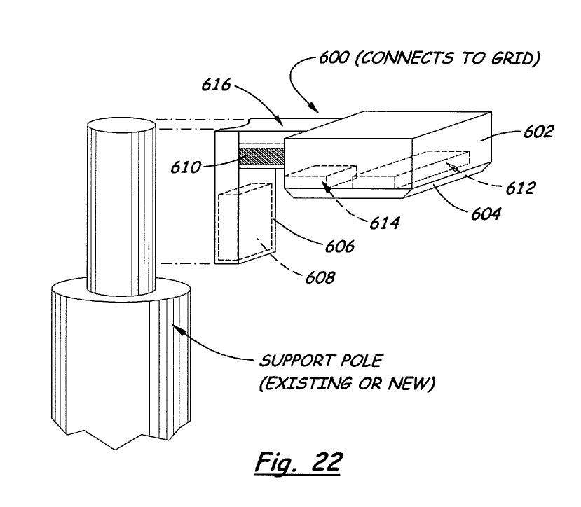

Other examples of invented light fixtures are described later in this document and are shown in FIGS. 22, 29, and 30-33E, which fixtures do not have LEDs and lenses on three or four sides and do not necessarily have vertical LED groupings. Instead, fixtures may have adjustable-direction LED modules that may be directed to emit light in various directions for fine-tuning to desired light patterns.

In another embodiment, an outdoor light pole, having the features described above, is provided on, and hinged to, a portable base. In such an embodiment, the battery system may be located in, and provide additional weight for, the base.

In some embodiments, the solar-powered outdoor utility system, for example, the outdoor lighting system, is connected to the utility grid, so that the photovoltaic panel may provide energy to the grid during peak-demand daylight hours, and so that, if needed or desired, low cost night-time electricity may be provided by the grid to the electrically-powered device(s) such as the outdoor lighting, to power the device(s) and/or charge batteries or other energy storage units (ESUs). In some grid-tied embodiments, no ESUs are needed, but, in others, ESUs are provided that may also be charged during the daylight hours, for providing power to the lighting system during the night hours, and/or providing power to the lighting system in the event of a grid failure or natural catastrophe that interrupts grid power supply.

Venting and/or air channels may be provided in the pole to allow cooling by natural convection air flow through the pole and the light fixture. Heating equipment may be provided in one or areas of the pole to protect equipment and/or enhance operation during extreme cold.

Referring now specifically to FIGS. 1-18, there are shown several, but not the only, embodiments of the apparatus that may be used in invented lighting systems and/or in other utility systems. FIG. 1 portrays one embodiment of a solar-powered street light 10, comprising a pole 12 with a panel 14 of thin-film photovoltaic material attached thereto. The panel 14 may be selected from commercially-available amorphous silicon (non-crystalline) photovoltaic materials, or other photovoltaic materials, which produce electrical energy when exposed to sunlight. One source of material for the panel 14 is Uni-Solar (United Solar Ovonic), which flexible, non-framed laminates that may be used in embodiments of the invention, under the name of UNI-SOLAR® “solar laminates” or “photovoltaic laminates.”

While currently-available flexible photovoltaic laminates, such as the UNI-SOLAR solar laminates are preferred, it is envisioned that thin-film light-active materials being developed, or to be developed in the future, may be used in certain embodiments of the invention, wherein said materials being developed or to be developed may be used in the place of the panel 14 described herein. For example, it is envisioned that photovoltaic material may be applied directly to the pole 12 in the form of a liquid having components that later polymerize or “set up” on the pole and retain the photovoltaic material on said pole. Thus, the flexible photovoltaic panels described herein may be provided as a flexible sheet attached to the pole, or as other thin-film materials applied to the pole and taking the form of the pole, that is, preferably curving at least 90 degrees around the pole, and, more preferably, at least 180 degrees or at least 225 degrees around the pole.

The panel 14 preferably is a thin, flexible sheet that is preferably adhered to the pole by adhesive. The panel 14 may be a single, continuous sheet with “self-stick” adhesive on a rear surface, and that, upon peeling off of a protective backing, may be directly applied to the pole. The integral adhesive makes attachment of the panel 14 simple and inexpensive. No bracket, rack, covering, casing, or guard is needed over or around certain embodiments of the panel, and this simplicity of attachment preserves the aesthetics of the preferred slim and smooth profile of the pole. Less-preferably, multiple, separate panels may be adhesively applied to the post 12 and operatively connected.

The preferred panel 14 extends continuously around the pole along a significant amount of the circumference (for example, at least 90 degrees, and preferably at least 225 degrees and more preferably about 270 degrees) of the pole in order to be directly exposed to sunlight all through the daylight hours. The coverage illustrated in FIGS. 13-16, for example, will expose the panel 14 to the suns rays generally from sunrise to sunset, in order to maximize solar-power generation. The panel 14 preferably covers ½-¾ of the length of the pole, extending from its upper edge 20 at a location near the top of the pole to its lower edge 22 several feet above the base 24 supporting the pole. It is preferred that the lower edge 22 be high enough from the ground or street level that passers-by or vandals cannot easily reach the panel 14 to cut, pry off, or otherwise damage the panel.

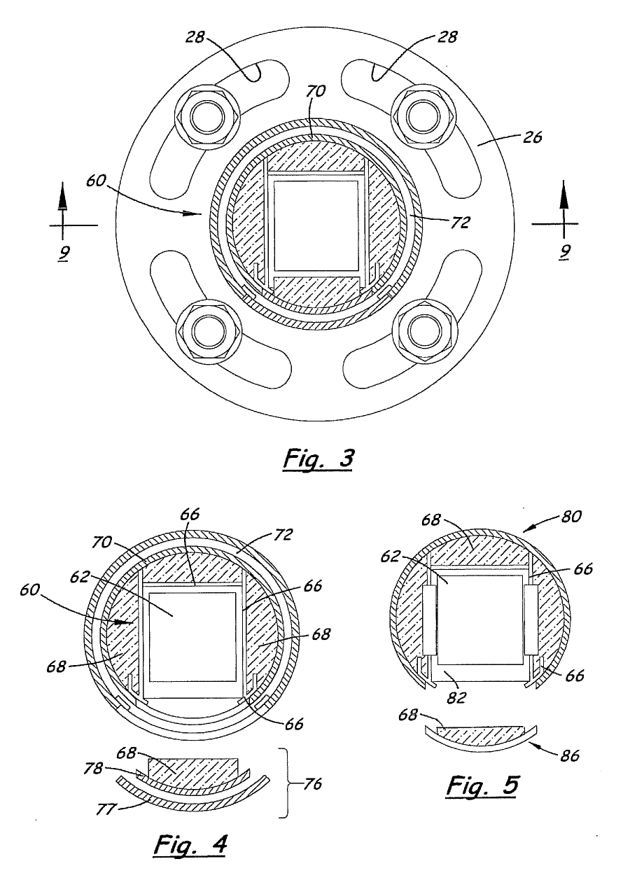

Connection of the pole 12 to the base 24 may be done in various ways, each typically being adjustable so that, at the time of installation, the pole may be turned to orient the panel 14 optimally to catch sunlight through the day. The adjustable connection, shown in FIGS. 1 and 3 to best advantage, includes a pole base flange 26 having multiple, curved slots 28 through which bolts extend, so that the bolts may be tightened to secure the pole to the base 24 after the pole is rotated to the desired orientation. The connection of the decorative light fixture (50, discussed below), may also be adjustable, so that, given any orientation of the pole, the decorative light fixture may be secured/tightened to point in the desired direction, for example, over a street or sidewalk.

The main, or only, light-producing unit of street light 10 is a light-emitting diode (LED) fixture at or near the top of the pole 12. LED fixture 40 has a cylindrical outer surface and is coaxial with, and of generally the same diameter as, the upper end of the pole 12. This LED fixture, as will be discussed further below, may emit light out in a 360 degree pattern, or, may be adapted by LED and/or reflector placement and shape to emit various patterns of light as needed for a particular setting.

Decorative light fixture 50 is portrayed in FIG. 1 as a box-style fixture on a horizontal arm, but may be other fixtures. The decorative light fixture 50 comprises a housing 52 and connecting arm 54 that are the same or similar to conventional fixtures. The decorative light fixture 50, however, has no internal or external workings to produce light, no bulb and no wiring, as the fixture 50 is merely a “token” or “fake” light fixture simulating the appearance that the public is used to. The decorative light 50 may have a conventional lens that contributes to the fixture looking normal during the day. Alternative decorative light fixtures may be provided, for example, a “gas lamp” glass globe that extends up coaxially from the LED fixture 40, or a curved-arm with conical housing 60 as shown in FIG. 12.

The inclusion of a decorative fixture may make the overall appearance of the street light 10 more desirable for the public or the governmental/transportation agency installing and maintaining the street light 10. This may make the overall appearance of the street light 10 match or complement pre-existing fixtures or the style or desires of a neighborhood. Having a decorative light fixture 50 may be reassuring and comforting to the public, as they will automatically recognize the street light 10 as a light for public safety, rather than worrying that the structure is an antenna or transmitter, surveillance structure, or some other undesirable structure in the their neighborhood, for example.

Alternatively, the decorative light fixture 50 may be adapted to provide some light output, for example, a single LED or other minimal light source to further enhance the aesthetics of the street light 10. Such a minimal light source will light the interior of the housing and/or the fixture lens, to prevent the decorative fixture from appearing to be burnt-out, and to suggest to passers-by that the fixture 50 is indeed providing light as is customary and comfortable for the public. Said decorative light fixture 50 may comprise said a minimal light source, for example, accounting an amount of light in the range of about 2-20 percent, with the LED light fixture provide the rest of the light from the system 10, 10′.

FIG. 2 illustrates the light pole in use with the decorative, non-lighting or minimally-lighting fixture 50 removed, in which form the street light 10′ is fully functional for providing the desired amount of light for the street or neighborhood by means of the LED fixture 40. This version of street light 10′ has, therefore, no significant protrusions from its elongated, vertical structure, and has a slim, sleek appearance that, over time, may become preferred for many settings.

FIG. 3 illustrates the adjustable connection of the pole 12 to the base 24, and shows the internals, in cross-section, of the storage system 60 with batteries 62 stored in the lower section 64 of the pole and operatively connected to the panel 14. The batteries 62 of this non-grid-tied embodiment store the energy provided by the solar panel during the day or previous days, and power the LED fixture 40 during the night. The battery system is adapted to store enough energy to power, when fully charged, the LED fixture 40 for several nights with little or no additional charging and without any outside energy input. The battery system preferably stores enough energy to power the LED fixture for at least 5 nights and, more preferably, 5-9 nights equating to at least 50 hours, and preferably about 50-100 hours or more depending upon the number of hours in a night. Thus, certain embodiments of street light 10, 10′ are capable of autonomously illuminating (that is, at least part-time operation from energy provided by the stored energy from solar collection) the surroundings for several, and preferably at least 5 nights, even when the light 10, 10′ is located in an overcast, inclement, hazy or smoggy location, all of which conditions will diminish the intensity of the daytime sun hitting the panel 14. In other words, the large amount of energy stored in the batteries during days of clearer weather is sufficient to “carry the light through” cloudy and inclement weather for about a week, until improved sunlight conditions return. The preferred amorphous thin-film panel 14 is more shade-tolerant than conventional crystalline solar cells, and is therefore expected to be more efficient and effective than banks or racks of crystalline solar cells.

Alternative embodiments may use other energy storage units (ESUs) for storing energy from the solar panel. For example, ESUs may include one or more batteries, one or more capacitors, one or more fuel cells, one or more devices that store and release hydrogen and/or one more devices that store and release energy.

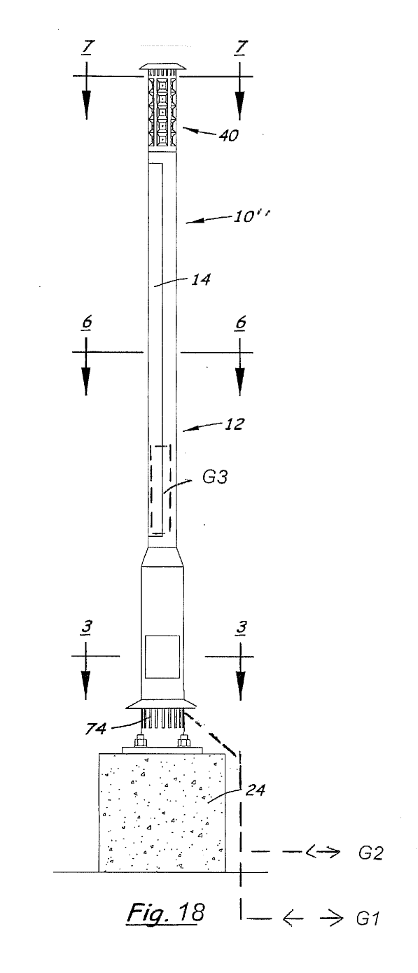

In alternative embodiments, the light 10″ (see FIG. 18) may be tied to the utility grid, for example, for providing power to the grid during the day (and optionally also charging batteries during the day), and then receiving less expensive power from the grid during the night (and/or also receiving power from the optional batteries as a supplemental/backup power source). In FIG. 18, connection to the grid is shown schematically as G1 (underground) or G2 (above-ground) and one of skill in the art, given the disclosure herein, will understand how to build, install, and manage said connections. Especially-beneficial management of said connections, preferably for an array of lights/poles, to the grid has been invented and is discussed below.

A grid-tied embodiment that also has battery storage capability may provide the benefit of supplementing the grid during peak electricity-usage hours, while also being capable of being autonomous (independent of the grid at least part-time) operation in the event of disaster or other grid outage. In such embodiments, an inverter and control and measurement systems (G3 in FIG. 18) will be added, for example, inside the pole, to cooperate with the utility grid and measure and record the system's energy contribution to the grid.

Controllers are provided to manage charging of the batteries and delivery of energy to the lighting system and/or other components. Control of the operative connection between the batteries 62 and panel 14 and the operative connection between the batteries and the LED fixture 40 and other components may be done by electronics, circuitry, semiconductors, and/or other hardware, software and/or firmware, for example, embodied in control board 80 shown in FIG. 7, and broadly called a “controller” (which includes one more boards, one or more controller units, and various controller embodiments that will be apparent to those of skill in the art after reading and viewing this document). The controller preferably continually monitor(s) battery voltage and temperature to determine battery health, to improve both battery performance and life. As further described later in this document, said controller preferably controls the speed and the amount that the batteries are charged and discharged, which can significantly affect battery life. Combined with the preferred cooling system for managing battery temperature, the batteries of certain embodiments are expected to exhibit longer lives, and better performance, than prior art batteries installed in solar-powered light systems.

A first controller function delivers a low-current (trickle) charge from the solar collector panel 14 to the batteries. This controller also preferably limits the maximum voltage to a voltage that will not damage or degrade the battery/batteries. A second controller function draws current from the battery/batteries and delivers it to the LED fixture and other electric device(s) requiring power from the batteries. The minimum battery voltage is also protected by the controller to prevent excess battery drain. During prolonged periods of inclement weather and low daytime energy generation, the controller may dim the lights during part or all of the night to reduce the amount of energy being consumed while still providing some lighting of the surroundings. The controller may turn the light on based on a signal from a photocell and/or a motion sensor, and off with a timeclock, for example.

The controller may comprise and/or communicate with computer logic, memory, timers, ambient light sensors, transmitters, receivers, and/or data recording and/or output means. Said controller may comprise only electronics and apparatus to operate the single light 10, 10′ in which it resides, or may additionally comprise electronics and apparatus that communicate with a central control station and/or with other street lights. Said communication is preferably accomplished wirelessly, for example, by means of a “multiple-node” or “mesh” network via any wireless communication, for example, cell-phone radio or satellite communication, as will be discussed in more detail later in this document. Such a network of multiple street lights (“multiple poles”) and a central control station may allow monitoring, and/or control of, the performance of individual lights and groups of lights, for example, the lights on a particular street or in a particular neighborhood or parking lot. Such performance monitoring and/or control may enhance public safety and improve maintenance and reduce the cost of said maintenance. A central control station may take the form of, or be supplemented by, a headquarter or other site with one more servers, or any computer/server/gateway including those accessible via an internet website, for example.

The entire system for storing and using energy preferably uses, in certain embodiments, only direct current (DC). Benefits of this include that LED lights use DC energy; the DC system is low-voltage, easy to install and maintain, and does not require a licensed electrician; and energy is not lost in conversion from DC to AC.

The preferred batteries are sealed lead-acid AGM-type batteries or gel-cell batteries, nickel metal hydride batteries, or lithium batteries, for example. It is desirable to maintain the batteries 62 within a moderate temperature range, for example, 40-90 degrees F. as exposure of the batteries to temperatures outside that range will tend to degrade battery performance and life. Daily battery performance may be reduced by more than 50 percent by cold weather, and batteries may stop working entirely in very low temperatures. Further, high temperatures tend to also degrade battery performance and life.

In the preferred configuration shown in FIG. 4, the batteries 62 are supported in a bracket(s) 66 and surrounded on multiple sides by insulation 68 for protecting the batteries from cold weather, preferably to help keep the batteries above about 40 degrees F. Further, said insulated batteries, and/or the bracket system supporting them, are connected to and contained inside a cooling sleeve 70 that is beneficial in hot weather, preferably to keep the batteries below about 90 degrees F. The cooling sleeve 70 is concentric with, and the same general shape as the wall of the pole 12. The sleeve 70 is of smaller diameter compared to the pole, for example, 2-4 inches smaller diameter, forming an annular air flow space 72 inside the pole along the length of the lower section 64 of the pole. Air enters the intake vents, for example, slits 74 around the pole in FIGS. 1 and 2, and flows up through the annular space 72 past the bracket(s) 66 and batteries 62 to cool said batteries 62. Said vents 74, and the open top of the flow space 72 that preferably communicates with the LED light fixture 40, are examples of at least one lower pole vent and at least one upper pole vent adapted for ventilation of at least a portion of the pole by natural convection up through said at least one portion of the pole. Preferably, the flow space 72, or alternative internal spaces for draft up the pole, communicates with the LED light fixture, but alternative ventilation systems may be independent from the LED light fixture. Referring to FIG. 17, there is shown another, alternative lower pole vent. The lower pole vent of FIG. 17 is provided (instead of vents 74) by providing spaces around the flange of the pole 12′ by virtue of the flange being spaced from the base 24 by a bolt system that may be used to level the flange (make the pole vertical) on a base on uneven ground. The bottom end of the pole 12′ has a bottom end opening (not shown) into which the air flows (instead of flowing into vents 74), and said bottom end opening is in fluid communication with the annular space 72 or other interior axial spaces inside the pole for creating the ventilation draft described elsewhere in this disclosure.

In FIG. 5, one battery system 80 (one of many possible alternative battery systems) is shown, wherein no cooling sleeve is provided, but air may flow up through the battery section through axial spaces 82 around the batteries 62. Insulation 68 is preferably provided at and near the pole inner surface and extending most of the way to the batteries 62, however, with the exception of the axial spaces 82 that provide channels for air flow up through the system 80.

One may note that the designs shown in FIGS. 4 and 5 both have access doors systems 76, 86 that allow insertion, maintenance, and removal of the batteries 62 from the lower section 64. The access door system of FIG. 4 comprises both a door 77 in the pole and a door 78 in the sleeve 70. The sleeve door 78 of FIG. 4 may be insulated, so that the batteries are surrounded circumferentially by insulation, or, in alternative embodiments the sleeve door 78 may be un-insulated or even eliminated. The access door system 86 of FIG. 5 comprises only a door in the pole, and is insulated, so that the batteries are surrounded circumferentially by insulation. Other bracket, insulation, and door configurations may be effective, as will be understood by one of skill in the art after reading this disclosure.

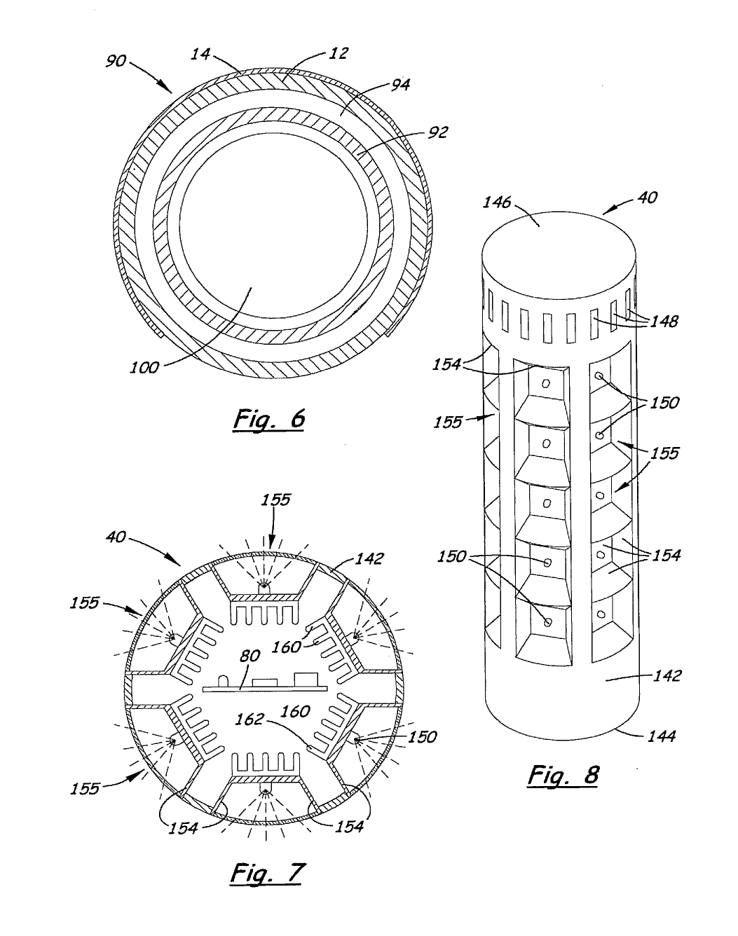

FIG. 6 illustrates the internal structure of the middle section 90 of the pole 12, wherein the flexible panel 14 is wrapped and adhered to the pole outer surface. It should be noted that the preferred pole is a hollow, straight (or right) cylinder, and the preferred panel 14 is applied continuously around at least a portion of the pole (for example, around at least 90 degrees, at least 180 degrees, or at least 225 degrees of the pole), so that sunlight “collection” is maximized. However, other pole shapes may be effective in certain embodiments if the corners are rounded to allow the panel 14 to bend gently around said corners. For example, a square, rectangular, or polygonal pole, with rounded corners, may be effective, with the panel 14 still being provided in a single panel, and not needing to be held in brackets or frames on the various flat sides of the poles.

Inside the middle section 90 of the pole 12 is an axially-extending sleeve 92, which creates an annular space 94 that extends through the entire middle section 90. This annular space 94 fluidly communicates with the annular air flow space 72, or other air flow spaces 82 of the lower section 64, so that air vents from the lower section 64 through space 94 of the middle section 90 and to the LED fixture 40, as further described below. Ventilation by air flow up through the middle section 90 of the pole keeps the inner surface of the panel 14 cooler than the outer surface that is “collecting” the sun light. This may be important for efficient operation of the solar panel 14, to maintain a temperature gradient between the higher temperature outer surface and the cooler inner surface of the panel. Thus, it is not desirable to have insulation between the panel 14 and the pole 12. The pole middle section 90 may be made without a sleeve 92, in which the hollow interior of the pole might serve in place of space 94 as the air vent chimney in fluid communication with spaces 72 or 82 and the LED fixture.

The middle section 90 may house long-term energy storage 100 comprising one or more ESUs, for example, capacitors, fuel cells and/or a hydrogen storage tank, for example. Capacitors would have the advantage that they would not be as affected by heat and cold as are batteries. Typically, capacitors would have longer lives than batteries, for example, up to about 20 years, compared to 2-5 years for batteries. Fuel cells could be used for applications that require longer autonomy than 5 days. The fuel cell and hydrogen storage tank could be integrated into the middle section 90 or lower section 64 of the pole, or into the base or an underground container. Venting similar to that required for the battery system would be required for off-gassing.

FIGS. 7 and 8 portray transverse cross-section, and side perspective, views, respectively, of the preferred LED fixture 40 positioned above the middle section 90 of the pole. The fixture is preferably cylindrical and longer axially than it is in diameter. The fixture 40 is preferably the same diameter as the pole middle section, and comprises preferably a constant or nearly-constant-diameter housing 142. The housing 142 is substantially hollow with an open bottom end 144 in fluid communication with the middle section 90 and a closed upper end 146. Vents 148 are provided near the upper end 146 to allow air that flows up through the pole 12 to pass through the fixture 40 and then exit at or near the top of the fixture. Open bottom end 144 and vents 148 may be considered examples of a lower vent and an upper vent adapted for ventilation of said light fixture by natural convection up through the light fixture. Other venting systems comprising at least one lower vent and at least one upper vent may be used, including, but not necessary limited to, systems that utilize upwards draft from/through at least portions of the pole to create/enhance ventilation of the LED light fixture. There also may be ventilation systems for the LED light fixture that are independent from pole ventilation.

Certain embodiments use light sources (luminares) other than LEDs, for example, one or more of: a light emitting diode (LED), an HID light source, a fluorescent light source, a mercury vapor light source, a gas light source, a glow discharge light source, a solid state light, an organic-compound light-emitting light, an OLED light source. Compared to certain other light sources, however, LEDs are smaller, more efficient, longer-lasting, and less expensive. LEDs use less energy than certain other light sources to provide the necessary lighting desired for a street light. LED may last up to 100,000 hours, or up to 10 times longer than other lighting sources, which makes LEDs last the life of the pole and the entire light system in general, especially when said LEDs are housing and cooled by the apparatus of the preferred embodiments.

Multiple LED lights 150 are arranged around the entire, or at least a significant portion of the, circumference of fixture 40. LED's are arranged in multiple vertical column units 155, and said column units 155 are spaced around the circumference of the fixture 40 to point LED light out from the fixture 360 degrees around the fixture. In alternative embodiments, LED's may be provided around only part of the circumference of the fixture, for example, only around 180 degrees of the fixture to shine light generally forward and to the sides, but not toward the back. Six of the LED column units 155 are provided, each with five LEDs, but more or fewer units and LEDs may be effective. Reflectors 154 are provided on some or all sides of each LED and may be positioned and slanted to reflect light outward and preferably slightly downward as needed for a particular environment. The preferred arrangement of LEDs results in their being, in effect, columns and rows of LEDs.

At the back of each LED column unit 155 are located cooling fins 160, protruding into the hollow interior space 162 of the housing 142 for exposure to air flowing upward from the middle section. Heat exchange from the fins and adjacent equipment to the flowing air cools each unit 155, to remove much of the heat produced from the LED's. This heat exchange is desired to keep the LED's in the range of about 20-80 degrees, F and, more preferably, in the range of 30-80 degrees F. LED performance and life are typically optimal when operated at approximately 30 degrees F., but a range of operation temperature (for example, 20-80 degrees F.) may be tolerated due to the inherent long lives of LEDs.

In the center of the fixture in FIG. 7, one may see an example control board 80, as discussed previously. Optionally, other equipment may be provided inside the fixture 40, extending through to or on the outside of the fixture 40, or in/on stem 166 or the rain cap C at the top of the fixture 40. Such equipment may include, for example, a camera and/or recorder for a security system, wireless network radio, antenna, motion sensor, and/or photocell. If provided on the outside, it is desirable to have such equipment consistent with the contour/shape of the fixture, for example, to be flush with, or to protrude only slightly from, the housing 142 outer surface. The control boards 80 and other equipment, if any, located inside the fixture 40 may be cooled by the upwardly-flowing air inside the fixture, in some embodiments, or, in other embodiments, may need to be insulated from their surroundings, depending on the heat balance in the LED fixture.

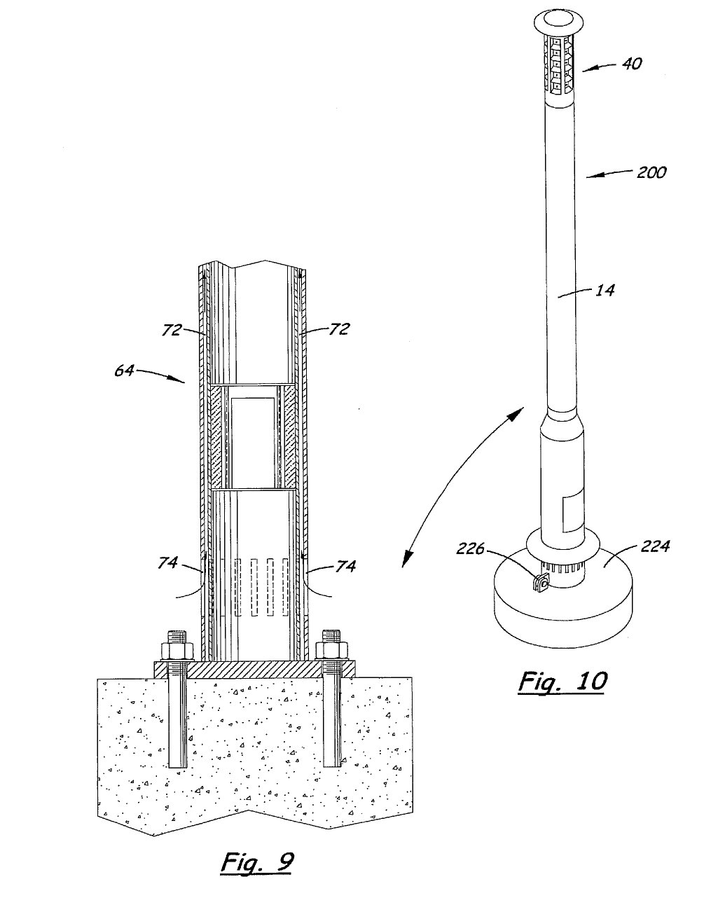

FIG. 9 portrays air being pulled into the lower section of the pole through slits 74 and continuing to flow up past the batteries and up through the pole, by natural convection. As provided by the structure of the pole and pole internals discussed above, the entire pole 12 will preferably be ventilated and designed to create an upward draft of air through the pole 12. This air flow cools the battery section and the LEDs, for improved operation and greater efficiency. The air flow may cool the circuit board and any other equipment that may be provided in LED fixture, depending on the heat balance in the fixture, or said circuit board and other equipment may need to be insulated to keep the LEDs from heating them beyond desirable temperatures. While other solar-powered outdoor lights have been proposed, none to the inventor's knowledge have a cooling feature, and the inventor believes that the preferred embodiments will exhibit increased efficiency and long-life, due to the special combination of LEDs and cooling for batteries and LEDs. Optionally, heating equipment may be provided in one or areas of the pole to protect equipment and/or enhance operation during extreme cold. Cable or film heating means may be effective, and may be controlled by a thermal sensor and controller.

Some, but not all, alternative light fixtures are discussed later in this document. See, for example, FIGS. 22 and 29-33E.

FIG. 10 portrays an alternative embodiment of the invention, which is a portable, pivotal outdoor light 200. Light 200 comprises a pole with attached flexible panel 14 of thin-film photovoltaic material, LED fixture 40 at the top of the pole, and a heavy but portable base 224 that is neither connected to, nor buried in, the ground. The pole is hinged at 226 to the base 224, for tilt-up installation at the use site. A lock (not shown) may secure the pole in the upending position until it is desired to remove and move the portable light 200 to storage or another location. Batteries or other ESUs may be provided in the portable base 224.

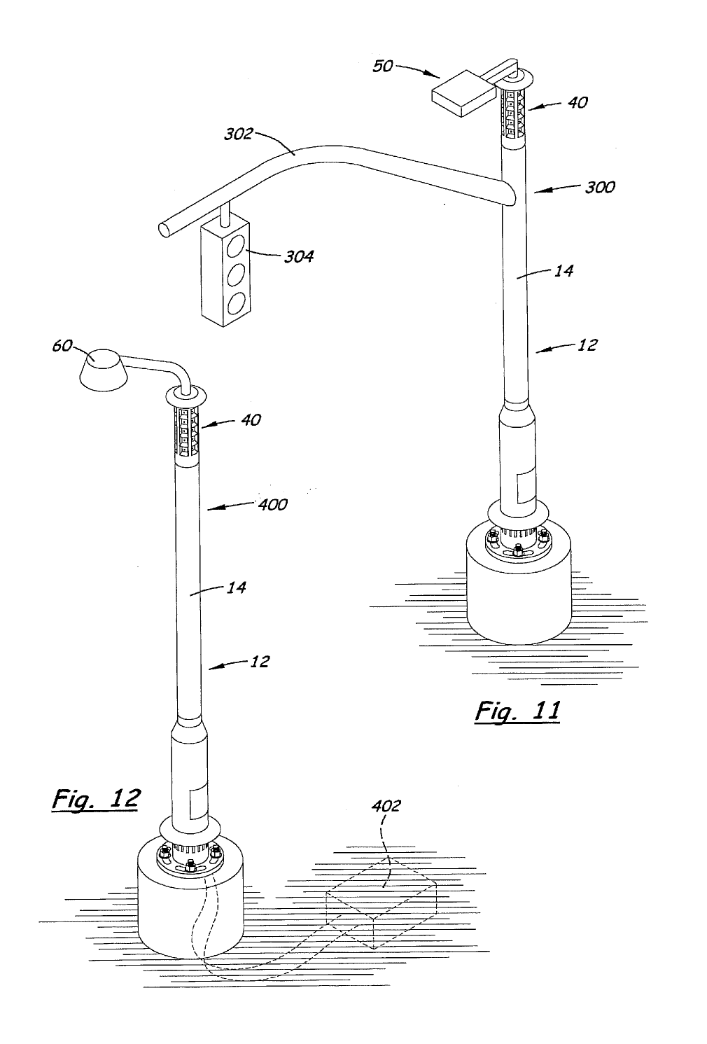

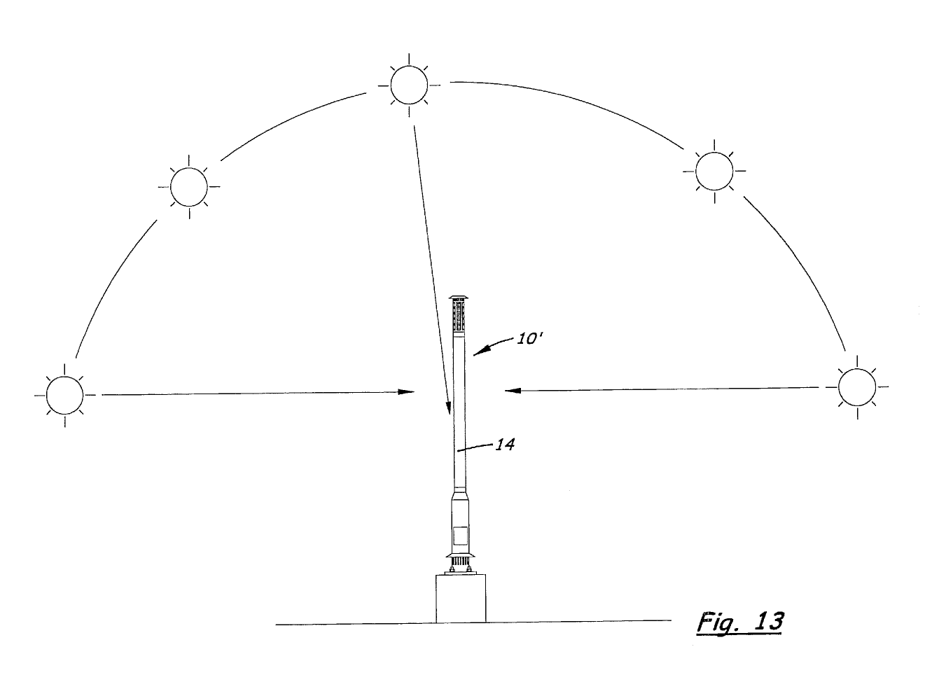

FIG. 11 portrays an alternative embodiment 300 that includes a traffic light as well as a street light. The pole 12, panel 14, base 24, LED fixture 40, and decorative fixture 50 are the same or similar to those described above for the embodiment in FIGS. 1 and 2. An arm 302 extends from the middle section of the pole, to a position over a street intersection, for example. A traffic light 304 hangs from the arm 302, and is powered by the solar-powered system already described for the other embodiments. A control board and/or other apparatus and electronics will be provided to control the traffic light, in accordance with programs and instructions either programmed into the circuitry/memory of the embodiment 300 and/or received from a control network and/or central control station.

FIG. 12 portrays an embodiment that is break-away, road-side outdoor light 400 embodiment, which has its battery system 402 buried in a vault in the ground rather than being in the lower section of the pole. The electrical connection between the batteries and the panel, the batteries and the LED fixture extend underground. The rest of the light 400 is the same or similar as the embodiment in FIGS. 1 and 2, except that the lower section does not contain batteries, and the decorative light is a different one of many possible styles. The lower section of the pole may have a sleeve for encouraging draft and air flow up to the LED fixture, but does not need to contain brackets for batteries. An access door may be provided, for example, to check on or maintain wiring or connections that may be reachable from the lower section. Adaptations, such as break-away bolts, are provided to allow the pole to break-away when hit by a vehicle, as is required for many highway lights. Having the battery system buried in the ground enhances safety because vehicles will not crash into the full mass of the pole plus base plus battery system. Alternatively, batteries could be located in a buried base, to which the pole may be bolted. The pole may be steel or aluminum, and may have rust resistant coatings applied for extending underground.

FIGS. 13-16 illustrate improved efficiency and effectiveness of certain embodiments of the invention. Sunlight hits the flexible panel 14 from all directions on its path “across the sky.” The continuous panel in FIGS. 13-16 extends around at least 225 degrees of the pole circumference and along a substantial amount of the length of the pole, provides a large target that the sunlight hits “straight on” as much as is possible. The preferred cylindrical shape of the pole, and, hence, of the panel, provides a curved target that catches light from dawn to dusk.

Certain outdoor light embodiments are what may be called “visually integrated,” as they contain a great amount of operational capability inside and on a sleek, slim, and generally conventional-looking pole and installation. Certain outdoor light embodiments do not include any flat-panel or framed solar cells. The pole may have few if any protrusions, except for the optional rain shirt S which may be designed in many non-obtrusive ways, and an optional rain cap C that also may be designed in non-obtrusive ways. In embodiments having a decorative light fixture, said decorative light fixture may be considered a protrusion, but one that is expected and conventional-appearing. In certain embodiments, most or all of the pole and its associated equipment, except for the decorative light, varies only about 20 or less percent from the constant or substantially-constant diameter of the main (middle) section of the pole.

In certain embodiments, the attachment of the preferred flexible light-active panel, or light-active materials of the future, is done simply and without racks, brackets, frames, and other complex or protruding material. Thus, the panel may appear to simply be the side of the pole, for example, a painted or coated section of the pole wall. In certain embodiments, the pole is a straight cylinder (with a constant diameter all along the middle section of the pole) that may be painted a dark color like black to match or blend with the dark color of the panel. Preferably, the panel is not an ugly or strange-looking structure that would irritate the public, customers, or property owners who desire an aesthetically pleasing lighting system, and the panel does not have a high-tech appearance that might attract vandals or pranksters.

It should be noted that, while certain embodiments are outdoor lighting systems, that some embodiments of the invention may comprise the preferred LED fixture by itself and/or the preferred LED fixture in use with supports and equipment other than those shown herein. Also, some embodiments of the invention may comprise the preferred solar-powered pole by itself and/or connected to and powering equipment not comprising any light source, powering non-LED lights, and/or powering equipment other than is shown herein.

### Wireless Intelligent Outdoor Lighting System (WIOLS):

Certain embodiments comprise adaptations such as intelligent control, for independent processes, such as independent monitoring, control, and output (light, alarms or other communication, etc.), which independent processes comprise sensing, communication and control between the nodes/poles of an individual WIOLS. As described above, therefore, such networks are called “independent array” and/or an “independent network of nodes”, and are not linked to a control station.

Certain embodiments comprise adaptation for non-independent processes, such as communication between the WIOLS and a control station, as in “control-station-networked-arrays” or “control-station networks”. Such networks may be master-slave networks or peer-to-peer networks, for example,

In the case of master-slave networks, the network comprises multiple “slave” units (also, slave node/pole) and at least one “master” unit (also, master node/pole or coordinating unit/node/pole). Some or all of the slave units and the master unit may comprise an outdoor lighting device and/or other wireless and electrical devices. Each wireless network comprises individual slave units at a plurality of node locations that “talk” to each other via a mesh network. The preferred slave units may be outdoor lighting devices with wireless communication capability, although other wireless and electrical load devices may be included in the network instead or in addition to lighting. Each of the slave units is equipped with a wireless modem that communicates with adjacent slave units. The range of each unit reaches other units at least two units (nodes) away in order to allow for the system to remain operational even if one unit is lost or otherwise fails in any way. Each of these units is called a “slave” unit/node, because each depends on other units to pass information back & forth; thus, some units are “intermediaries” in communication to the master unit, passing information from other units to the master unit, and/or receiving information from the master unit to pass on to the other unit.

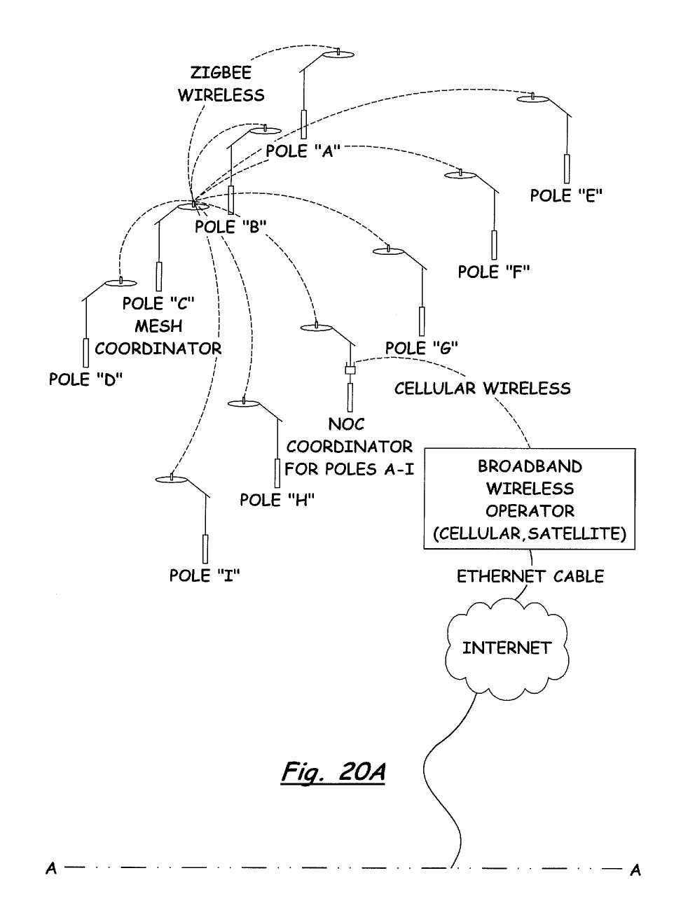

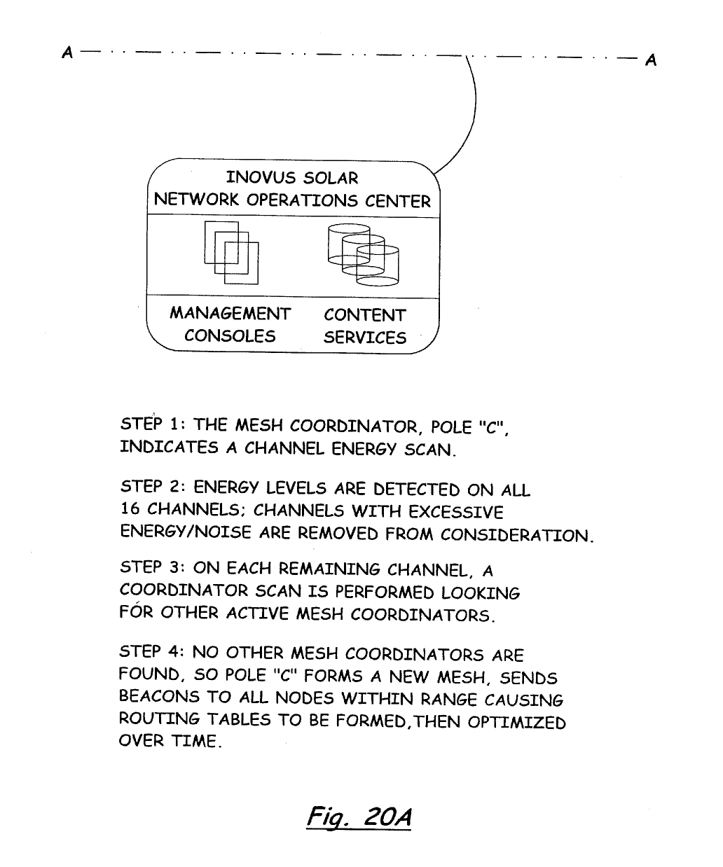

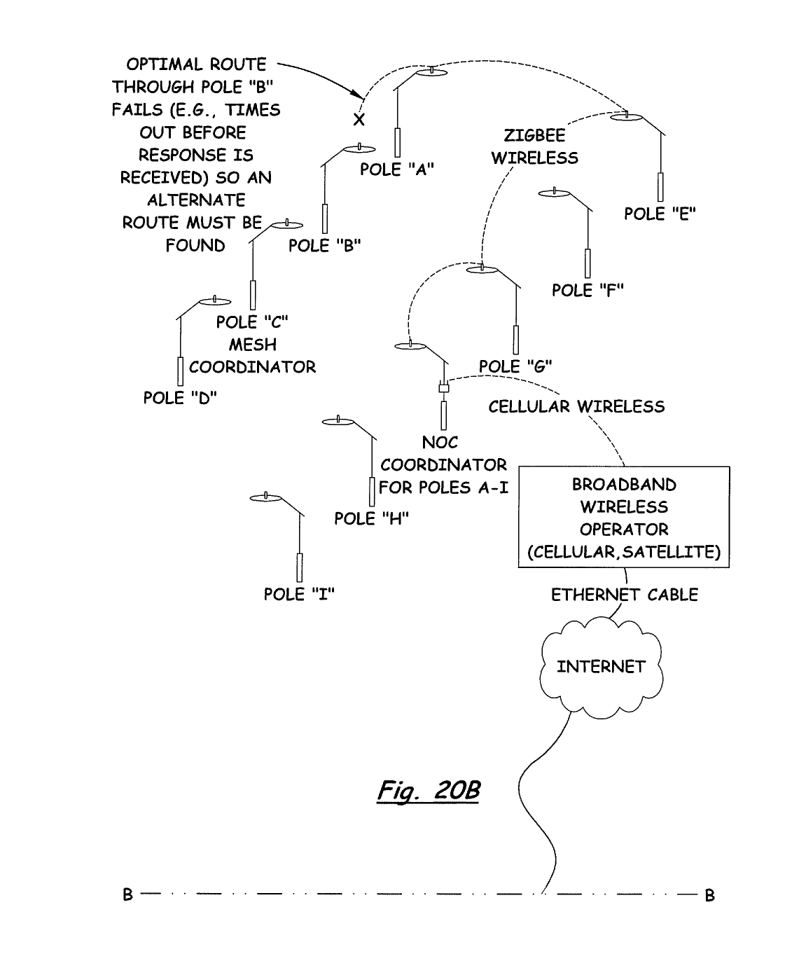

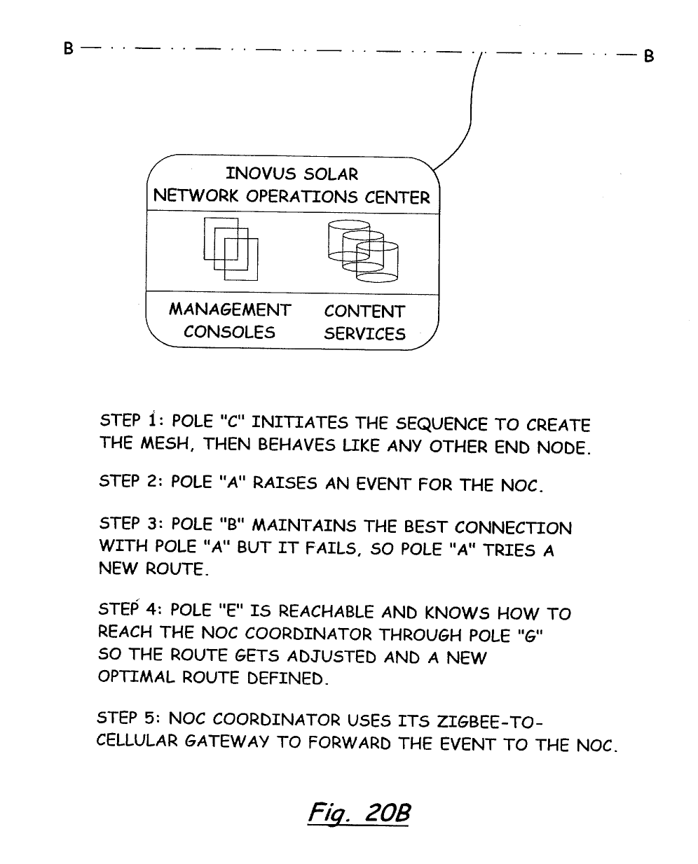

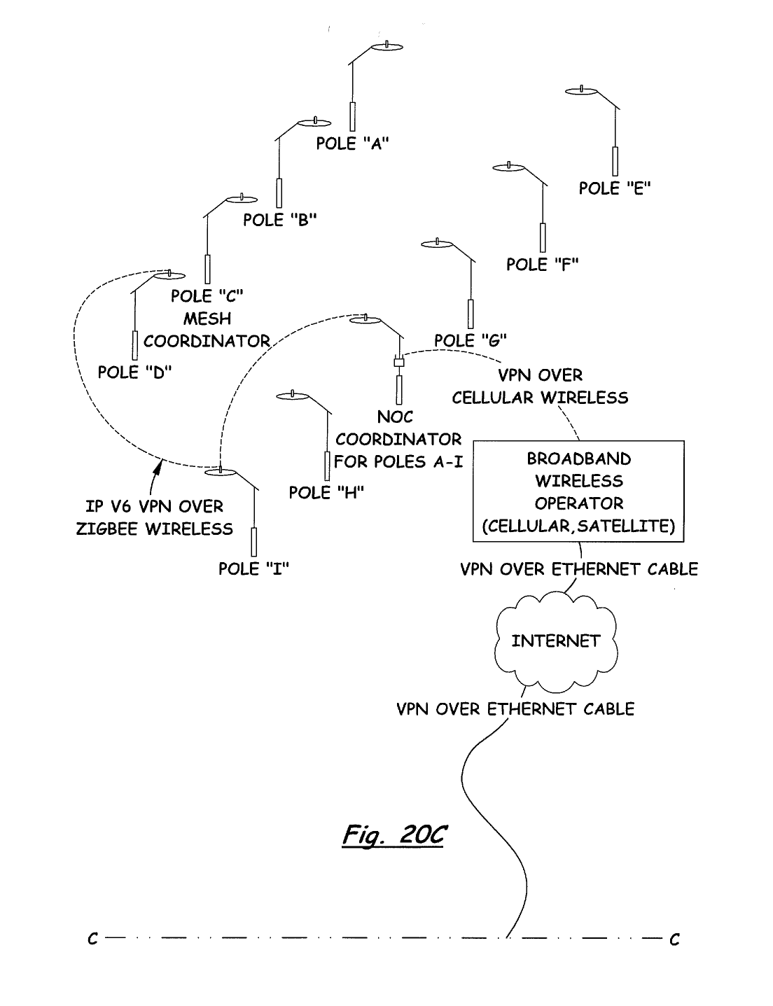

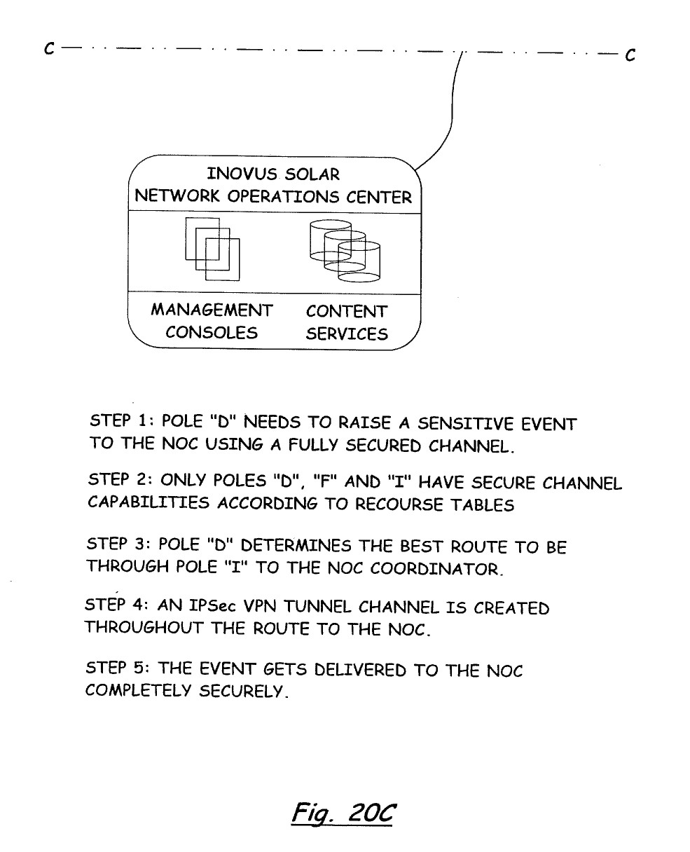

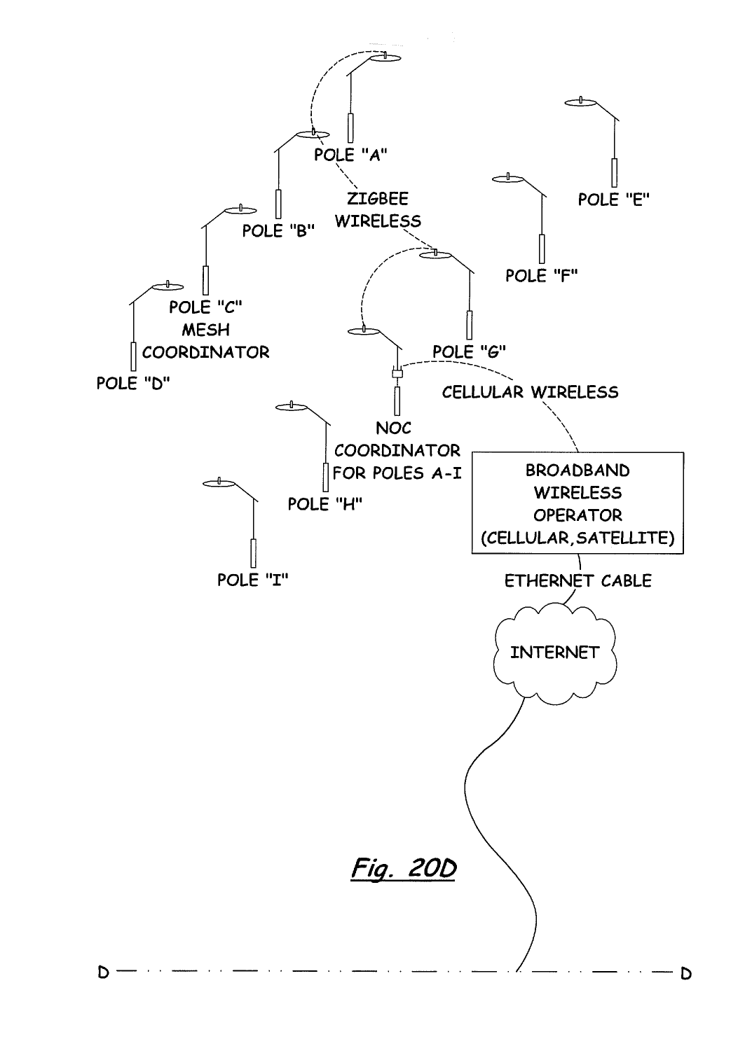

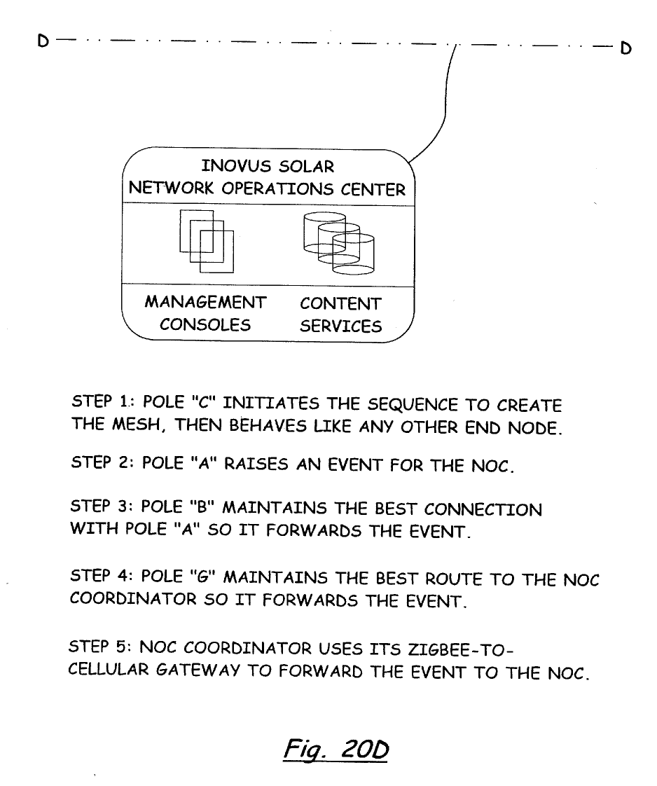

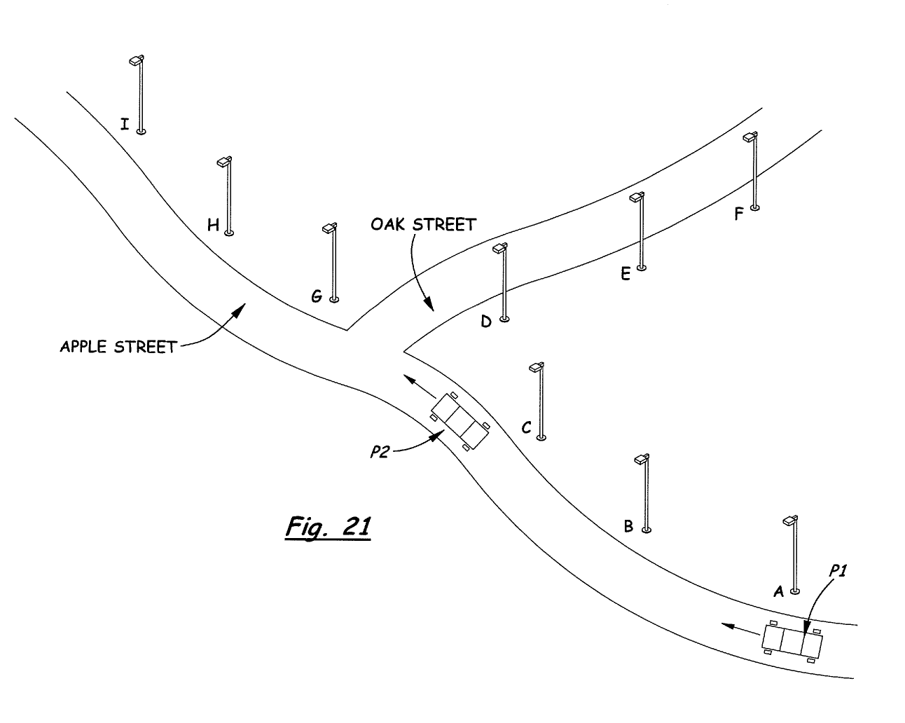

It may be noted that FIGS. 19 and 20A-D portray master-slave networks, and some statements of this WIOLS section and other sections of this document use “master-slave” terminology. However, it will be apparent to those of skill in the art, that many of the methods and apparatus elements described in a context of a master-slave network may be done/used in other wireless mesh networks, for example, a peer-to-peer network. In such peer-to-peer networks, any wireless node (each unit/pole and also the control station) can communicate with any other wireless node (including the control station), for two-way gathering and dissemination of data and/or analysis of data, including control settings and instructions, software, etc. In turn, the control station preferably may communicate bi-directionally with the internet. Peer-to-peer networks are further described later in this document, including in the Examples, and are the preferred network of many embodiments of the invention,

In certain embodiments, several sensing and control tasks are handled between the multiple slave units and/or between slave units and the master units, without requiring control from the control station. The slave and master units preferably each also have a self-discovery feature for self-identification of new units/nodes and integration of the new units/nodes onto the network, for example, to bridge the gap when any given node is “lost” for any reason. The units of each WIOLS are typically powered by battery(ies)/ESUs and can use solar panels to recharge the battery/ESUs. Preferably, each unit has a wireless modem and controller forming a wireless network, for monitoring and control of its electrical load devices to allow for adjustment for low-battery/low-ESU conditions and the ability to measure excess power generated by the units to be placed back on the grid, for example, for being applied for a credit to the account. Optionally, the master unit, as described above, may also communicate to, or receive from, the control station information and instructions about said low battery/ESU conditions and/or excess power. Therefore, the WIOLS units, including the slave and master units, may use power stored in batteries/ESUs recharged by solar panels, rather than a grid tie, for transmission of signals between slaves units, between slave units and the master unit, and to a remote control location, for example, city blocks or miles away.

FIGS. 19 and 20A-D that illustrate multiple, but by no means all, of possible arrangements for a mesh network for wireless systems, which may comprise lighting systems and/or additional powered equipment, such as alarms public service displays, WI-FI hot-spots, etc., as discussed elsewhere in this document.

Certain embodiments of the control station comprise a connection to the internet so that the system can be both monitored and controlled from anywhere with internet access. The control station may be connected to a main server that contains the web site for connection to the internet. If any given node of the network fails, that information (a “trouble” signal) is passed on through the network to the control station so that it can be addressed. There may be more than one master device connected to a main server, each master device acting as the primary control interface between the main server (typically at the control station) and its respective separate wireless network of units/notes.

In certain embodiments, the wireless network can be simplified by use of LED's or lasers that can be modulated for communication. Simple photodetectors can be used in conjunction with the LED's or lasers for purposes of detecting an object in the area that interrupts the communication (via LED's or lasers) between adjacent nodes or devices, that is, typically between adjacent poles.

One of many applications for a wireless intelligent network according to the invention is illustrated in FIG. 21, wherein the network and its devices are used for anticipatory control of lighting. For example, the wireless intelligent outdoor lighting system (WIOLS) may comprise anticipating the direction to be traveled by an object or human. Motion sensors on the WIOLS along a road can detect the direction that a vehicle is traveling and light the next few neighboring lights in the direction of the traveling vehicle (while leaving other lights off or dimmed). At intersections, lights in any viable direction for travel are lit until the vehicle has begun travel along a particular route from that intersection, at which time the lights ahead of that vehicle light up while the other routes dim or are turned off. Similarly, in a parking lot or a park, motion sensors on the WIOLS can detect the direction that a person is traveling and light the poles in the direction that the person is moving, or create some other illumination pattern that promotes safety, alertness, or other desirable goals. See also, for example, the embodiments discussed in the Example IV below.

Referring specifically to FIG. 21, when a vehicle is in Position P1 traveling along the street, the motion sensors in/on poles A and B allow the intelligent network to determine the direction and speed of travel. Lights A and B are immediately illuminated. Lights C and G are illuminated ahead of the vehicle, lighting its way ahead of its path of travel. As the vehicle approaches the intersection (Position P2), lights D and G are illuminated, anticipating the direction of travel along one of the two streets. If the vehicle turns and begins to travel along “Oak Street”, then poles E and F are illuminated. If the vehicle continues to travel along “Apple Street”, then poles H and I are illuminated. Once the vehicle has traveled beyond the lighted path of travel, the poles are dimmed down to the low light level or turned off until the next event sensed by the motion sensor. In this scenario, poles/lights A-I may be considered individual nodes in a wireless mess network, wherein typically all but one are slave poles/nodes, and said one is a master. Thus, poles/lights A-I will preferably all be part of a single mesh network and the network may communicate with a control station via the master pole/light, as schematically portrayed in FIGS. 19 and 20A-D. The selection of which poles/nodes are adapted to be the slaves and which is adapted to be the master may be done according to various criteria, including optimal location for the master pole/nodes cell or satellite communication with a control station and/or internet, and/or proximity to support and maintenance structure, for example. It may be noted that “on-pole” refers to actions that are specific to one pole (the pole itself) that do not relate to other poles. For example, motion sensed at a single pole in a parking lot will increase the light level for just that pole, and does not involve other poles. It may be noted that “across-poles” means that a series or group of poles are involved, for example, a series of poles along a street. As a car passes at least two poles, the motion information (speed, direction of travel) must be communicated to the other poles along the street in order to ‘light the way’ ahead of the cars travel path.

In an outdoor public lighting system, it can be desirable for individual outdoor lighting nodes to behave in an interdependent manner, which may include self-monitoring or “self-diagnostics”, overriding of errors or abnormal operation, and/or coordinated activities. For example, a damaged or missing light needs to have that status communicated to a central control, so that repairs can be made or adjacent lights can temporarily compensate for the missing/damaged light. For security reasons, a specific activity in a certain location within the array may cause a particular node to change it parameters/operation (i.e. adjusting luminosity or sending out some sort of communication) triggered by motion sensors, etc. Also during times of transition between light and dark (i.e. dawn and dusk), it is desirable to control of the array of lights as a group to adjusts the luminosity with respect to the ambient lighting conditions. See other the Examples for discussion of active control, self-diagnostics, overriding of errors or abnormal operation, and/or coordinated activities.

Wireless networks typically may be powered by solar panels charging batteries/ESUs, as discussed above, but may instead, or also be tied to the electrical grid. In certain embodiments having batteries/ESUs and also a grid tie, the network can respond to grid power outages as an uninterruptible power supply (called herein “UPS”). For example, the network detects the loss of grid power and communicates with the utility company to determine how to place power from the energy storage device back onto the grid. In certain embodiments, the WIOLS can also act as a UPS in a small localized energy grid, eliminating or supplementing backup power generators; such behaviors would be similar to that on the larger power grid.

Public outdoor lighting arrays, such as in certain embodiments of the WIOLS, form a ready-made wireless infrastructure, since nearly all municipalities and many public roadways utilize light poles, and are ideally suited to wireless communication for public safety, or with the proper protocols and security, for public access to the internet. Such adaptations, for example, public safety communication for alarms and/or signaling to the public, and/or public access to the internet, may be provided by fitting one of more nodes/devices/poles of the WIOLS with supplemental equipment, such as alarm speakers, electronic signage, environmental sensors, security equipment, and/or internet “Wi-Fi hot spot” hardware and software.

Master and slave units may have many features/elements in common. The slave units each comprise/consist of a lighting fixture and/or other electrically-powered load device, network board with a micro controller, power supply, electronics as required for the mesh network, and zero, one or more devices that act as sensors or other active devices. There is also a wireless modem “on-board” each slave unit. An AC to DC power supply connects it to an AC system if available. If no power is available, a wind generator and/or a solar collector powers the system. Power can be stored to an energy storage device/unit (ESU), such as a battery, capacitors, fuel cells, or devices that store and release hydrogen. Typically, the master unit has all of the same components as the slave device with the addition of a cell or satellite radio for wireless communication to the control station.

The outline below lists some, but not all, of the preferred features/options that may be included in various WIOLS embodiments. Following are preferred “supportability” features:
1.1 It is preferred to include, in the WIOLS wireless controller/programming, a method for separation of operational parameters from code, with the following preferred features:
   1.1.1 All operational parameters that affect how the systems and algorithms behave are abstracted out of the code, leaving behind variables in the code that are evaluated at system start;
   1.1.2 Operational parameters are stored separately from code in a profile that is easily read and processed by the code;
      1.1.2.1 Said profile should be easy to replace in its entirety;
      1.1.2.2 Individual values for operational parameters in said profile should be easy to replace;
   1.1.3 On system restart or reset, all systems and algorithms flush their values for operational parameters then re-read and re-process operational parameters from the profile;
1.2 A method for an operator or maintenance personnel to reset the device at ground level (i.e. standing on the street), like a reset button. Pushing this button is the equivalent to power cycling the system, which causes all hardware, firmware and software to re-initialize, re-read and re-process all operational parameters;
1.3 A method for indicating device system status, like a 3-color light or set of lights (e.g., green, yellow, red) at ground level that conveys one of three states: operating properly, operating but there is an issue needing attention, and not operating. This provides ground level feedback regarding whether to push the reset button as well as whether or not pushing the reset button resolved the issue.
1.4 As another example, the processor may blink and/or strobe an error code via the primary illumination device of the lighting system to indicate the determined error condition. In an environment where the lighting system is employed as a street light or other lighting pole, a passing pedestrian and/or motorist may notice the error code and notify the relevant lighting system operator. The operator may then dispatch maintenance and/or repair persons to correct the error condition. In addition, by employing the primary illumination device of the lighting system to indicate the determined error condition, error conditions signaling capability may be provided without additional components and only minimal increase in system complexity.
1.5 A method for providing a ground-level memory card reader (e.g., CompactFlash™, SmartMedia™):
   1.5.1 Memory card reader is bootable, meaning that, on reset, the card reader is checked for a set of operational parameters and if they exist, these operational parameters are used instead of any others that may be onboard;
   1.5.2 System logging persists on a memory card in the ground level slot so that the card can easily be replaced, with logging data taking back for more thorough analysis than can reasonably occur in the field; and
   1.5.3 Amount of memory for operational parameters and logging is easily increased by replacing lower capacity card with higher capacity card over time.
1.6 Methods and algorithms are used that create modularity of systems on the device in order to:
   1.6.1 Facilitate unit testing as the number of components increases;
   1.6.2 More easily enable in-field, black-box replacing as a cost-effective support strategy in the field; and
   1.6.3 So that replaced modules are sent back to the manufacturer or certified service representative for troubleshooting, repair and recirculation.
1.7 Methods and algorithms are used to enabling an expandable bus architecture on the device to enable in-field hardware feature expandability over time (e.g., new sensor, high bandwidth radio, video camera).

Following are “Wireless Networking & Control” features that are preferably included in various embodiments of the WIOLS invention:
2.1 The following features are preferred “on-pole”, that is, on EACH individual POLE or on a plurality of poles in the wireless network:
   2.1.1 Algorithms to perform all functions in above through a wireless network and set of commands and protocols.
   2.1.2 Preferably included “on-pole” for event management:
      2.1.2.1 Algorithms for monitoring and storing discrete and continuous triggers, interpreting triggers and translating them into events to be published;
      2.1.2.3 Algorithms for subscribing to and receiving events with specified attributes as a way of performing a task in response to a published event;
      2.1.2.4 Algorithms for interpreting one or a collection of conditions, assessing their severity and then determining whether a warning or error condition exists;
      2.1.2.5 Algorithms around scheduling jobs at predefined times and/or with predefined frequencies to perform tasks; and
      2.1.2.6 Algorithms enabling the way an event is treated throughout the system to be dictated by the classification and characteristics of the event itself.
   2.1.3 For joining a network and self-organizing:
      2.1.3.1 Algorithms for initialization processes that include broadcasting across frequencies and channels to find other devices within range; and
      2.1.3.2 Algorithms surrounding whether to join an existing network versus creating a new network in response to other devices located within range, their functions within the network, their capabilities and the breadth of the networks they share.
2.2 The following features are preferred to be “Across-Poles” (that is, between multiple poles):
   2.2.1 Algorithms around how, where, and how redundantly to register a device's capabilities on a network;
   2.2.2 Algorithms for determining connectivity issues on the network, routing around issues, repairing issues and reestablishing routes once repaired;
   2.2.3 Algorithms for favoring efficient routing, penalizing inefficient routing and adjusting both over time based on changeable definitions of efficiency;
   2.2.4 Algorithms for locating and sharing resources on the network as resource availability and location changes over time;
   2.2.5 Algorithms for securing the network against unauthorized “network joins” and ensuring intra-network communications cannot easily be intercepted and interpreted;
   2.2.6 Algorithms for using monitoring events across a population of devices to determine a coordinated action to take like lighting the way ahead of a walker along a pathway or turning on a video camera based on triangulation of multiple device motion sensors, such as:
      2.2.6.1 Algorithms that detect motion (direction and velocity) and estimate the future direction and location of the moving object as a function of time; and
      2.2.6.2 Algorithms that activate devices based on the anticipated location of the moving object per the algorithms in (i.e. turning on or brightening lights or turning on/waking up security cameras ahead of a moving car or moving person).
   2.2.7 Algorithms for aggregating events over populations of devices, rolling up event information based on criteria, interpreting low-level event information and using it to create new higher-order events;
   2.2.8 Algorithms for determining the location of a device based on known fixed locations and triangulation of multiple device radio signals;
   2.2.9 Algorithms that allow poles in a network to look for and sense different sensors that come into range of the wireless sensor(s) on the poles;
   2.2.10 Algorithms that allow poles in a network to identify and categorize the different types of sensors that come into range of the wireless sensor(s) on the poles;
   2.2.11 Algorithms that allow poles in a network to communicate with the different types of sensors that come into range of the wireless sensor(s) on the poles; and
   2.2.12 Algorithms that allow poles in a network to activate certain function on the different types of sensors that come into range of the wireless sensor(s) on the poles.
2.3 Regarding Content and Information Delivery (for example, gathering of weather or other information from networked devices by communication from one of more nodes/poles of a WIOLS to the control station, and/or providing messages, advertising, and public information that may be communicated from the control station to one of more nodes/poles of a WIOLS and then to the public):
   2.3.1 Algorithms involving securely bridging a low-power, low-bandwidth network and a medium-power, high-bandwidth network, or providing secure gateway capabilities between the two networks;
   2.3.2 Algorithms for aggregating information across populations of devices and securely delivering this information through a broadband wireless infrastructure to a WIOLS-manufacturer-operated network operations center; and
   2.3.3 Algorithms for guaranteed or best-efforts delivery of information to the network operations center based on the classification of the information.
2.4 Regarding Management that may be preferred and/or necessary for the business of operating and maintaining a WIOLS:
   2.4.1 Algorithms around creating and managing user/customer accounts and passwords with associated roles and permissions that span different kinds of customers as well as the needs of the WIOLS manufacturer itself;
   2.4.2 Algorithms that enable authentication of individual users to specific accounts and roles with associated permissions, and that track failed authentication attempts for intrusion detection security;
   2.4.3 Algorithms for authorizing individual users/customers to access and use only their devices and associated data;
   2.4.4 Algorithms for detecting when security might be compromised anywhere in the system and taking action once security is believed to be compromised such as locking out a user or customer, denying access to devices or data, locking out parts of the system globally or by customer and flushing all security keys requiring re-initialization throughout the system of all security subsystems;
   2.4.5 Algorithms for creating sets of devices that meet pre-defined conditions then proactively and remotely managing these devices including resetting, updating firmware, updating operational parameters, triggering on-demand information delivery, troubleshooting issues, overriding operation for prescribed periods of time, etc.;
   2.4.6 Analytical algorithms that operated on aggregated information at the WIOLS manufacturer's network operations center and provide customers with all manner of operational and environmental insights;
   2.4.7 Algorithms that allow a network of poles to manage power being pulled from the power grid or placed back onto the power grid, such as:
      2.4.7.1 Algorithms that allow a network of poles on the grid to put power onto the grid a desired times, either as certain criteria are sensed and met on the grid, or via a command from a central command center or a Network Operation Center (NOC); and
      2.4.7.2 Algorithms to draw power from the grid at desired times, as certain criteria are sensed and met on the grid, or via a command from a NOC.
   2.4.8 Algorithms to vary the control signal to the load(s) to test its operation (i.e. to test the ability of the light to run full brightness and dim down to various dimming levels). See, also, the section entitled “Active Control for Energy-Efficient Lighting” later in this document.
2.5 Regarding community assistance and relations, or advertising to the community:
   2.5.1 Algorithms relating to advertising and other information that may be announced and/or displayed on one or more of the nodes/poles of a WIOLS, preferably powered by renewable systems and energy storage systems that are also powering lights for the community:
      2.5.1.1 Methods for leveraging the convenient locations of street lighting and the surface area provided to offer advertising inventory;
      2.5.1.2 Methods and algorithms for providing programmable inventory on a pole that includes advertising inventory and time-based rotation of ad inventory;
      2.5.1.3 Methods and algorithms for selecting collections of poles that meet various criteria (e.g., location, amount of foot traffic based on motion triggers, average monthly temperature) and then delivering programmable ad inventory to poles meeting the criteria;
      2.5.1.4 Methods and algorithms for wirelessly determining additional context from a passerby (e.g., mobile device brand and service provider) and enabling more targeted advertising based on this additional context; and
      2.5.1.5 Algorithms for determining the direction a passerby is heading, identifying poles in that direction and then streaming advertising across poles along the passerby's path to overcome bandwidth limitations, provider a longer and richer ad experience or both.
   2.5.2 Algorithms regarding/providing Wi-Fi hotspots:
      2.5.2.1 Methods for including mobile broadband routers on poles in order to offer community Wi-Fi hotspots;
      2.5.2.2 Algorithms for leveraging sensor information (e.g., motion) and system parameters (e.g., time of day, available battery energy) to enable or disable Wi-Fi hotspot capability; and
      2.5.2.3 Methods for enabling/disabling and changing the behavior of Wi-Fi hotspots remotely, from a network operations center.
   2.5.3 Algorithms regarding/providing financial transactions:
      2.5.3.1 Methods and algorithms for securely receiving, aggregating, uploading and reconciling financial transactions from RF devices within range.

Certain embodiment use wireless communications channels (WCC) via wireless modems, and/or cell phone or satellite radio, as will be understood by those of skill in the art after viewing this disclosure. WCC enables the use of both high bandwidth & low bandwidth capabilities (channels) that can be selected based on communication requirements. For example, the controller's two-way communication may be either narrowband or broadband, depending on the communication requirements of the load devices. For example, narrowband communication is sufficient for an LED luminaire load devices and weather or pollutant sensors (thus saving energy), but broadband communication is typically required for Wi-Fi access point and streaming video load devices. The controller of each utility unit/pole will typically be adapted for (will comprise) communication in only one of narrowband or broadband, and typically will neither have the capability to communicate in both bands nor to switch between them during operation. Narrowband data transmission may be at rates of about 2 Mbit/s, for example, and broadband data transmission may be at rates in the range of about 54 to about 600 Mbit/s.

Certain embodiments may be self-acting, with event “awareness”, wherein actions of each individual pole are taken based on that pole's “view” of its local sensor data (solar collection data, motion sensor data, wind or barometric pressure, etc.). Such “event awareness” may take the form, for example, of “detect-trigger-action” (also, “sense-trigger-control”) modes, as will be further discussed later in this document. For example, various sensing or self-diagnosis apparatus/methods may be the “detect” step, which trigger the control system (broadly called “controller” herein), to take an action based on firmware, software, set-points or other inputs, historical data, algorithms, etc.

Certain embodiments may perform cooperative/community actions, also called “coordinated activities”, wherein the poles/network utilize wireless networking to allow operation of poles and attached devices to change/respond in operation of pole(s) based on detection by adjacent poles within the community. Thus, detection by one or more poles/devices may trigger the control system(s)/controller(s) to take action for the detecting poles/devices and/or adjacent or distant poles/devices. This includes small network actions (10-100 poles), city-wide actions, and/or large area networks, and part of this includes the “self-organizing” & “self-recognition” of new poles joining the network characteristic of Mesh or ZigBee networks.

Certain embodiments comprise remote configuration, wherein changes to the wireless controller can be done remotely via the internet web interface, which this includes new programming, firmware, upgrades, troubleshooting and repair (system reset if required), etc. These changes/configuration may provide pole/node management for coordinated actions such as “light the way”, power delivery to/from the grid, and/or content services, as discussed in more detail elsewhere in this document.

Certain embodiments comprise the preferred poles and network being made with a large amount of modularity. For example, this may be done by using an “open” architecture, including the utilization of standard open protocols, hardware and architecture, with universal bussing that allows the implementation of new systems, and/or devices that may be needed on the poles.

Certain embodiments may comprise financial transactions being communicated via RF, security cameras providing data and video to law enforcement, and WI-FI routers providing services. Both for “on-pole” devices and “off-pole” devices, the long-term supportability of the system is provided by the control system self-healing and repair functions, together with the capability of ground level access and repair. Security (system/network protection) is designed to limit connectivity and access based on who is attempting to connect to the network; new devices will immediately connect to the network, but under a systematic quarantine period to determine device type & authorization level.

### Peak Load Delay Energy Conservation System:

The main objective of certain embodiments is to provide a system to delay or off-load electrical energy usage to hours of the day when load on the utility grid is lower. Specifically, certain embodiments have an integral battery or other energy storage unit(s) (ESUs) that is/are recharged by the electrical grid during off-peak load times of the day. The stored energy in the batteries or other energy storage unit(s) can be utilized to provide power to the grid during peak load periods and/or to provide power to a light or other electrical device on or near the utility units/poles during peak load periods. The stored energy in the batteries or other energy storage unit(s) may optionally provide power to said light or other electrical device during power outages.

Optionally, the system/device may be autonomous in that it may be powered at least part-time by an integral renewable energy collection system such as a solar collector and/or wind energy device. Such embodiments may provide power from their own energy storage devices to their own electric-powered load device (light or other) specifically during times of peak load on the grid, and also manage the power between the energy storage device and the local electrical device to ensure adequate power to that local electrical device during said peak load hours. In other words, the management system is adapted to store energy when possible and use the stored energy in an efficient and controlled manner during peak load hours. This way, demand on the grid during those peak hours is reduced, and local load devices that must be turned on for public safety and security are indeed turned on and adequately powered. Further, power may be managed in such a way to supply power to the grid during certain periods, and the device may then be “self-powered” during prolonged periods of electrical grid power outage. For embodiments comprising solar collectors, the “insurance” of being connected to the grid may be particularly beneficial in cloudy climates, during inclement months, or where the grid needs or can benefit from the solar-collected power during peak load times.

In certain embodiments, the battery or other energy storage unit and other necessary system components (described below) may be integrated into the light fixture itself so that it can be installed as a complete unit onto/in an existing or new pole. Alternatively, some or all of said battery or other storage unit and/or other necessary system components may be manufactured and installed separate and/or distanced from the light fixture, for example, when a new pole is provided with some or all of this equipment inside the pole or inside the base below the pole.

Some, but not all, of the modes of operation of certain embodiments may be described as follows. Each night during peak load periods, for example when it first starts to get dark outside, a photocell or other light sensor turns on the light with power from the energy storage pack (energy storage unit, ESUs), so that no electrical load is added to the grid during peak load periods. Once the peak loading time period has passed, the light will then continue to be powered by the energy storage pack, however, the ESU will then be charged by the line voltage (grid) during the time period when peak loading is no longer an issue (in the early morning hours, for example) via the energy storage unit charger. The LEDs, control board and all other system components are operated on DC voltage. The energy storage pack preferably only needs enough power to carry the light thru the peak loading period for one night (typically only 3-4 hours post dusk), but, optionally, may be designed for enough power to provide power to the grid during said peak loading period. The energy storage pack will then be charged in the morning for later use that evening or night.

It may be noted that certain embodiments utilize a photocell as a light sensor to indicate light and dark, and especially to demarcate dawn and dusk, but other light sensors may be used. For example, in certain embodiments, the solar collector (PV panel) used in energy production for the utility units/poles may also be used as the light sensor. The solar collector's voltage varies with the amount of sunshine bathing its surface. By measuring this voltage and then correlating it over numerous dawn and disk transitions, a statistically significant voltage value or range of values is derived to represent dawn and dusk transitions. Once correlated with generally acceptable visual representations of dawn and dusk, these voltage values may be used to signal dawn and dusk to the utility system/pole(s).

Additional features may be added, for example, dimming capability to reduce the light output after the first hour. Such a dimming capability, for example, may allow the light to have a much higher lumen output when it first turns on & then dims it down as the night progresses and less light is needed. Another option is to include a motion sensor over-ride that will immediately turn the light back up to full brightness when motion is detected near the pole, for example, motion of a person, a bicycle, or a vehicle. Both of these features allow the light to be “tuned” to the specific application requirements and to conserve as much energy as possible. This will allow the energy storage pack to be as small as possible to reduce costs and to reduce the size and weight of the fixture. See, particularly, the section entitled “Active Control for Energy-Efficient Lighting” later in this document.

The additional feature of having a wireless control board, for example as described earlier in this document, allows the control settings on the light and/or the other electrically-powered load devices to be changed remotely and allows for the light/loads performance to be monitored remotely. For example, the power company may check to see how each of the lights/loads are performing and confirm that the light/loads is/are running off of battery/ESU power for the full amount of time required for the peak loading period. The owner of the light/loads may check the status of all system features, the batter/ESU health, and whether any maintenance items need attention, for example, LEDs that need to be replaced and battery chargers that are not working properly, etc.

An example of one peak load delay conservation system that uses an integral light, storage and control unit 600 is schematically portrayed in FIG. 22, wherein said integral unit 600 comprises the following elements listed by call-out number: fixture box 602, such as “shoebox” or “cobrahead” or other standard or custom light fixture housing or body; lens 604 connected to said box 602; fixture arm and/or bracket 606 to mount fixture to pole; energy storage pack 608, which may comprise batteries or other energy storage apparatus; energy storage pack charger 610; LED light engine 612, which may be of various designs; motion sensor & photocell 614; and control board w/wireless modem and/or cell phone radio 616. While such integral units are preferred, it will be understood by those in skill in the art reading and viewing this document and its figures, that peak load delay conservation systems according to certain embodiments of the invention could also be installed on existing or new light/equipment poles with the elements called-out for FIG. 22 being provided in separated housings and/or in spaced-apart locations on the pole.

Those of skill in the field of electrical grid management will be able to construct stems that detect peak load periods on the grid and/or that detect when loads exceed a predetermined level in smaller power grids such as a residence, that control electrical devices to reduce power demand and/or that use power from stored power sources (ESUs) to supplement power demand during periods of peak loads. After reading this disclosure, those of skill in the art will understand how to recharge, during off-peak hours, the energy storage devices of the preferred outdoor lighting systems of the invention, and how to monitor power being fed back to the grid from lighting systems according to embodiments of the invention, so as to bill energy credits to the utility company.

### Autonomous Connected Devices:

Many of the invented lighting networks, with or without additional or alternative powered equipment (such as alarms, Wi-Fi hotspots, advertising or public information dissemination, for example) are autonomous, in that they may be powered by preferably renewable energy sources and, therefore, may be separate from and not dependent or co-operational with the electric grid, or they may be self-powered during at least part of the time but may also cooperate with the grid to provide energy to the grid and/or accept energy from the grid only at certain times. Such Autonomous Connected Devices (ACD) combine a solar engine, for example as described elsewhere in this document, with a smart wireless mesh, such as described elsewhere in this document, for example, in the section Wireless Intelligent Outdoor Lighting System (WIOLS). Much of the apparatus shown in previously-discussed figures of this document may be used in the ACD's, for example, FIGS. 1-17 and 19-21, as will understood from the descriptions and discussions of those figures; additional apparatus and methods are discussed below.

ACDs may be especially beneficial in remote areas and rural settlements, municipalities, housing associations, industrial complexes, developing countries, or other entities or regions that have no option to connect to a grid, want/need to have no connection to the grid, or want substantial autonomy but are willing to cooperate with the grid by supplying the grid with energy some times and accepting energy from the grid at other times. One group of embodiments of the latter category (self-powering combined with cooperation with the grid) is described in the section “Peak Load Delay Energy Conservation System” above. While the preferred ADC's are powered by solar engines (solar panels and/or other solar devices), wind-powered engines may be used instead or in addition to the solar engines.

It will be understood that many features of the ADCs overlap with the features of the WIOLS, as a WIOLS is the preferred form of monitoring and controlling a ADC network but WIOLS technology may be applied in either ADC's or grid-dependent devices. In addition to providing lighting to entities or regions such as are listed above, ACD's, and their WIOLS, may provide one or more of said powered equipment, including devices to provide “content services” such as information gathering (weather conditions, fire or floor conditions, etc.), or information dissemination (advertising or warnings in the form of digital or other visual displays or audible announcements, etc.). Thus, Autonomous Connected Devices (ACD) combine a solar engine providing self-contained power with as smart wireless mesh for connectivity and content services to enable new social and business models to be built from populations of devices.

The preferred solar engine collects solar energy using photovoltaics, controls the flow of solar energy, stores solar energy for optimal use, and delivers energy at the right voltage and current to devices. The smart wireless mesh that is preferably used to connect said ACD organizes itself, repairs connectivity issues automatically, communicates data seamlessly, and cooperates in group activities.

An ADC network may be used to aggregate information widely, monitor issues remotely, manage operational excellence, and analyze behavioral & environmental trends over large geographies, so that said analysis may be shared with customers and/or the public.

ACD devices benefit from being autonomous yet connected. For example, a population of remotely managed street and area lights according to ACD embodiments, may be economical and effective where the cost of trenching to deliver power is cost-prohibitive. Grid-neutral outdoor lighting may be installed, according to embodiments of the invented ACD networks, that offsets wired energy usage by collecting, metering and returning solar energy to the grid, for example according to the Peak Load Delay systems described earlier in this document.

Examples of ACD applications, features, and benefits may include:

1. Remotely monitored & managed, grid-tied LED retrofits that may provide a remote physical security installation with light, video, security gate and sensor fencing.
2. Ubiquitous broadband internet access provided preferably by multiple of the poles in an ACD network.
3. Power, light and internet access for third world village libraries.
4. Lighting, Wi-Fi hotspots, and video cameras on poles of a single ACD network;
5. Monitoring & management allowing operational and environmental data gathering over wide areas of network apparatus and/or wide areas of land, therefore allowing alerts, inventory control, and information dissemination not previously possible in such an efficient and accurate manner.
6. New social & business models possible by using the invented ACD, as information gathering, information dissemination, and energy and internet access may be available to more people and more efficiently and accurately.
7. Simplicity and adaptations that allow off-the-shelf components to be used in the ACD.
8. Employing of “smart” data and “dumb” code.
9. Keeping components separate, loosely bound and stateless.
10. Comprising a secure, low-power backhaul for monitoring & management of diverse populations of devices.
11. Aggregates operational & environmental content across wide geographic areas using ubiquitous infrastructure elements like light poles.
12. The preferred solar engine employed in ACD networks generalizes solar collection, power management, energy storage and power delivery.
13. Manufacture and install-time power delivery configuration (e.g., voltage, current, wiring harnesses).
14. Maximize energy budget over time by optimizing solar collection via optimizing the PV “skin” plus charge controller, and by smart usage profiles via optimizing sensors plus control board plus algorithms.
15. Granular operational data, including PV, charge controller and battery metrics, and consumption metering of device activities, including dumping energy back onto the grid.
16. Remotely updatable firmware & profiles.

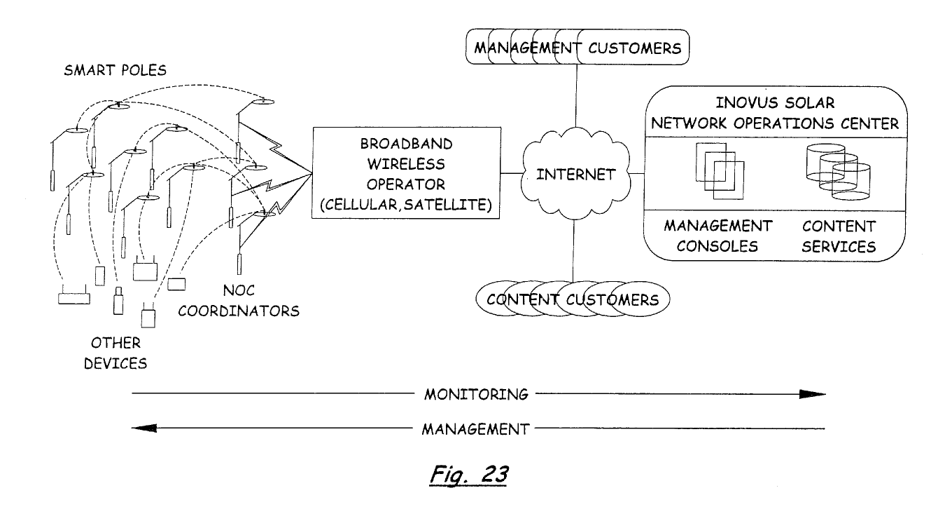

As portrayed in FIG. 23, the preferred ACD system architecture comprises devices that are powered by the solar engine, either on-pole, near-pole, and/or in the general vicinity of the preferred wireless communication from the pole. Secure two-way communications between the poles and the NOC coordinator poles (for example, master poles) and the Internet and/or headquarters (for example, control station) are accomplished by a “smart” mesh network. Both content customers (such as weather service or traffic planners, for example) and management customers may receive content via the Internet.

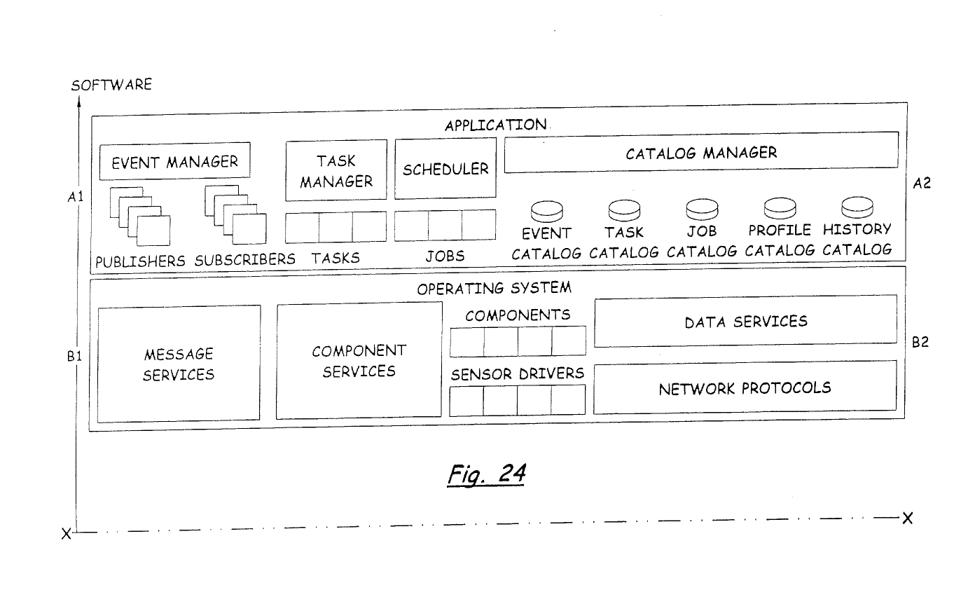

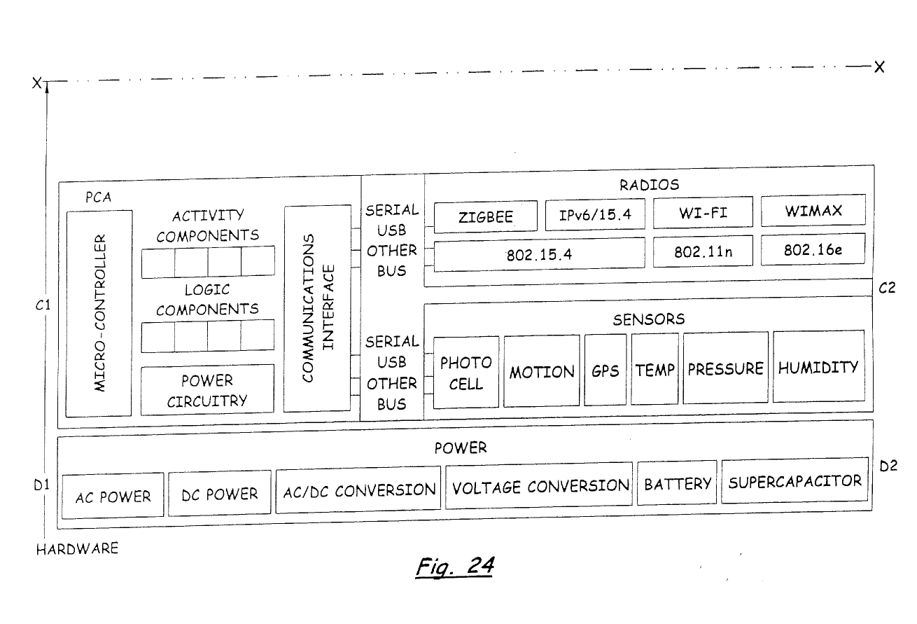

An ACD needs power, performs activities (e.g., lighting, Wi-Fi, video) makes decisions, monitors operational and environmental data and participates in collective behavior. As portrayed in FIG. 24, the preferred ACD system may be described as having an Application Layer (A1) (e.g., power profile applications, light-the-way applications, grid neutral metering, which utilize on-device and collective intelligence algorithms (A2). Also, the preferred ACD system has event Driven OS w/Driver Abstraction (e.g., TinyOS) (B1), which utilizes unique event-driven device drivers for device capabilities (B2). Also, the preferred ACD system comprises hardware (chipsets, sensors, radios, etc) (C1), preferably utilizing a system that is flexible and expandable as the hardware evolves (C2), for example, as protocols, radios and sensors evolve. The Power Abstraction Layer (D1) of the preferred ACD system utilizes standardized and normalized power delivery (D2).

The preferred smart wireless mesh connects ACDs into a self-organizing, self-repairing mesh that enables low-power, two-way communications; remote troubleshooting and repair; system monitoring and management; environmental sensing; collective intelligence; and wide area content aggregation and analytics. Smart Wireless Mesh-Topology

The “Smart Wireless Mesh Network” of the preferred ACD comprises each “population” (each networked group, each wirelessly-connected plurality of ACDs) having a Gateway Node, which performs low to high bandwidth mapping as “NOC coordinator,” initiates mesh forming as “mesh coordinator”, and oversees mesh healing. Each population of ACDs also has Router Nodes that aid in locating other nodes, cache data for “sleeping children” poles (hibernating or unused at the time), and that reinforce “good” paths. Each population of ACDs also has End Nodes, which feature minimal energy use, wake to connect on demand, and are activity & connection independent. Then device functionality is overlaid atop the mesh topology of Isolated Devices needing slow uni-cast connectivity for monitoring and maintenance (e.g., environmental sensors); Collective Devices needing slow multi-cast connectivity for group behavior (e.g., “light the way”); and Streaming Devices need fast uni-cast connectivity for real-time throughput (e.g., contextual advertising).

The supportability of the preferred Smart Wireless Mesh may be illustrated by response to an event such as device connectivity loss, whereafter:

1. Scheduled report-back job flags a customer's non-reporting node;
2. Service sends a device down alert to device manager's mobile phone;
3. Device ping confirms—no connectivity;
4. In-field support tech dispatched;
5. Ground-level panel opened;
6. Reset button pushed; and
7. After a short time, status lights indicate all systems are operational!
Or, after mesh connectivity lost, the response may be:
1. Report-back job indicates a mesh coordinator node is down;
2. Device in adjacent mesh is remotely repurposed;
3. End node program replaced with mesh coordinator program—OTA;
4. Device remotely reset;
5. New mesh coordinator finds orphaned nodes, reforms mesh; and
6. Support tech dispatched, resets old mesh coordinator, re-joins as end node.

The preferred smart wireless mesh is “open” yet secure, for example, the smart wireless mesh is open in that it adheres to the ZigBee protocol (i.e., IEEE 802.15.4-2006 standard for wireless personal area networks) and allows any device supporting ZigBee to join the mesh at anytime.

The smart wireless mesh is secure in that it features a quarantine (a period of time with limited connectivity while behavior is watched and deemed proper for device type, or not), for example, verified, then isolated, then meshed, then monitored, then managed. The wireless mesh comprises selectable paths, whereby the connectivity path is selected based on sensitivity of data being moved, for example, unprotected data is moved by unencrypted ZigBee over 802.15.4 (mesh forming and healing, collective behavior, for example); protected date is moved by E2E tunnel-mode VPN using IPv6 over 802.15.4 (remotely updating security keys over-the-air, change operating profile, for example).

The preferred ACDs are widely distributed and therefore, event driven. Events connect sub-systems within a single device, devices within a smart wireless mesh, the mesh network with content services in the Network Operations Center (control station). Events have triggers that percolate up through HW & OS abstractions; that are discrete (single-instance, occurring once—e.g., motion detector registers a change) or are continuous (multi-instance, streaming over time—e.g., battery current). Events are classified along three dimensions, specifically, type (info|warning|error|monitor|manage); scope (device|mesh|service|customer); and risk (low|medium|high).

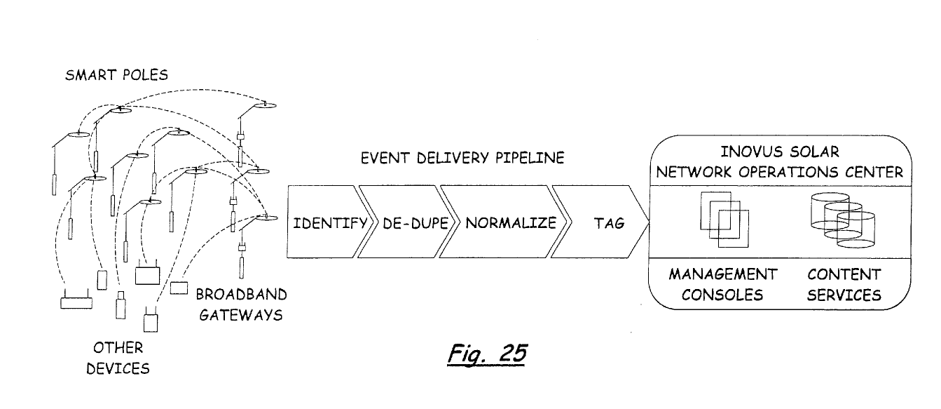

The monitoring processes of the ACD network delivers service and customer scoped events from the field to the Network Operations Center as they occur, enabling alerts when predefined conditions are met to facilitate cost-effective maintenance and aggregation of operational and environmental data over large populations of devices to facilitate troubleshooting and value-added content. See the Event Delivery Pipeline in FIG. 25, wherein the box “Identify” refers to a unique device ID (identification) resolved to assembly IDs, manufacturer, installer, support, service log and customer; wherein “De-Dupe” refers to multi-path routing with delivery delays can cause duplications that get collapsed using unique identifiers; wherein “Normalize” refers to device and sub-system version differences being normalized on the way in, to maintain consistency at the NOC; and wherein “Tag” refers to metadata derived from context and route being added to events on the way in (duplicate plus alternate routes).

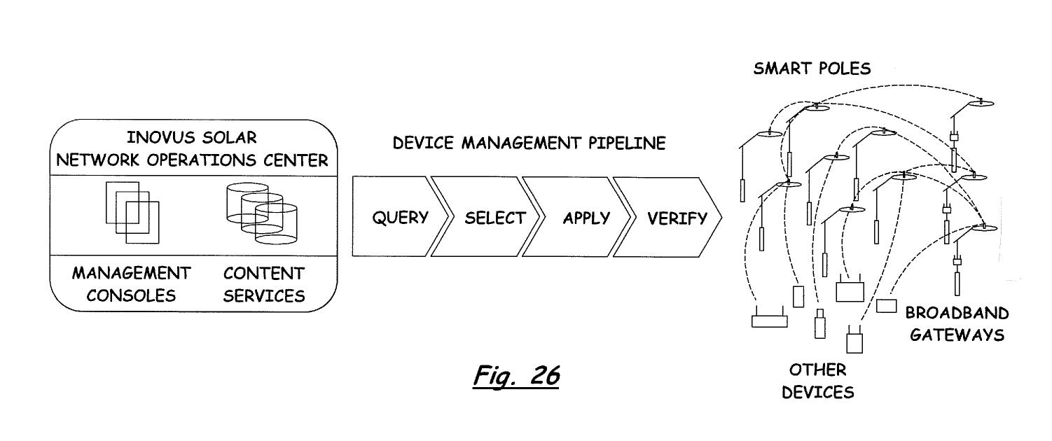

The management processes of the ACD network operate on sets of devices, selected at the Network Operations Center, then targeted with events delivered using the smart wireless mesh to enable remote device reset (like CTRL+ALT+DEL), whole system inventory (e.g., assembly ids, HW/SW/FW versions); data, profile & SW/FW updates over the air; and programmed tasks (e.g., stream video every night at 10 PM for 5 minutes). See the Device Management Pipeline of FIG. 26, wherein the box “Query” refers to leveraging of internet search technology to query populations of devices that meet specific characteristics; wherein “Select” refers to sorting and sifting to further refine the set of devices and creating a narrowly targeted set to select and operate on; wherein “Apply” refers to defining a task, scheduling a job containing one or more tasks then applying the job to the set of selected devices; and wherein “Verify” refers to leveraging monitoring, verifying the job and tasks were executed, events were delivered to devices, actions performed and results achieved.

As discussed briefly elsewhere in this document, “content services” may be a feature of the preferred ACD and/or other wireless network. Content aggregated across wide populations of devices, combined with the ability to reach out a touch an individual device remotely, enables services such as customer account creation, user identification, and authorization; device identification and provisioning; and account and device disablement. Also, content services are enabled that comprise management such as troubleshooting and repair, inventory control w/updatable code, profiles and data, and scheduled device or population jobs/tasks. Also, content services are enabled that comprise “visualization” features, such as overlays (Google maps, insolation, energy costs), customer dashboards w/KPIs for devices, and redistributable “widgets” for partner networks. Also, content services are enabled that comprise monitoring such as granular event logging over time, predefined thresholds with actions, and automatic actions or email/text alerts. Also, content services are enabled that comprise analytics, such as searching, sorting and refining devices by attributes, and correlating operational with environmental and location to feed back into optimizations and roadmap.

Enabling new social & business models from populations of devices requires a services system with redundant, commodity HW paradigm (like Google—i.e., 5×9's of reliability via quick healing), real-time and batch inbound processing pipeline to maintain data integrity, a presentation layer rich with visualization and Web 2.0 sharing (e.g., widgets), and data interfaces/schema for converting and then delivering data to customers in any format (e.g., XML schema and connectors for SOAP). Preferably, these services comprise location-based visualization with overlays and real-time search engine based filtering; auto and manual metadata tagging to support powerful analytics; and creating jobs w/tasks then targeting devices for delivery and execution.

ACD services are connected to the Internet, so they must be designed securely by employing a Threat Model. Such a Threat Model will comprise Assets & Risks analysis and Vulnerabilities and Safeguards analysis. Periodic Security Assessments should also be made, including intrusion detection, DoS; and independent security certification, if required by customers.

The outline below lists some, but not all, of the preferred features/options that may be included in various embodiments of the ACD invention. This outline is organized into the following three categories: features provided and/or programmed mainly, or entirely, “on device,” that is, on the pole and/or the lighting or equipment unit on the pole; features of the preferred smart wireless mesh for the ACD's; and content services.

### 1. ON DEVICE

There is a collection of structural elements, methods, and algorithms that reside on preferably each device.

### 1.1 SOLAR DEVICE

1.1.1 Device design elements and algorithms for maximizing solar collection capabilities:
1.1.1.1 Relationship between pole height, location on solar isolation map and amp-hours;
1.1.1.2 Relationship between pole diameter, location & amp-hours; and
1.1.1.3 Relationship between PV efficiency and 1.1.5.1 or 1.1.5.2.
1.1.2 Hardware and interfaces for configuring power delivery options like voltage and current during manufacturing and/or installation to support multiple different device activities (e.g., lighting, security gate, broadband wireless.)
1.1.3 Configurable wiring harness(es) and routing to support multiple device activities powered on-device (e.g., lighting, video and broadband wireless at the top of the device, USB attachments at ground level) and off-device (e.g., security gate and sensor fence.)
1.1.4 Granular operational and environmental data logging to correlate solar collection and charge characteristics as a function of location and environmental information (e.g., average daily sunshine, temperature, pressure, humidity.)
1.1.5 Algorithms for determining when and how much energy to invert back onto the grid as a function of device operational and environmental parameters.
1.1.6 Algorithms for minimizing energy consumption as a function of device operational and environmental parameters as well as sensor triggers like photo cell and motion.
1.1.7 A separable solar engine kit that includes solar collector, charge controller, energy storage, delivery and wireless monitoring backhaul; along with all the connectors—mechanical, electrical & software/firmware interface—to enable third parties to install our solar engine on other types of devices.

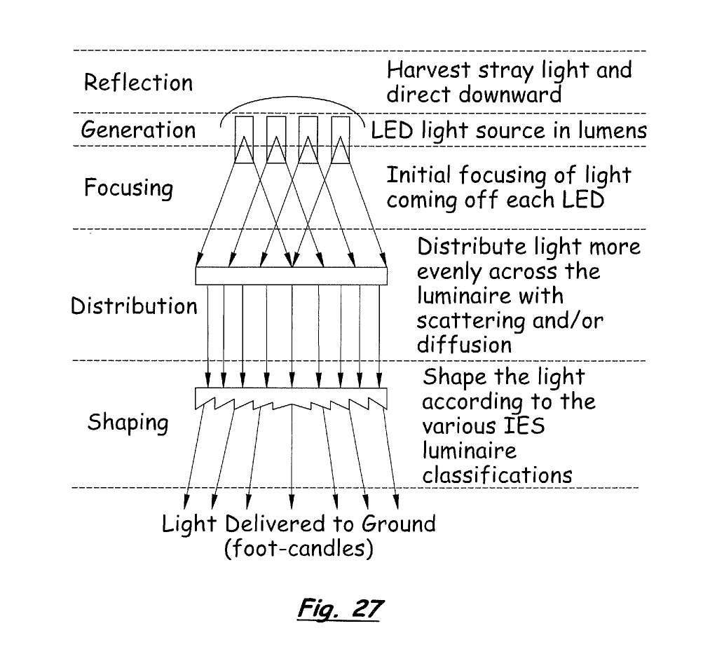

### 1.2 LIGHT DELIVERY STACK (SEE FIG. 27)

1.2.1 Delineate light delivery into distinct layers with unique parameters that can be independently adjusted to meet overall intensity and shape requirements cost effectively.
1.2.2 A whole-luminaire, high efficiency lens that integrates diffusion technology for smoothing light distribution where there are hotspots with Fresnel lens technology to direct light at precise wide angles to achieve standard IES luminaire distribution types I thru V and sufficient environmental protection to achieve IP65/66 approval.
1.2.3 A luminaire mounting plate with highly adjustable LED module mounts that enable cost effective, highly variable lighting patterns outside of the standard IES types I thru V, along with algorithms for how to adjust modules to achieve a given light distribution.

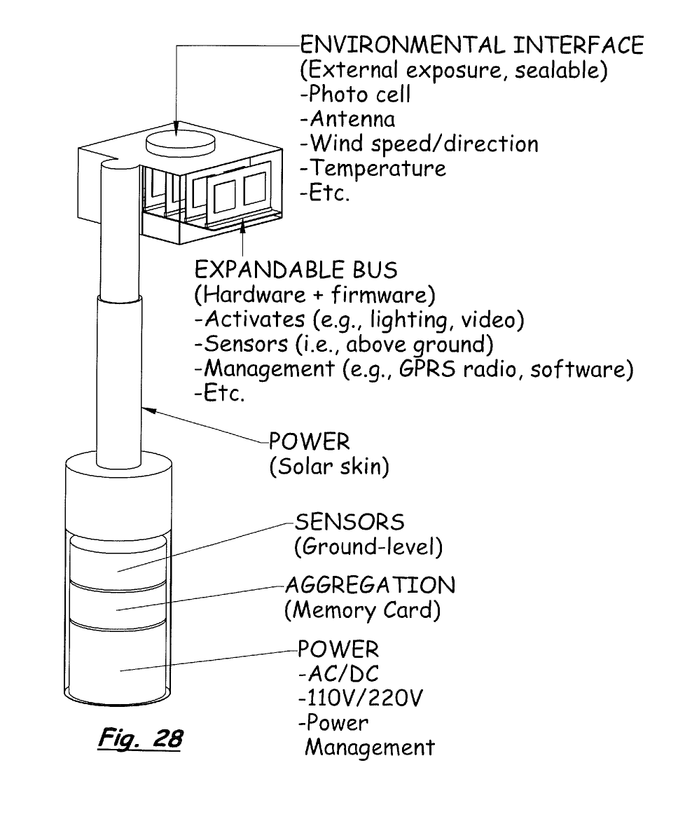

### 1.3 MODULARITY (SEE FIG. 28)

1.3.1 Mechanical modularity of devices that allows different activities to be attached and configured easily at manufacturing time, installation time or even in the field post install (e.g., Inovus Solar LED shoebox, Lithonia LED shoebox, shoebox lighting plus Sony internet video camera and PowerFence high-voltage sensor fence.)
1.3.2 Harness, conduit and wiring that enables batteries to be located off-board, meaning off the device yet wired into the device.
1.3.3 Well defined abstractions with interfaces to allow wireless connectivity hardware and protocols to evolve over time and be upgraded without affecting the architecture or higher-level applications relying upon this connectivity.

### 1.4 DIAGNOSTICS & REPAIR

1.4.1 Algorithms to diagnose which Energy Storage Unit pack(s) has a bad or failing Energy Storage Unit.
1.4.2 Algorithms to determine whether the Light Sensitive Device is failing or failed.
1.4.3 Algorithms to determine whether any of the Motion Sensing or Occupancy Sensing devices are failing or failed.
1.4.4 Algorithms to determine whether any of the Light Emitting Devices (i.e. LED modules) are failing or failed.
1.4.5 Algorithms to determine whether the AC/DC power converter is failing or failed.
   1.4.5.1 Algorithms to reset AC/DC power converter (either wirelessly or via hardwire connection)
1.4.6 Algorithms to determine whether the Charge Controller (device converting energy from the Power Generator to energy to be stored or consumed) is failing or failed.
   1.4.6.1 Algorithms to reset Charge Controller (either wirelessly or via hardwire connection)
1.4.7 Algorithms to determine whether the Power Generator (i.e. Solar Panel) is failing or failed.
1.4.8 Algorithms to determine whether the power inverter is failing or failed.
   1.4.8.1 Algorithms to reset power inverter (either wirelessly or via hardwire connection)
1.4.9 Algorithms to determine whether the Control Board is failing or failed.
   1.4.9.1 Algorithms to reset Control Board (either wirelessly or via hardwire connection);
   1.4.9.2 Algorithms to test various subsystems and/or subroutines on the Control Board (either wirelessly or via hardwire connection);
   1.4.9.3 Algorithms to put selected subsystems and/or subroutines in selected states (either wirelessly or via hardwire connection); and
   1.4.9.4 Algorithms to reset various subsystems and/or subroutines on the Control Board, including entire Control Board (either wirelessly or via hardwire connection)
1.4.10 Algorithms to determine whether other devices (such as a security camera) are failing or failed.
1.4.11 Algorithms to reset those other devices (either wirelessly or via hardwire connection)

### 1.5 SUPPORTABILITY

1.5.1 All operational parameters that affect how the systems and algorithms behave are abstracted out of the code, leaving behind variables in the code that are evaluated at system start
1.5.2 Operational parameters are stored separately from code in a profile that is easily read and processed by the code
   1.5.3.1 The profile should be easy to replace in its entirety
   1.5.3.2 Individual values for operational parameters in the profile should be easy to replace
1.5.3 On system restart or reset, all systems and algorithms flush their values for operational parameters then re-read and re-process operational parameters from the profile
1.5.4 A method for resetting the device at ground level (i.e. standing on the street), like a reset button. Pushing this button is the equivalent to power cycling the system, which causes all hardware, firmware and software to re-initialize, re-read and re-process all operational parameters
1.5.5 A method for indicating device system status, like a 3-color light or set of lights (e.g., green, yellow, red) at ground level that conveys one of three states: operating properly, operating but there is an issue needing attention, and not operating. This provides ground level feedback regarding whether to push the reset button as well as whether or not pushing the reset button resolved the issue.
1.5.6 A method for providing a ground-level memory card reader (e.g., CompactFlash, SmartMedia)
1.5.7 Memory card reader is bootable, meaning on reset the card reader is checked for a set of operational parameters and if exists, these operational parameters are used instead of any others that may be onboard
1.5.8 System logging persists on a memory card in the ground level slot so that the card can easily be replaced, with logging data taking back for more thorough analysis than can reasonably occur in the field
1.5.9 Amount of memory for operational parameters and logging is easily increased by replacing lower capacity card with higher capacity card over time
1.5.10 Methods and algorithms for creating modularity of systems on the device
1.5.11 Facilitate unit testing as the number of components increases
1.5.12 More easily enable in-field, black-box replacing as a cost effective support strategy in the field
1.5.13 Replaced modules are sent back to Inovus Solar or certified service rep for troubleshooting, repair and recirculation
1.5.14 Methods and algorithms for enabling an expandable bus architecture on the device to enable in-field hardware feature expandability over time (e.g., new sensor, high bandwidth radio, video camera)

### 1.6 ENVIRONMENTAL SENSING

1.6.1 Methods for collecting and logging environmental data (e.g., luminosity, temperature, humidity, pressure, wind speed) for later use and correlation with other information like device operational parameters.
1.6.2 Methods for adding, configuring and enabling sensors on a device during manufacturing, installation and/or in the field.

### 2. SMART WIRELESS MESH

The basics of mesh networks are known by mesh providers, such as self-organizing, repairing, route optimization via feedback, etc. However, some unique innovations occur in how mesh networking is used to meet the goals of ACDs, for example, the following features.

### 2.1 MESH

2.1.1 Methods for providing different backhaul channels to meet the characteristics of different types of device data (e.g., low bandwidth, best efforts, open channel; high bandwidth, guaranteed delivery, VPN channel)
2.1.2 Algorithm for selecting a backhaul channel based on the characteristics of a specific type of device data, that is, data-driven backhaul channels (e.g., for small size, non-critical, insensitive data, use low bandwidth, best efforts, open channel; for streaming, real-time sensitive data, use high bandwidth, guaranteed delivery, VPN channel)
2.1.3 Method and algorithms for periodically polling the mesh, checking differences in the responses, using these differences to determine when individual devices are unresponsive and then taking action: sending alerts, repurposing a nearby functioning device to assume unresponsive device's role, dispatching field support to reset or troubleshoot if necessary, etc.

### 2.2 QUARANTINE

2.2.1 A method for allowing formerly unknown devices to join a mesh, but to limit the functionality of the device—and therefore its risk to the overall system—until the device successfully passes several well defined phases of quarantine.
2.2.2 Algorithms for describing what behavior and conditions must be met for each phase of quarantine and then determining when a specific unknown device successfully meets these conditions.

### 2.3 COLLECTIVE INTELLIGENCE

2.3.1 A method for sharing information wirelessly with a collection of devices, having each device in the collection perform tasks to make one or more determinations, and then sharing these determinations with other devices in the collection yielding a result that causes a change in the behavior of a collection (e.g., two or more lighting devices determine a walker's direction and speed and then light the way ahead of the walker.)
2.3.2 An algorithm for lighting the way ahead of a moving object (e.g., walker, automobile.)
2.3.3 An algorithm for pointing a POV video camera in the direction of meaningful activity and following that activity as it moves.
2.3.4 An algorithm for using motion triggered lighting across a large collection of lighting devices as a way of indicating where potentially meaningful activity is occurring (e.g., border crossing, college campus.)
2.3.5 An algorithm for targeting advertisements to devices that follow an individual user as they move.
2.3.6 Algorithms around how, where and how redundantly to register a device's capabilities on a network
2.3.7 Algorithms for determining connectivity issues on the network, routing around issues, repairing issues and reestablishing routes once repaired
2.3.8 Algorithms for favoring efficient routing, penalizing inefficient routing and adjusting both over time based on changeable definitions of efficiency
2.3.9 Algorithms for locating and sharing resources on the network as resource availability and location changes over time
2.3.10 Algorithms for securing the network against unauthorized network joins and ensuring intra-network communications cannot easily be intercepted and interpreted
2.3.11 Algorithms for using monitoring events across a population of devices to determine a coordinated action to take like lighting the way ahead of a walker along a pathway or turning on a video camera based on triangulation of multiple device motion sensors
   2.3.11.1 Algorithms that detect motion (direction and velocity) and estimate the future direction and location of the moving object as a function of time.
   2.3.11.2 Algorithms that activate devices based on the anticipated location of the moving object per the algorithms in 5.2.3.1. (i.e. turning on or brightening lights or turning on/waking up security cameras ahead of a moving car or moving person.)
2.3.12 Algorithms for determining the location of a device based on known fixed locations and triangulation of multiple device radio signals
2.3.13 Algorithms that allow devices in a network to look for and sense different sensors that come into range of the wireless sensor(s) on the devices.
2.3.14 Algorithms that allow devices in a network to identify and categorize the different types of sensors that come into range of the wireless sensor(s) on the devices.

### 2.4 REMOTE TROUBLESHOOTING

2.4.1 A method and algorithms for periodically querying a population of devices for connectivity, comparing these snapshots differentially and determining when individual devices have lost connectivity
2.4.3 A method for remotely resetting a device, which has the effect of cycling the power on the device, flushing all runtime memory and then reloading and restarting all systems on the device.

### 2.5 EVENT MANAGEMENT

2.5.1 Algorithms for monitoring and storing discrete and continuous triggers, interpreting triggers and translating them into events to be published
2.5.2 Algorithms for subscribing to and receiving events with specified attributes as a way of performing a task in response to a published event
2.5.3 Algorithms for interpreting one or a collection of conditions, assessing their severity and then determining whether a warning or error condition exists.
2.5.4 Algorithms around scheduling jobs at predefined times and/or with predefined frequencies to perform tasks
2.5.5 Algorithms enabling the way an event gets treated throughout the system to be dictated by the classification and characteristics of the event itself
2.5.6 Algorithms for aggregating events over populations of devices, rolling up event information based on criteria, interpreting low-level event information and using it to create new higher-order events
2.5.7 Algorithms involving securely bridging a low-power, low-bandwidth network and a medium-power, high-bandwidth network, or providing secure gateway capabilities between the two networks.
2.5.8 Algorithms for aggregating information across populations of devices and securely delivering this information through a broadband wireless infrastructure to an Inovus operated network operations center.
2.5.9 Algorithms for guaranteed or best-efforts delivery of information to the network operations center based on the classification of the information.

### 3. CONTENT SERVICES

Methods and elements for delivering content services via ACD's are described below, which content services may be delivered by a single ACD but more preferably are delivered by a network of multiple ACD's. Delivering said content services may be in one or more directions, for example, gathering of information from a population (multiple) networked poles for transmittal preferably to a master pole and then to a control station for processing and/or use, or (in the opposite direction) dissemination of information, advertising, alarms, or other content by the control station to the master pole and then to one or more of the slave poles in the network.

### 3.1 MONITORING

3.1.1 Methods for setting thresholds for values generated by devices or populations of devices that when met, cause actions to be taken like sending an email or text alert, raising other events, etc.

### 3.2 MANAGEMENT

3.2.1 Methods for defining a task or set of dependent tasks to be delivered to populations of devices and then executed.
3.2.2 Methods for defining jobs, comprised of a task or group of dependent tasks, that can be scheduled for delivery and execution to a population of devices.
3.2.3 Algorithms around creating and managing user/customer accounts and passwords with associated roles and permissions that span different kinds of customers as well as the needs of Inovus itself
3.2.4 Algorithms that enable authentication of individual users to specific accounts and roles with associated permissions, and tracks failed authentication attempts for intrusion detection security
3.2.5 Algorithms for authorizing individual users/customers to access and use only their devices and associated data
3.2.6 Algorithms for detecting when security might be compromised anywhere in the system and taking action once security is believed to be compromised such as locking out a user or customer, denying access to devices or data, locking out parts of the system globally or by customer and flushing all security keys requiring re-initialization throughout the system of all security subsystems.
3.2.7 Algorithms for creating sets of devices that meet pre-defined conditions then proactively and remotely managing these devices including resetting, updating firmware, updating operational parameters, triggering on-demand information delivery, troubleshooting issues, overriding operation for prescribed periods of time, etc.
3.2.8 Analytical algorithms that operated on aggregated information at the Inovus network operations center and provide customers with all manner of operational and environmental insights.
3.2.9 Algorithms that allow a network of devices to manage power being pulled from the power grid or placed back onto the power grid.
3.2.9.1 Algorithms that allow a network of devices on the grid to put power onto the grid a desired times, either as certain criteria are sensed and met on the grid, or via a command from a central command center or a Network Operation Center (NOC).
3.2.9.2 Algorithms to draw power from the grid at desired times, as certain criteria are sensed and met on the grid, or via a command from a NOC.
3.2.10 Algorithms to vary the control signal to the load(s) to test its operation (i.e. to test the ability of the light to run full brightness and dim down to various dimming levels). See, also, the section entitled “Active Control for Energy-Efficient Lighting” later in this document.

### 3.3 VISUALIZATION

3.3.1 Algorithms for placing devices on a map based on precise location, and then overlaying weather, insolation, energy cost, other meaningful data. over these mapped devices.
3.3.2 Methods for graphically illustrating key monitoring metrics for devices (e.g., KPI, ROI) in a dashboard.
3.3.3 Methods for enabling the distribution of summary monitoring information on populations of devices to other websites as widgets.

### 3.4 ANALYTICS

3.4.1 Methods and algorithms for quickly searching, refining and sorting sets of devices based on device attributes.

3.4.2 Methods for correlating attributes across large populations of devices and then deriving insights based on the correlations.

### Retrofit Solar-powered Outdoor Lighting System:

Solar-powered retrofit utility systems, including outdoor lighting system, security systems, and/or other electrical-load systems, may be provided according to certain embodiments of the invention. The retrofit systems may be attached to an existing pole, for example a conventional street light pole, conventional public safety alarm pole, or conventional security camera pole, to convert the existing pole to a solar-powered system. Alternatively, while the following description focuses on retrofit of existing poles that may already be erected and may already be in conventional service, said “retrofit” systems may also be attached to new poles that are not erected or in service, for example, if the community/industry desires the modular approach of attaching embodiments of the autonomous and/or wireless retrofit utility system to poles that they already own, have stockpiled, or want to purchase, because such conventional poles are “known commodities.” The main objective is to make such existing and/or new poles autonomous in that it/they can be powered at least part-time by a renewable energy system such as a solar collector. Especially in non-grid-tied systems, an energy storage unit (ESU) preferably provides enough stored energy to keep the system running, for example, for at least 5 days of low-to-limited solar radiation (for example during a week-long-spell of cloudy weather).

In certain embodiments, the solar-retrofit poles will be self-powered during the day to power the electrical device if needed during the day, and, in existing poles already tied to the grid, to also provide solar power to the grid during peak load periods. Then, at night, when the demands on the grid are less, such retrofit poles may be powered by grid, including power to the light/load and/or to the ESUs, for example. Thus, ESUs are typically not needed for retrofit systems for grid-tied poles, but energy storage devices may be included for emergency back-up during power outages. Such emergency back-up energy storage devices would not require as much energy storage as an autonomous system that is not-grid-tied, as one would expect such a storage device to be required to power the pole for at most a few hours during grid repair. In addition to saving grid energy compared to conventional poles, the retrofit systems provide an important public safety benefit. During periods of a grid-power outage, a retrofit light, public alarm, and/or security camera, for example, will still be able to operate to provide a safer environment.

The solar-retrofit system may be adapted so that the retrofit system is somewhat visually integrated with the existing pole/system to minimize the “modified appearance” of the retrofitted system, for example, by a semi-circular or circular collar on part of the pole. This may help accomplish two things, specifically, public acceptance and vandalism-resistance.

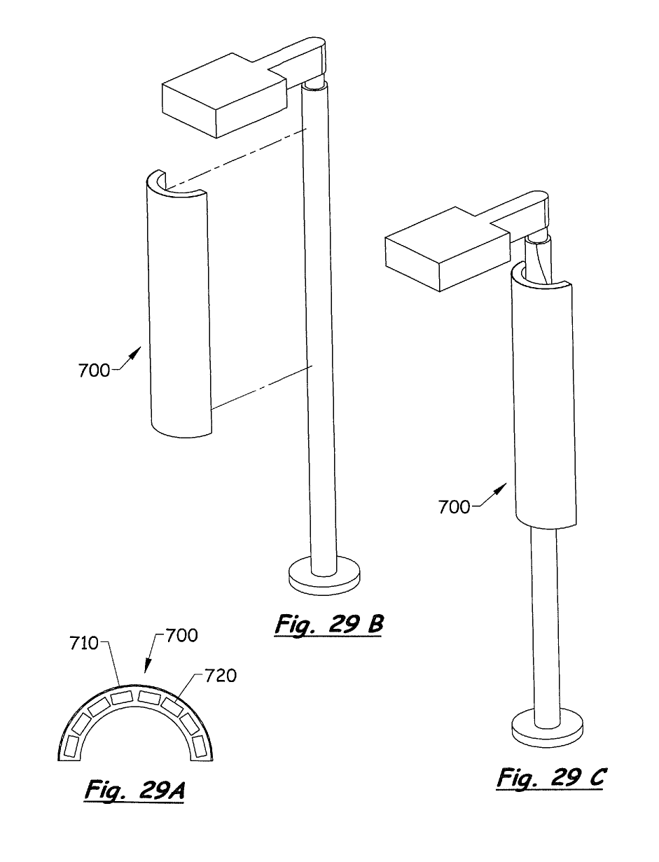

The retrofit system comprises the integration of a solar collector and other necessary system components, and preferably emergency ESUs, into a retrofit “package” so that it can be retrofitted & installed as an independent self-supported system onto an existing or new pole. As illustrated in FIGS. 29 A-C, in certain retrofit embodiments, a solar collector is attached to the outside surface of a collar 700. The collector can be a flexible photovoltaic layer 710 that is attached, grown, or woven onto the surface of the collar. In certain embodiments, the collar subtends an arc of at least 180 degrees. In certain embodiments, energy storage devices (ESUs) 720 are embedded in the collar, which energy storage devices 720 may be sized and designed for emergency use as described above. Such devices may be batteries, capacitors, fuel cells, or devices that store and release hydrogen. The collar is then mounted or otherwise attached onto an existing utility or light pole, with wiring extending from the solar collar to the light fixture. In this manner, installing the collar would also install an autonomous power system for the light pole, and/or at least (depending on the size and capability of said energy storage devices) an energy storage device for emergency grid outages, as described above.

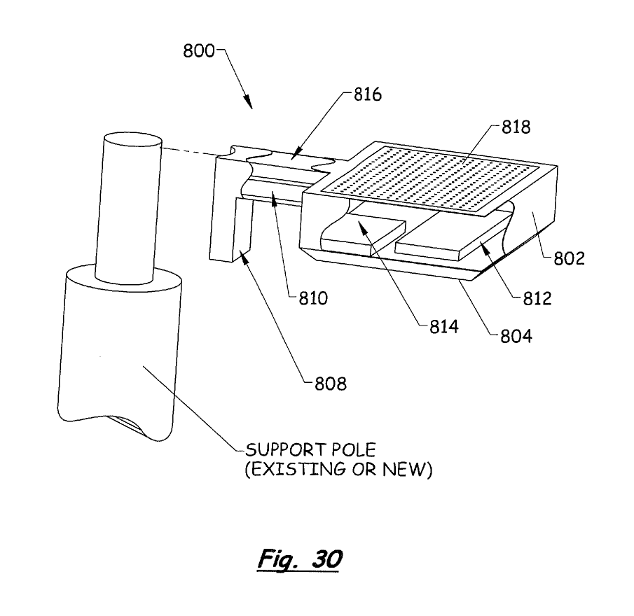

Another embodiment of a retrofit solar-powered outdoor lighting system is to include the solar collector and the energy storage device, preferably with control hardware/firmware/software, in the body of, or integrally connected to the light fixture, such as the integral unit 800 portrayed in FIG. 30 (described below in more detail). In certain embodiments, a lightweight PV layer/panel would be on the top of the replacement light fixture. The light fixture itself would contain a lightweight energy storage device, which in its preferred embodiment, is a high energy density ultra or super capacitor. In this manner, replacing the light fixture would also install an autonomous power system for the light pole and/or at least (depending on the size and capability of said energy storage devices) an energy storage device for emergency grid outages.

There are different ways these embodiments may be used. For example, a retrofit solar-powered pole may power systems other than lighting, such as stand-alone radio and antenna equipment at remote sites, or any other application that requires a self-powered source for support of the equipment. The retrofit solar-powered pole may comprise additional or alternative features to achieve various objectives. For example, a control system of a retrofit solar-powered pole may comprise motion sensors, photocells, time-clocks, or any other type of control to turn the light (or other powered equipment) on and off or to provide any other control required for the specific application.

In certain methods and apparatus of retrofit solar-powered poles, the solar panels and/or batteries are integral parts of a collar/unit that is applied to the existing pole, so that the solar panels and batteries are not installed separately. The benefits are ease of installation, better reliability (separate components are more subject to damage or improper installation), and overall lower cost compared to the conventional installation of separate solar panel and battery components on an existing pole. Multiple retrofit options are possible, with the two preferred options being a) a solar-panel collar/unit (optionally with ESUs) applied to the generally cylindrical side surface of an existing pole (separate from the light or other powered equipment), or b) a combined solar-panel and light/load unit (optionally with ESUs) connected to the existing pole in locations where a conventional light/load might be connected. These two options are discussed in more detail as follows.

As schematically portrayed in FIG. 29A, a collar may comprise the preferred flexible solar panel on a flexible or semi-rigid frame that is adapted to be snapped/installed around a pole. Said collar may optionally comprise pockets/receiving spaces for batteries or other ESUs. The preferably-flexible solar panel or solar “fabric” may be installed on or incorporated into a variety of flexible or rigid panel, layered composites, or other solar-panel structure with optional regions or pockets for receiving battery/ESU apparatus, wherein said solar-panel structure is mounted onto, flexed or bent around, or otherwise attached to an existing pole. Thus, said collar that incorporates an outer layer of a solar collector material and optionally an inner layer of batteries/ESUs may be used as the retrofit solar collection (and optionally, an energy storage system) that generally mimics or takes the outer generally cylindrical form of the existing pole, to power outdoor light(s) or other powered equipment (other load(s)) that is/are already connected to, or that is retrofit to, the pole. Said outdoor light/load(s) typically are separate piece(s) that are installed separate from the collar, for example, a conventional light or other light fixture, or other electrically-powered load at or near the top of the pole. Thus, said fabric, flexible or rigid panel, layered composite, or other layered material combines a solar collector and energy storage device into a single integrated unit, which is installed separate from but is operatively connected to the light or other powered equipment.

As schematically portrayed in FIG. 30, an integrated unit 800 comprising preferably all of the solar panel, batteries, and LED light engine, may be attached to the existing pole preferably at or near the top of the pole. This integrated unit therefore, is positioned where one would expect a conventional outdoor light to be placed on the pole, with no need for a solar-collector and/or battery collar on the generally cylindrical side surface of the pole. The integral unit 800 in FIG. 30 represents one embodiment of retrofit solar-powered outdoor lighting system that comprises preferably all of: fixture box 802, such as a “shoebox” or “cobrahead” or other standard or custom fixture housing or body, wherein the fixture box may have a thin film photovoltaic (PV) layer 818 attached to it to convert light into electrical power, which PV layer is preferably on a generally horizontal top surface of box 802 and which may replace the solar collector mounted on the pole or may augment that PV collector; lens 804 preferably connected to the box 802 and/or to the LED light engine 812; fixture arm and/or bracket 806 to mount fixture to pole; energy storage pack 808, which may comprise a lightweight energy storage pack; such as the preferred high energy density ultra or super capacitor, batteries, or other energy storage apparatus; energy storage pack charger 810; LED light engine 812, which may be of various designs, but is preferably the modular LED system described elsewhere in this document; motion sensor and photocell 814; control board w/wireless modem and/or cell phone radio 816. While such integral units are possible, it will be understood by those in skill in the art reading and viewing this document and its figures, that peak load delay conservation systems according to embodiments of the invention could also be installed on existing or new light/equipment poles with the elements called-out for FIG. 30 being provided in separated housings and/or in spaced-apart locations on or in the pole.

### Modular LED Light Engine:

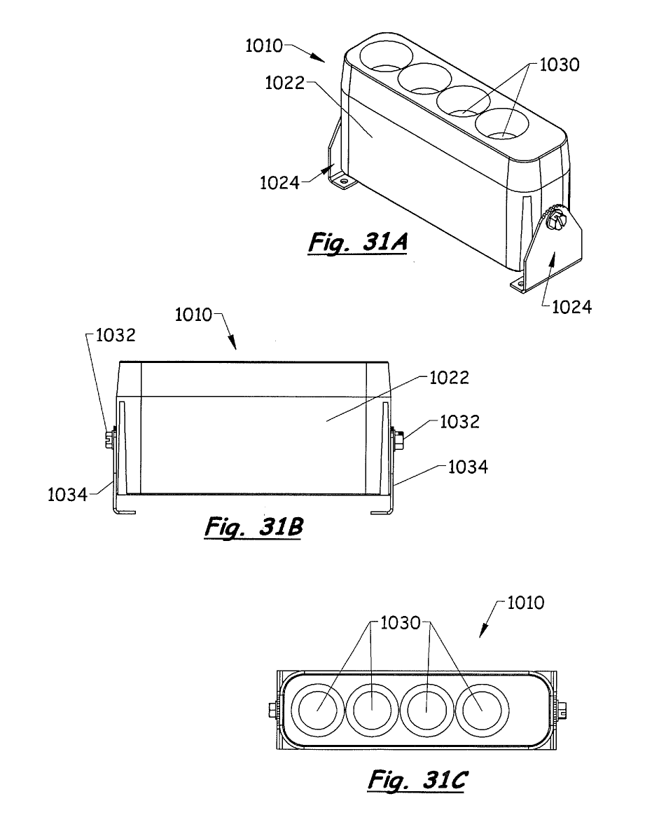

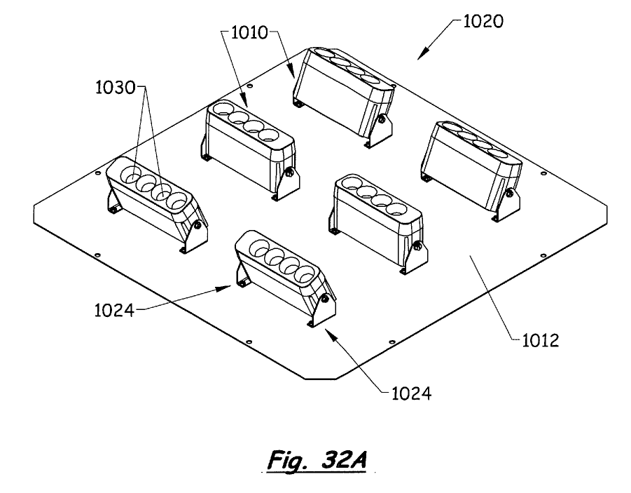

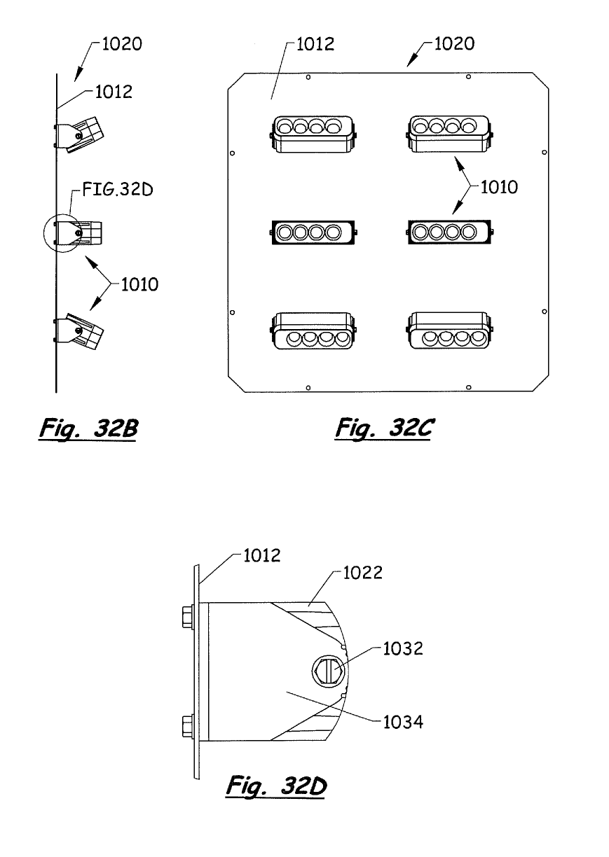

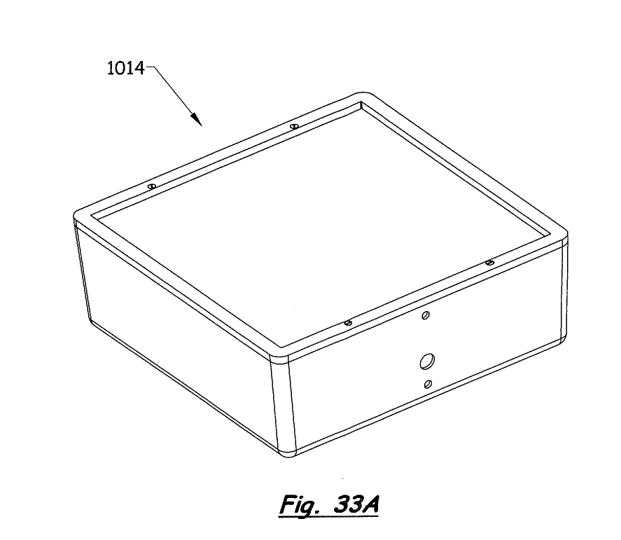

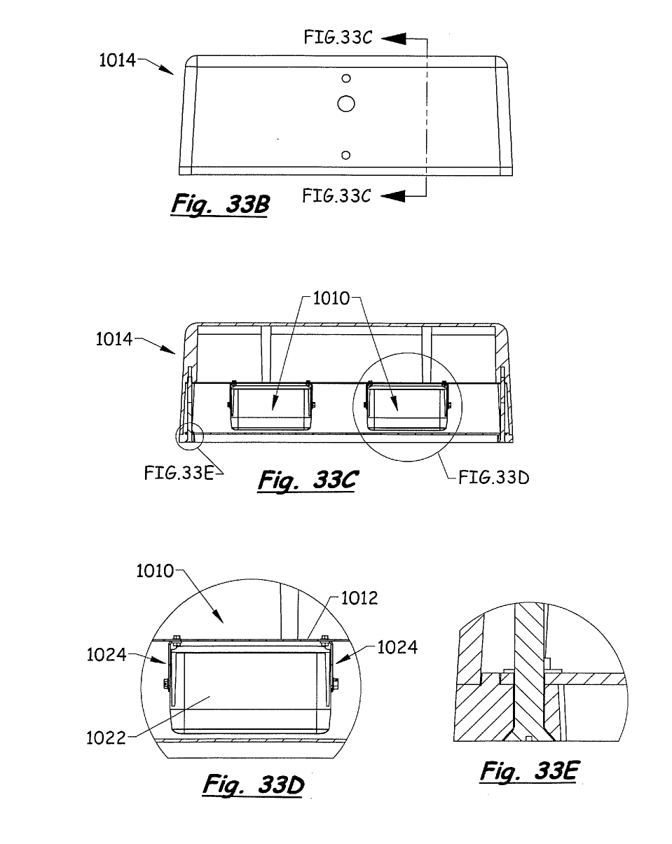

A modular LED system may be adapted to be part of either new (OEM) or existing (retrofit) outdoor lighting fixtures. Such a modular LED system may allow multiple lighting distribution patterns to be emulated, including some lighting distribution patterns that can not typically be achieved by conventional light fixtures. As illustrated by the preferred embodiments in FIGS. 31 (A-C), separate modules 1010, may be provided with each module preferably containing multiple light emitting diodes 1030 (LEDs). Multiple of said modules 1010 are mounted to a sheet metal plate or baffle 1012, as illustrated in FIGS. 32A-D, to create a light fixture comprising a modular LED light engine 1020. The baffle is then attached to the interior of a light fixture 1014, as illustrated in FIGS. 33A-E. As discussed elsewhere in this document, many different light fixtures may be used, as it is the light engine 1020, and it is the particular the number, arrangement, and directing of modules 1010 that is the major determining factor of the light intensity and light pattern.

The structure and operation of each module 1010 is preferably the same as the others in said light engine 1020, with said multiple modules being arranged on the baffle 1012 and each modules being directed (pointed) in a direction, so that the sum total of the specially-arranged and specially-directed modules is the desired light distribution pattern (or simply “light pattern”). The appropriate modules required to achieve the desired lighting distribution pattern are mounted to the baffle and aimed in the direction needed for the specific pattern. Thus, several modules can be combined in different configurations as required, with the “adaptation” or “adjustment” to obtain the desired light pattern preferably consisting of: mounting the modules on the baffle in a particular design arrangement and pivoting the LED housing 1022 of each module relative to its bracket 1024 to direct each module (independently from all the others) as desired.

Each module 1010 preferably has multiple LEDs, for example, four LEDs 1030, in a single row along the length of the module housing 1022. All four LEDs 1030 preferably “pointed” in the same direction inside the LED housing 1022, with “directing” of the module, and, hence, of the light, being done by said pivoting and then locking of the module in the desired orientation relative to the plane of the baffle, and, hence, relative to the surrounding landscape, roads, and/or buildings, etc. The LED housing 1022 may be locked in place by a bolt/screw system 1032 or other lock/latch, preferably at the time of manufacture of the light fixture with light engine (if the desired light pattern is known), at the time of installation of the light engine 1020 in an existing fixture, and/or at the time of installation of the light fixture on the pole, for example. Each bracket 1024 may comprise one or more members that may pivotally receives the LED housing 1022 so that the LEDs may be swung in a direction preferably perpendicular to the length of the LED row for said directing of the LED module. For example, two or more ears 1034 may be fixed to the baffle 1012, and receive the housing 1022 so that is pivots on an axis parallel to the length of the LED row. The ears 1034 may be considered part of the module, and/or may be considered part of the baffle 1012, depending on one's perspective.

In the preferred LED module, the LEDs 1030 are mounted to, or less preferably connected to, a circuit board along with required drivers and circuiting for the LEDs. Said circuit board, drivers, and circuits for the LEDs are not shown in FIGS. 25-27, but may be contained within each module housing 1022. Also contained with the module housing may be heat sink material to draw heat away from the LEDs as required, as will be understood after reading this document and after viewing FIG. 7, which portrays a generally cylindrical light engine as opposed to the generally planar light engine of FIGS. 31-33. It will also be understood that multiple modules 1010 may be arranged on variously-sized and shaped plates, baffles, cylinders, cones, boxes, or other support structures, wherein the light pattern and the outward appearance and aesthetics of the light fixture with light engine will be determined by said support structure, said arrangement of the modules on the support structure, and said directing of each module. In addition, or as a partial or total replacement for said directing of the modules, a lens assembly with reflectors may help achieve the specific distribution (pattern) required.

There are five basic distribution patterns identified for outdoor lighting. These are type I, II, III, IV and IV. Not only will the preferred modular LED system, described above with reference to FIGS. 31-33E, allow these distribution patterns to be met, but additional and project specific (site specific) distribution patterns can also be achieved. The modular system also allows virtually any distribution pattern to be achieved by adjusting the angle and pitch of the modules to achieve the desired lighting. This can be done either by the engineer designing the lighting system, at the factory, or in the field. No shielding is required because the modules can be “aimed” away from the area of light trespass. Not only does the invented modular LED system allow each fixture to be “customized”, the overall lighting system (network of poles) can be designed to work together in a unique or custom way to achieve an overall lighting system for that specific site or area.

Other unique qualities and features, not necessarily represented by the modular LED embodiments of FIGS. 31-33E, but preferred in alternative embodiments of the invented modular LED systems include:

1. multiple or different lenses on a standard lens cover/housing;
2. individual dimming of modules;
3. wireless control option so that changes to lighting can be done after the fixture has been installed on the pole;
4. pan/tilt option for each module via the control wire (or wirelessly) with micro controllers or small motors to physically change the direction or “aim” of the modules;
5. pan/tilt solid State option by having multiple LEDs in a wide range of distribution angles and only illuminating those LEDs pointing in the direction of the desired distribution pattern (and leaving the other un-needed LEDs dark);
6. solid state redundancy option wherein “unlit” LEDs could alternatively be utilized to turn “on” when an adjacent LED burned out;
7. color changing; and
8. software design option, using modular LED software program to design the lighting system to his/her specifications so that each individual fixture can be configured as required.

### Active Control for Energy-Efficient Lighting:

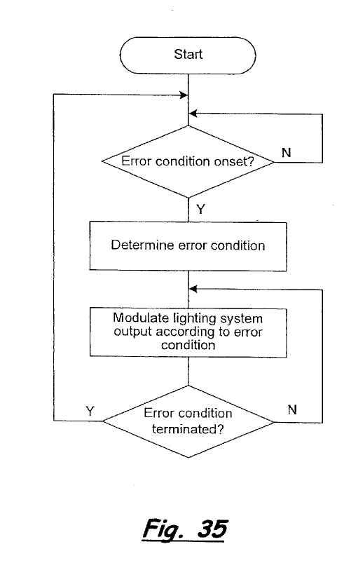

Certain embodiments may be considered utility systems for providing one or more electric-powered devices/services, using a solar-powered component. Active control of the utility system may provide effective energy-efficient operation even through extended periods of low-sunshine days. This is especially important in systems that are not connected to the grid, but may be also important in systems that are both solar-powered and grid-connected for overall energy conservation. FIGS. 34 and 35 illustrate basic logic flow diagrams for certain embodiments of an active lighting control process, and error/alert indication processes. The preferred active control determines or predicts available energy and determines or predicts load demand (lighting or other load), and then controls the load by modifying energy to the load and/or other control settings. Such active control may take the form of a “detect-trigger-action” mode, wherein various sensing or self-diagnosis apparatus/methods may be the “detect” step, which trigger the control board/system (broadly called “controller” herein) to take an action based on firmware, software, set-points or other inputs, historical data, algorithms, etc. provided in/for the controller. For example, for lighting, the lighting output and/or lighting timing may be adjusted, with said active control monitoring the system for error(s)/alert(s) that require modifications to, or shedding of, the lighting or other peripherals to prevent damage or failure of the system. For example, by adapting the amount and timing of light output, the system may increase lighting on an as-needed basis while reducing energy consumption at other times. In addition, the technology may indicate lighting system error/alert conditions over the primary illumination device of the lighting system. The technology may be also embodied as methods, apparatus, manufactures, and/or the like.

The general process shown in FIG. 34, and specific embodiments developed therefrom for active control, may be performed by a micro-controller, a micro-processor, a programmable logic controller, a digital signal processor, other processor, and/or the like, for example. For the lighting example, starting at the start block, a processor determines the current and/or predicted energy availability and/or demand for lighting. For example, this determination may be based on a charge, current, or voltage level of a battery circuit, historical data regarding energy collection (e.g., energy generated during the previous day or week), energy cost data, predicted generation capability (e.g., based on a weather report received over a network connection, inferred from past energy generation, or provided by a operator), historical data regarding motion detection, and/or the like. For example, a lighting system may be configured to provide more light when sufficient energy is currently available while reducing the light output when less energy is currently available and/or when future energy generation is predicted to be limited.

The lighting system then adapts and/or selects a light output profile according to the determined current and/or predicted energy availability and demand for lighting. As described later in this disclosure, a lighting profile may include configuration of a light output level, a duration during which a configured light output level is provided, whether the lighting system is enabled (e.g., enabled during the night, disabled during the day), and/or the like. The lighting system then provides light according to the adapted and/or selected light output profile.

The general process shown in FIG. 35, and specific embodiments developed therefrom for indication of a lighting system error/alert condition, may be performed by a micro-controller, a micro-processor, a programmable logic controller, a digital signal processor, other processor, and/or the like. The process begins at a decision block where a processor monitors for an onset of an error/alert condition. For example, an error/alert condition may include detection of partial failures, degraded performance, reaching a point of a maintenance interval, and/or the like. If the processor detects no error/alert condition, the process remains at the decision block. If the processor detects an onset of an error/alert condition, processing flows to the next step wherein the processor determines the error/alert condition. After determining the error/alert condition, processing flows to the next step(s) of the processor modulating the lighting system output according to the determined error/alert condition. As one example, the processor may blink and/or strobe an error/alert code via the primary illumination device of the lighting system to indicate the determined error/alert condition. In an environment where the lighting system is employed as a street light or other lighting pole, a passing pedestrian and/or motorist may notice the error/alert code and notify the relevant lighting system operator. The operator may then dispatch maintenance and/or repair persons to correct the error/alert condition. In addition, by employing the primary illumination device of the lighting system to indicate the determined error/alert condition, error/alert conditions signaling capability may be provided without additional components and only minimal increase in system complexity. From the modulating step, the process flows to next decision block, wherein the processor monitors for the termination of the error/alert condition. For example, this may include detecting if the lighting system has been repaired, has functioned normally for a predefined time period, a register has been cleared, and/or the like. If the processor detects termination of the error/alert condition, the process flows back to the beginning, otherwise, processing continues to further modification of the lighting system.

Aspects of the invention may be stored or distributed on processor-readable media, including magnetically or optically readable computer discs, hard-wired or preprogrammed chips, nanotechnology memory, biological memory, or other data storage media. Indeed, processor implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, mesh, or other scheme).

Schematic FIGS. 34 and 35 are not intended to be exhaustive or to limit the invention to the precise form disclosed above. While specific embodiments of, and examples for, the invention are described herein for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The overall and main objectives of the active control for energy-efficient lighting are to conserve energy in solar-powered utility systems, so that they can be implemented in regions and climates in which conventional wisdom would predict ineffectiveness, spotty performance, and/or failure because of frequently cloudy or inclement days. Said active control actively manages battery/ESU charging, manages the available energy, and controls the power or energy delivered to the load. As a result, even in said cloudy or inclement regions/climates, the light or other utility system delivers effective lighting or other services according to the needs/preferences of the community or business, while protecting the battery/ESU from becoming damaged and short-lived because of draining below its low end threshold.

Actively-controlled embodiments vary greatly from conventional solar-powered street light systems that, instead of actively controlling the load, are actually passively controlled by the load. When the load draws more energy than is available in the battery of the conventional lighting system, the load then “turns itself out” because the battery does not have enough energy left to support the load.

Certain embodiments of active control for energy-efficient lighting and/or other utilities/services include some or all of the following features. The preferred system actively monitors all critical system components to assure maximum performance while conserving energy, with decisions on energy management made based on system programming along with sensor input. The preferred system in many embodiments may be remotely controlled via wireless system by a remote station such as a utility as required for energy delivery to the grid during peak loading situations. Both energy storage and solar production may be controlled. Logs and records data are kept for use by the system to determine future actions, for example, for predicting future energy availability and demand for lighting. The system may have multiple energy operational modes based on current and predicted future conditions, wherein the preferred modes are described in detail later in this disclosure. The system delivers power to system devices preferably according to one of these energy savings modes as required to conserve energy for future demand when current energy production is low. The energy management system can support lighting systems and other loads (devices requiring energy), and the device-specific control criteria of each load determine the energy delivery to that specific device. The preferred system's “load shedding” features may control priorities relating to which devices need to be supported when energy stores are low.

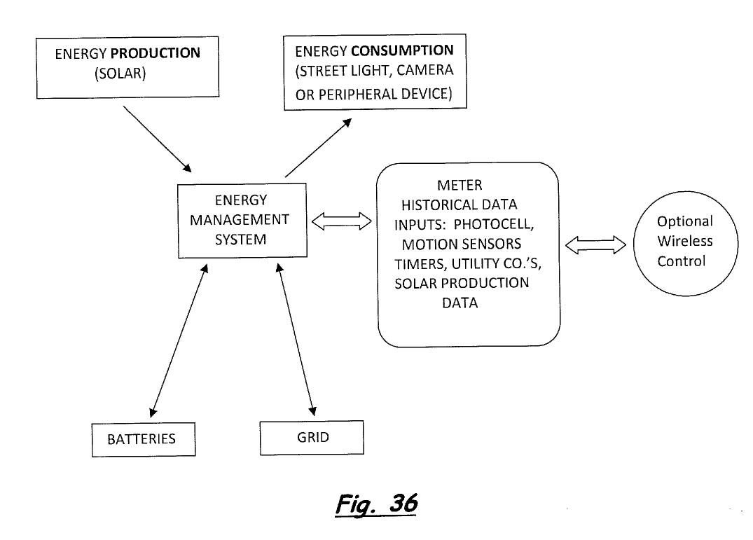

FIG. 36 summarizes the operation of certain embodiments of the control system. Energy produced (solar) is delivered to the batteries for storage or directly to the grid. The energy management system then determines how the energy is delivered to the loads or the grid. This may be done according to the control system algorithms and historical data, along with sensor input, for example. The system may also be controlled by the utility company as required. Solar and/or stored energy in the batteries may be delivered to the grid during peak demand in the middle of the day.

The preferred active control systems may comprise, or be implemented with, other energy-efficient and/or “smart” systems discussed earlier in this document, for example, wireless intelligent outdoor lighting systems (WIOLS), peak load delay energy conservation systems, and autonomous connected devices. For example, the preferred active control system may comprise and/or be implemented with multiple of the following features:

a) energy conservation by dimming lights, and/or load shedding;
b) energy conservation by operating at lower power levels when demand is low, for example, utilizing low power low-bandwidth wireless most of the time, then switching to the high bandwidth only when required;
c) cooperating with the grid, by supplying the grid in peak load hours, and being recharged in non-peak hours;
d) for an array of light poles, using a master-slave system, wherein preferably none of the slaves communicate with the control station but poles may change their roles in the array network based on strength of signal, and/or error/alert signals, for example, wherein network communication/control is switched to other routes through the array if one or mores poles is/are “down” or sending weak signals;
e) adding additional poles by “self-discovery”;
f) a quarantine system for self-discovery addition of poles to the network;
g) Wi-Fi hot-spots provided by the poles/network; and/or
h) a “Look-ahead” traffic light system or other coordinated activities.

Embodiments of active control that are particularly important for energy conservation and/or public safety are systems that may be called the “Light-the-Way,” “Point-the-Camera,” “Coordinated On/Off” and/or other coordinated activities, which may be applied in various networks, including master-slave networks and peer-to-peer networks. Light-the-Way, Point-the-Camera, and Coordinated On/Off systems involve sensors on one or more poles in a population/array of poles from which the control system receives input signals that are used for subsequent lighting modification and/or security action.

In a light-the-way system, two or more motion sensors, within a population of poles, are triggered by motion of a person or vehicle and cause the population to calculate an approximate direction and speed and light the way ahead of the person/vehicle. Each successive motion sensor trigger provides an opportunity to adjust the direction and speed to keep lighting the way for said person/vehicle. The light-the-way algorithm preferably resides on every pole in the population.

In a point-the-camera system, preferably one pole within a population of poles includes a pan-tilt camera. As a person or vehicle passes by two or more lights in the population, a vector is calculated and used to point the camera at the person/vehicle and follow as long as the person/vehicle is within the scope of the poles and range of the camera.

In a coordinated on/off system, the light threshold for photo cells or other light sensors across a population of poles varies based on manufacturing tolerances, plus individual poles experience different amounts of light based on location and shadowing. Photo cells/sensors across a population of poles can be used to coordinate a single “light on” and “light off” time for the entire population. An average, or a minimum or maximum, for both the on-time and the off-time can be calculated each 24-hour period and used to implement coordinated on/off times for the population.

These and other methods of best-leveraging solar energy generated during daylight hours and stored energy during nighttime hours may be managed via certain embodiments of an active control system. For what may be called generation optimization, the preferred active control system must determine what to do with energy being generated by the solar skin as a function of the customer, the time of day, the time of year, and the state of energy demands from a single-pole-, multiple-pole- (if a population of poles is in use), and utility-wide- (if tied to the grid) point of view, the security scenario (for example, pedestrians and/or vehicles in need of lighting), and the state of the battery pack. The preferred active control system performs this optimization to prioritize energy delivery to lighting, peripherals, the battery/ESU pack, and/or to the grid in grid-tied embodiments. The management algorithms may include modification of energy delivery to the lighting and/or to peripherals in order to protect the battery/ESU pack and to ultimately protect the entire lighting system. In embodiments without any tie to the grid, this active control is crucial to maintaining operability of the system and preventing damage to the batteries, over long cloudy or winter days. In grid-connected embodiments, this active control is crucial to managing the synergistic relationship between the pole/array, wherein the grid may rely on the pole/array for energy inverted directly onto the grid in real time when demand matches generation (e.g., afternoon air conditioning peak matches afternoon generation peak), or for battery-stored energy at other times, but wherein the pole/array may rely on the grid for energy input during the darkest months of the winter.

The energy management algorithms, such as N1, E1, E2, etc. modes described later in this document, as a function of battery voltage may be relatively simple for a single load (for example, LED lighting). However, for each added load, the algorithms become more complex. With a transport layer load (wireless radios) plus myriad other peripherals (video, security gate, emergency call box, etc.), the energy management algorithms' scope includes the management of a prioritized list of “loads” that can be toggled on/off or reduced in functionality/consumption as a function of battery voltage, and, in grid-connected embodiments, may also include algorithms for drawing energy from the grid through the battery charger to refill.

At night there is no solar energy generation, but, for poles tied to the grid, cheap nighttime energy from the grid can be used to top-off the battery pack. This “topping off” of the battery pack is especially effective in cases where expensive daytime energy demands have depleted the battery to threshold levels. Also en mass, a utility company may elect to push cheap energy out to these highly distributed storage devices at night, leveraging the battery charger to fill the battery packs, so that immediate local energy can be delivered later to meet peak demands.

### Example I

### Apparatus and Methods of Active Control for Energy-Efficient Lighting and/or Other Services

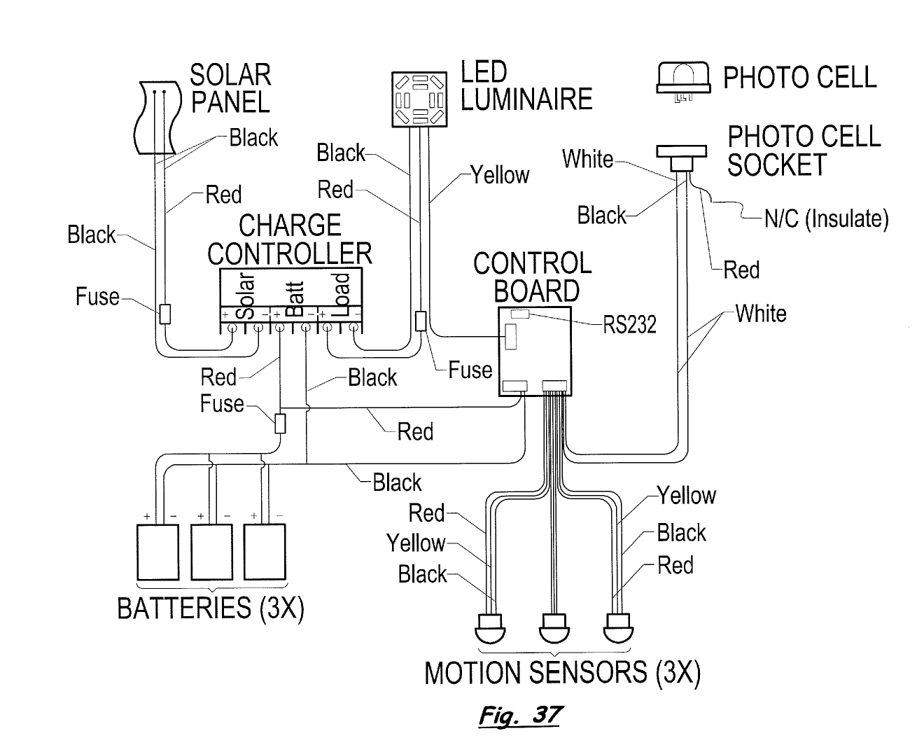

The apparatus of this Example comprises an LED-based luminaire, a photocell, a control board, a charge controller, a solar collector (PV solar panel) a battery subsystem (composed of 6-8 batteries, a battery enclosure and wiring harnesses), three motion sensors, and the pole assembly. See FIG. 37 and the other Figures of this document for examples of elements that may be used in the methods of this Example.

The solar collector captures light during daytime hours and passes it onto the charge controller. The charge controller manages the power provided from the solar collector to optimize the power to be stored in the batteries. The batteries hold stored electrical energy and release it to power the LED luminaire and other system electronics. Various modes of energy release are determined and managed by the control board. The control board uses input from the photocell to determine when to turn the luminaire on (and off at dawn), and uses energy-saving algorithms to manage energy to the luminaire. These algorithms take into account the charged state of the battery subsystem, the photocell output, the state of the motions sensors, and the anticipated time before dawn.

Certain variables that determine the degree of power management can be user-selected. The preferred algorithm sets, named E1, E2, and E3 modes, etc., are detailed later in this document; it will be understood by those of skill in the art, after reading this document, that these algorithms/methods are described for a system that is based on 12 volts, but that these algorithms/methods could be scaled to systems based on other voltages, for example, 24 or 36 volts.

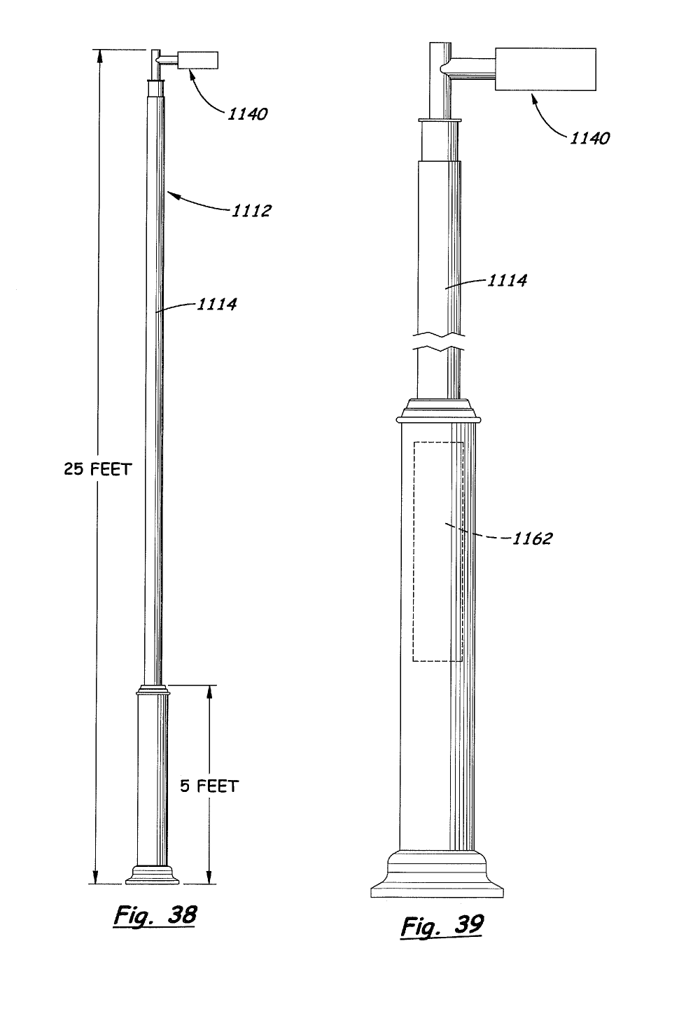

The light pole assembly is the structural element of the overall system, and contains compartments and channels for the various subsystems and wiring. The preferred light pole assembly is portrayed in FIGS. 38 and 39, shown with a box-style lighting fixture. The pole 1112 provides the structural support for the luminaire 1140, and the channel for all the wiring inside that connects the other subsystems. It also provides the outer surface and structural support for the solar collector 1114. Compartments or holes in the pole are provided for various subsystems depending on whether they need to communicate to the outside world or whether they can be wholly contained inside the pole. Those subsystems include the batteries/battery enclosures, control board, battery charge controller, solar collector wiring, motion sensors, and RS-232 ports. Specifically, the preferred pole 1112 is of single piece construction, and is made from ASTM steel (10 gauge IPS tube) and is black powder coated to provide protection to the pole from the elements. A battery compartment 1162 is contained in the lower 10″ diameter portion (enlarged diameter relative to the rest of the pole) of the pole with a secured door to allow access for installation and maintenance of the battery subsystem. Openings are provided at the bottom and top of the pole assembly to allow natural convective air to enter the interior of the pole to cool the batteries. The solar collector is wrapped around the smaller-diameter portion of the pole, from above the larger-diameter pole bottom end nearly to the top end of the pole. Thus, the solar collector preferably extends about 20 feet along the pole. Openings in the pole allow for electrical connection between the solar collector and the charge controller. Three openings above the top of the battery chamber allow for the mounting and electrical connection of the motion sensors. The control board is mounted at the top of the battery chamber. The luminaire is supported by an arm that is mounted at the top of the pole. All electrical wiring required for the luminaire and associated electronics are channeled through the interior of the pole.

The preferred solar collector is a thin-film photovoltaic panel/device that converts sunlight into electrical energy. The solar collector operates from about 15 volts on the low end (with lower current flow at this lower voltage) up to 15% over the rated 33 volts and 136 watts. The initial operation will be 15% over the ratings, but will stabilize to the nominal collector specifications within a few months (due to the Staebler-Wronski effect). This stabilization is well-characterized and understood in the thin film photovoltaic industry. The center line of the solar collector faces approximately in the direction of the sun at its highest point in the sky and wraps about 225 degrees around the pole to collect light in the morning and evening hours. The preferred thin-film solar collector is highly shade-tolerant, both as far as individual cells within the collector and the collector as a whole. Generally, a solar collector is comprised of multiple solar cells. If solar cells are connected in series, a shaded cell within the collector can begin to consume current (as opposed to create current). This not only degrades the overall performance of the collector, but can create hot spots in the collector that can be damaging to the collector. The solar collectors used by the present Inventors and Applicant Inovus Solar, Inc., however, have bypass diodes that prevent shaded portions of the collector from consuming current. This preserves the performance of the collector and prevents the build up of hot spots. Regarding the collector as a whole, the thin film material that forms the active photovoltaic component in the Inventors' and Applicant's collector is more effective at converting sunlight on cloudy days. Daylight is composed of direct sunlight and diffuse or scattered sunlight. During cloudy days, almost all the light that reaches the collector is diffuse sunlight. Inventors'/Applicant's thin film collector converts this diffuse sunlight into usable energy nearly 20% better than crystalline or polycrystalline Si collectors.

The solar collector is conformably attached to the surface of the pole by means of rivets and a strong heat tolerant adhesive (an ethylene propylene copolymer adhesive-sealant with microbial inhibitor). In the preferred generally-cylindrical pole, therefore, the solar collector fits snugly against the pole, itself taking the generally-cylindrical shape of the pole. Because the collector is conformably attached, it does not incur any additional wind loading onto the system. This is a decided advantage compared to flat panels that incur a high wind load (or snow load) and thus may not be suitable for many sites. It is virtually impossible for natural events to dislodge the collector, and it is highly resistant to vandalism.

The covering for the solar collector is a durable ETFE (e.g. Tefzel®) high light-transmissive polymer. This polymer coating not only provides a durable physical shield for the collector's solar cells, but also a durable chemical shield, protecting them from water, salt spray, etc.; it can be easily wash with water and detergents.

Measured power generation on Inventors'/Applicant's poles according to embodiments of the invention has been measured at least 50 Watts at Boise, Id., U.S.A. during the month of November, with energy generated well in excess of 300 Watt-hours. The actual performance of the system depends on the location of the installation. Many factors influence this including shading from adjacent buildings or structures and weather patterns in the area installed. Inventors'/Applicant's preferred solar collector is currently the Unisolar PVL 136, specifications for which may be obtained from the company Unisolar and/or from appendices in the provisional U.S. application of which this application claims benefit and which are incorporated by reference into this document.

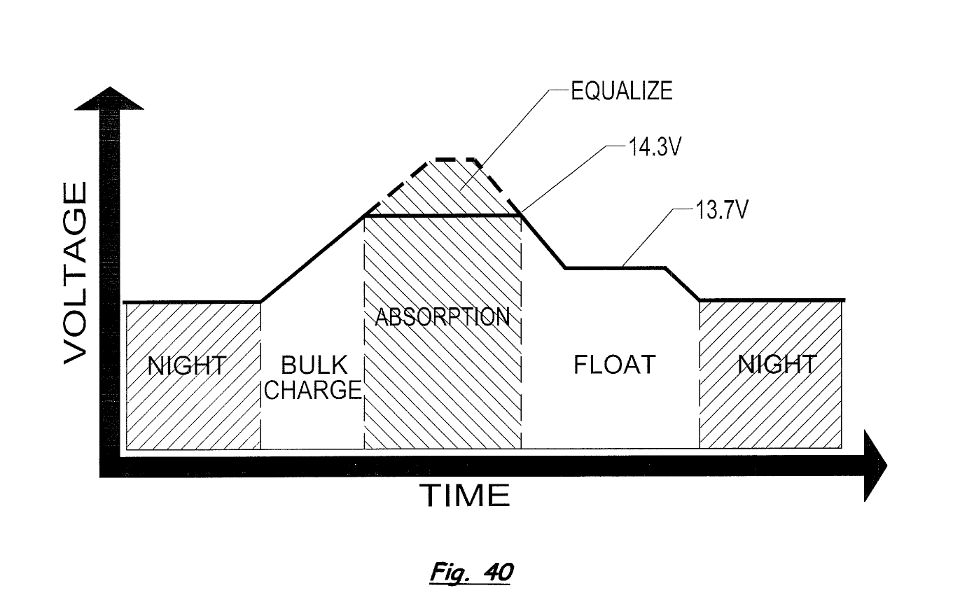

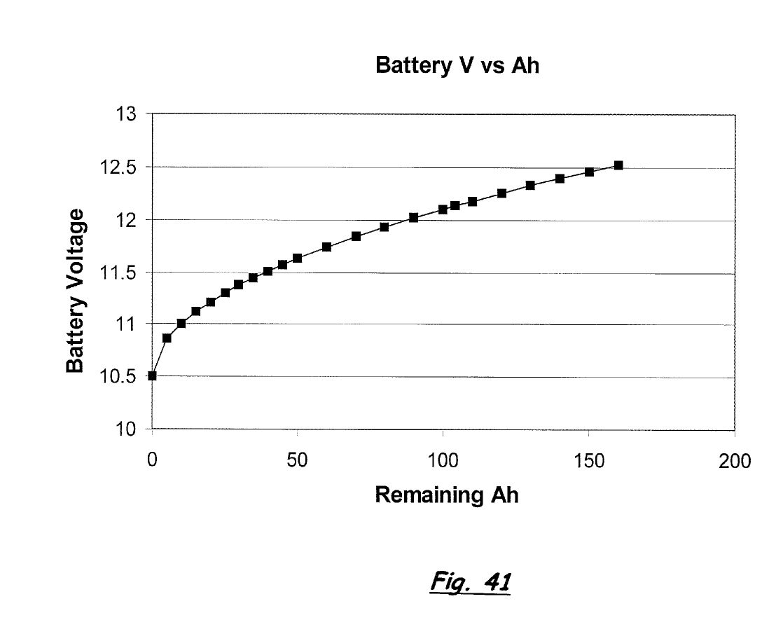

The battery charge controller is connected between the solar collector and the battery subsystem. The charge controller controls the current and voltage delivered to the batteries and optimizes the charging conditions to the battery to assure that the batteries are not overcharged, preferably according to the multi-step process portrayed in FIG. 40. In addition to the main steps shown in FIG. 40, the multi-step process features an auto-equalize step (to 14.5V) every 28 days or if low charge, that is preferably 3 hours of over-voltage charge to reduce plate sulfation. Also, the charge controller provides for low voltage disconnect (LVD) at 11.0V (and reconnect when 12 V is again reached), to prevent damage to the batteries from over-draining. Battery charge is monitored through voltage level, as shown in FIG. 41.

Inventors and Applicant use an advanced Maximum Power Point Tracking technology that converts the voltage from the solar panel that is above the battery voltage into usable energy that can be stored in the batteries. Older technologies, including PWM (pulse width modulation) charge controllers, are unable to do this. Because the batteries are a 12V system and the solar panel is a 30-33V system, significant energy can be converted from the solar panel for storage in the batteries. This enables the system to generate energy on sunny days (or even mostly-sunny days) typically well in excess of what is consumed at night. This excess is stored in the batteries.

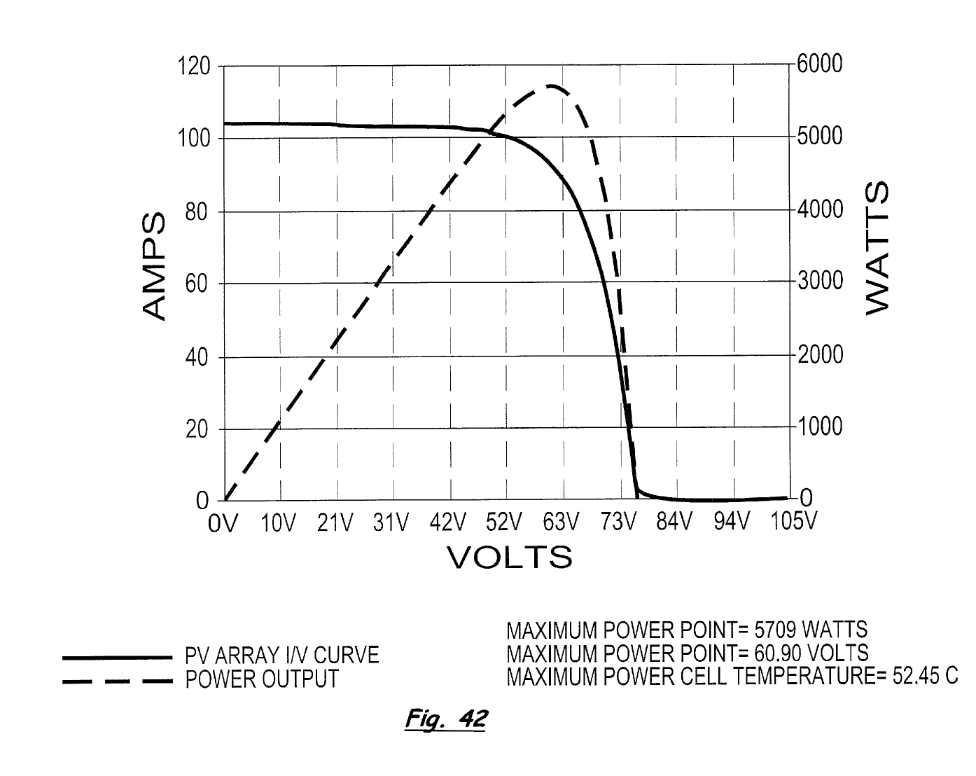

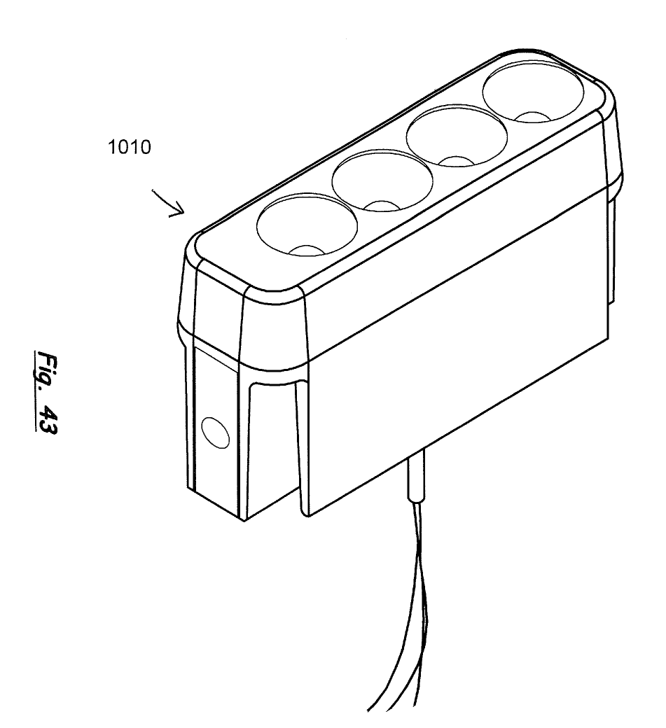

As portrayed in FIG. 42, the preferred Morningstar SunSaver MPPT-15 Maximum Power Point Tracking algorithms provide 90% more efficient operation (compared to conventional PWM charge controllers), transferring maximum power to batteries even though PV array and batteries operating at different voltages. Specifications for the Morningstar SunSaver system may be obtained from the company Morningstar and/or from appendices in the provisional U.S. application of which this application claims benefit and which are incorporated by reference into this document. MPPT controllers are apparatus and methods known to those of skill in the art, and will be understood by those of skill in the art after reading this disclosure; MPPT controllers are available from various manufacturers.

The charge controller is designed to tolerate harsh environments. The fully solid-state electronics are encapsulated in an epoxy potting to prevent moisture and harmful chemicals from degrading the electronics. The casing is a rugged die cast aluminum, and the terminals are marine rated. The operating temperature range is specified from −40 degrees C. to +60 degrees C.

Preferably, six batteries are connected in parallel in a 12-volt system. Each battery stores 26 Amp-hours for a total of 156 Amp-hours. See FIG. 41. The battery subsystem can accommodate up to 8 batteries in parallel. The battery dimensions of 6.56″×6.97″×4.92″ allows them to be placed in an insulated battery enclosure (2 in each enclosure) and fit within the pole base, preserving the aesthetics of the preferred pole.

The preferred batteries utilize Absorbent Glass Mat (AGM) technology that immobilizes the battery's electrolyte in a fiberglass mat. This leak-proof design means that the electrolyte will not spill is the casing is damaged. It is the reason these batteries are approved to be shipped by air by both the D.O.T. and the I.A.T.A. AGM batteries provide superior tolerance to heat and low humidity, as little-to-no water is lost under high heat and/or low humidity. This preserves battery life well beyond simple lead-acid or gel batteries under these conditions. AGM batteries also provide recombining of the oxygen with hydrogen to form water during charging. This not only prevents loss of gas and maintains the water for the electrolyte. In the case of too-rapid charging (something that is unlikely to happen with solar collector charging), there is a vent valve for excess gas to escape. To further combat high temperature conditions, the battery chamber in the pole is cooled by a process, described earlier in this document, that draws cool air up through the interior of the pole. The active control system is capable of monitoring each individual battery pack and isolating the rest of the system if one battery (or set of batteries) goes bad, for example, if a battery cannot hold a charge. This is accomplished by disconnecting (via relays or other switching means) the bad batteries from the good batteries in the system. If allowed to stay connected to the system, the bad batteries would otherwise bring down the voltage and performance of the entire system. Left unchecked, it could potentially cause the entire system to degenerate to the point of failure. By disconnecting the bad batteries, the rest of the battery storage system will continue to operate (albeit at a lower overall storage capacity) until the bad batteries are replaced.

The battery casing and lid are made of a non-conductive and high impact resin. The material is also resistant to chemicals and to flammability. The plates within the battery are optimized for surface area via porous electrode materials. This increases energy density and optimizes capacity. The battery enclosures are made of polypropylene, with an insulating layer between the battery casing and the battery enclosure walls. A wire harness connects all the batteries in parallel, and is made of marine grade wiring. The Inventors' and Applicant's current preferred and approved batteries are PowerSonic's Model 12260. Specifications for which may be obtained from the company PowerSonic and/or from appendices in the provisional U.S. application of which this application claims benefit and which are incorporated by reference into this document.

SLA-AGM type batteries (sealed lead acid, absorbant glass mat) have been preferred, but they have approximately a 4 year life and must be recycled (lead acid, being potentially toxic). A possible alternative is LiFE PO3 (Lithium Iron Phosphate) batteries that may have a 12-15 year life and be entirely environmentally inert (iron-based).

The preferred lighting fixture comprises a 12 volt LED lamp source. The preferred LED modules and mounting brackets for the modules are described earlier in this document, with examples portrayed in FIGS. 30-33E. Also, FIG. 43 provides a close-up view of the preferred LED module, detached from any mounting bracket. Preferably, there are 8 modules of LED's, with each module containing 4 LED's, for a total of 32 LED's. A 0-5V PWM line connects the control board to the drivers on the LED engine. The modulated pulses from the control board determine how the drivers output current to the LED's, thus affecting the LEDs' lumen output. Each LED has a nominal raw output of 100 lumens/Watt at a thermal pad temperature of 25 degrees C. (Philips data sheet). Slightly lower luminous output will be experienced as the pad temperature rises. Pad temperature under operation has been measured at 50 degrees C., so luminous raw output per LED may drop to 93% of nominal output (Philips data sheet).

The LEDs are mounted on a PCA (printed circuit assembly), and each LED has a small glass lens to create an initial desired illumination pattern. There is a high transmittance polycarbonate layer that fits closely over the LED's. This polycarbonate layer has additional lensing and reflective surfaces to generate the final desired illumination pattern from each LED. The assembly of the PCA with LED's, the polycarbonate lenses, a heatsink, and wiring comprises a module. The preferred 8-module light fixture operates at 50 Watts or about 1.5 W per LED. Under operation, the heatsink has been measured at 40 degrees C. at a 25 degree C. ambient temperature. The temperature gradient between heatsink and thermal pad is 7 degrees C./Watt, so the pad temperature under those conditions is 50 degrees C. The temperature gradient between pad and LED junction is 10 degrees C./Watt (Philips data sheet). So, under these conditions, the junction temperature is 65 degrees C. The net temperature gradient between ambient and junction is thus roughly 40 degrees C. Even at ambient temperatures of 60 degrees C. (140 degrees F.), the junction temperature should remain around 100 degrees C. This is important from a lifetime and reliability standpoint.

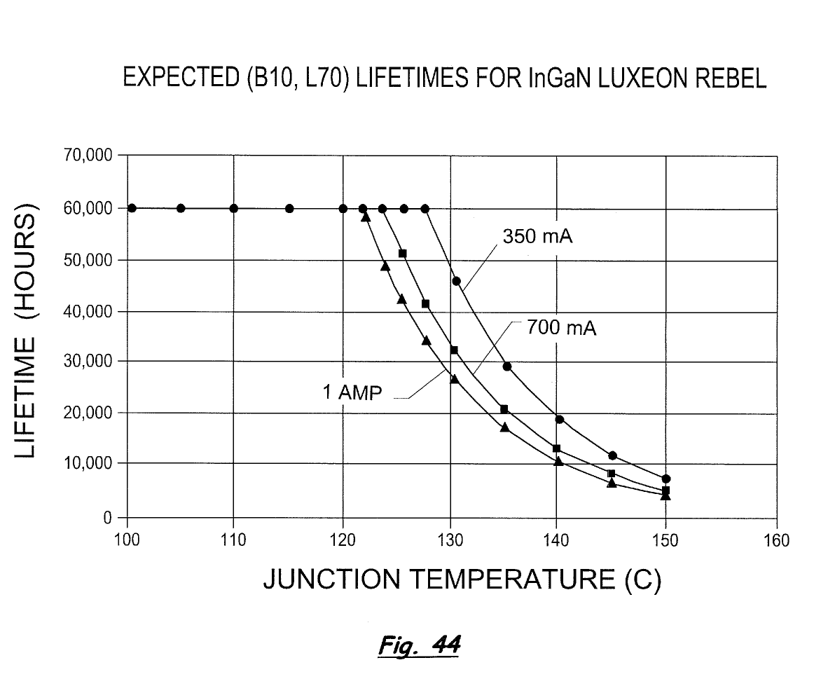

FIG. 44 is a plot of lifetime for Philips LED's as a function of junction temperature. The preferred lighting fixture operates at 450 mA, so the trend will be closer to the 350 mA trend line than the 700 mA trend line. B10 is the value at which 10% of the population is expected to fail, and L70 defines a lumen maintenance failure when a unit delivers less than 70% of its initial output. So the lifetime at (B10, L70) is the expected stress time (at a 90% confidence level) at which 10% of the population is expected to have either failed or has degraded by more than 30% from the initial light output. At a junction temperature of 100 deg. C., there should be plenty margin for maintaining a 60,000 hour LED lifetime.

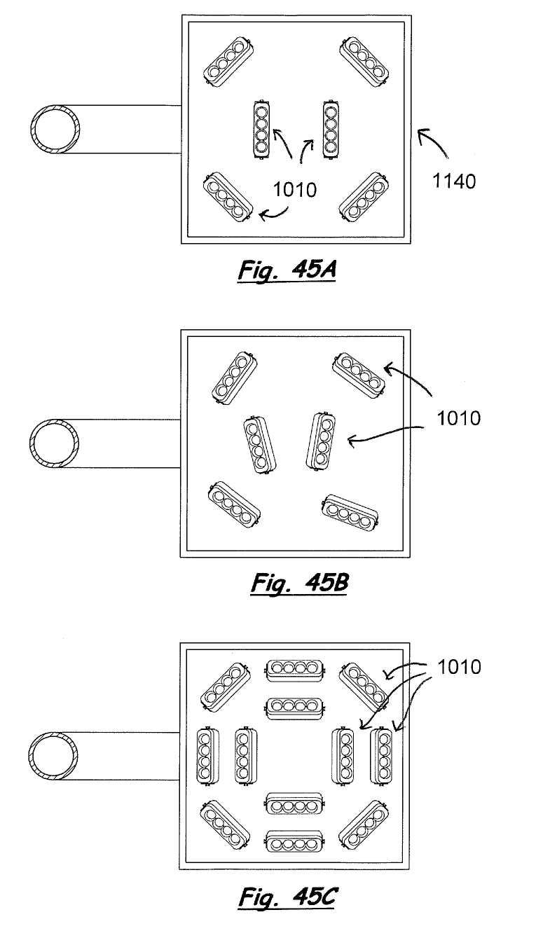

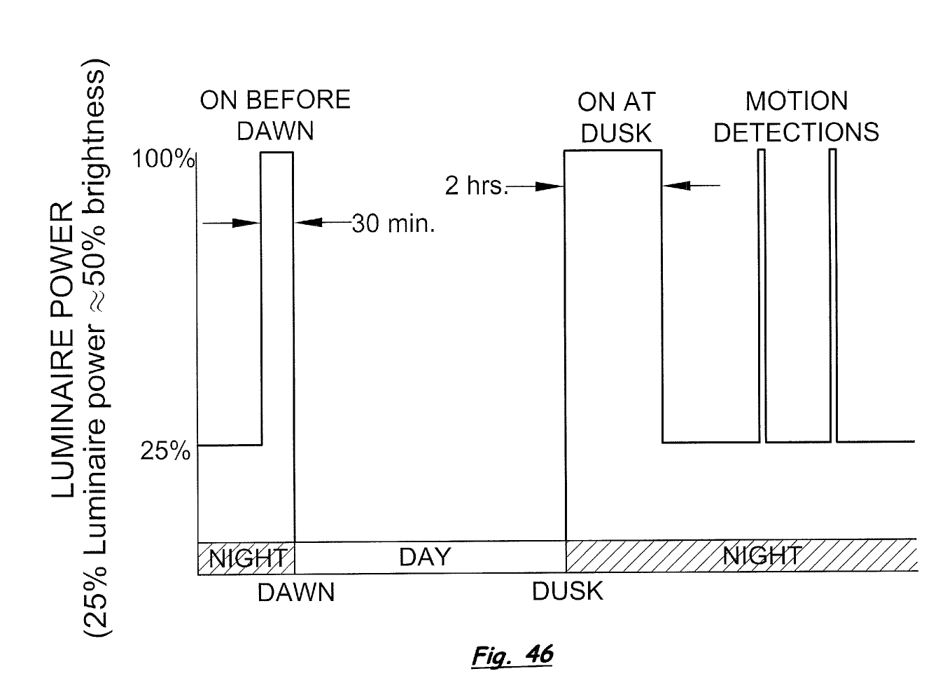

The preferred lighting fixture, using eight modules arranged in various patterns, can optimize the lighting distribution to meet Type 1-5 Lighting Patterns, which lighting patterns are known in the lighting industry. FIGS. 45A-C illustrate multiple, but not the only, possible arrangements for the LED modules, including a regular eight-module arrangement (FIG. 45A), a more random eight-module arrangement (FIG. 45B), and a twelve-module arrangement (FIG. 45C). As described elsewhere in this document, other styles of lighting fixtures may be used on the pole assembly, to match preexisting fixtures or the preferences of the customer.

Illuminance is a key parameter to assessing the ability of the luminaire to put light onto a surface. For Type 2 lighting patterns, which are possible from the LED modules arrangement shown in FIG. 45A (but with the two central modules preferably tilted slightly outward), illuminance on the surface at certain distances away from the pole are important. Measured illuminance from the Inventors' and Applicant's Type 2 luminaire at a 25 ft. pole height is 0.1 footcandles at 50 ft. This is roughly equivalent to the illuminance of a 100 watt High Pressure Sodium or Metal Halide luminaire after the bulb has burned in. This illuminance is created when running the luminaire at 50 watts total power (6.25 watts/module). Total luminaire Efficacy is 45 lumens/watt.

Currently-approved LED's for the luminaire are the Philips Rebel LXML-PWC1-0100 and the Cree XREWHT-L1-0000-00C01 and XREWHT-L1-0000-00D01. The LED Driver is preferably a SuperTex HV9910, high efficiency PWM driven control IC.

The controller consists of a microprocessor-based PCA and the associated firmware that controls the functions described herein. The PCA comprises Microchip's PIC18F6622 microprocessor, various logic components, power circuitry, an RS232 serial port, and low voltage connectors and circuitry for connection to other electrical subsystems/components. Most of the electrical connections to other subsystems are either for sensing the various states of those subsystems or for managing power to those subsystems. The control board senses the following:
1) The amount of light detected by the photocell, and manages the algorithms in response to the light detected.
2) Whether motion is detected by any of the motion sensors, and manages the algorithms in response to the motion detected.
3) The voltage of the battery system, and manages the selection of the energy savings modes from that information.
4) The current sent from the charge controller to the battery system, and reports that amount.

To manage the light output by the LED light fixture, the control board sends a 0-5V PWM output to the LED drivers in the luminaire to control the drive currents. The PWM values are determined via the microprocessor by executing the energy management algorithms (detailed below), which take into account values from the photocell, motion sensor and battery system. The control board communicates to the outside world via the RS232 serial port. Simple serial port communication programs can “talk” with the control board. Communication via the RS232 is primarily for reporting and testing. The control board is currently mounted inside the pole at the top of the battery compartment, at an angle to allow access to the RS232 connector. It is conformally coated with a protective film to guard against degradation from environmental extremes such as moisture, chemicals and salt air.

Motion sensors detect movement during low light or nighttime conditions. There are three motion sensors mounted on the light pole. They are low profile and unobtrusive (black body blends in with the pole). The motion detectors are capable of sensing motion out to 10 meters. Yet they have high a high S/N ratio and are low power consumption. Any motion detected is fed back to the controller board which then decides how to brighten the illumination of the LED's. Key variables in the algorithms include the current state of illumination and the battery voltage. The preferred motion sensors are Panasonic's Model AMN14111 “black”.

The photocell detects the ambient light conditions, and is primarily active within the system around dusk and dawn. Detected light level is used to adjust the resistance of the photodetector in the photocell circuitry. The control board senses the change in resistance of the photocell and uses it to determine when to turn the luminaire on (generally at dusk) and when to turn the luminaire off (generally at dawn). The photocell is a twist-lock mounted device that mounts onto standard photocell interfaces on the top of light fixture boxes. The electronics are conformally coated to withstand environmental extremes and are enclosed inside a UV resistant, high impact polypropylene case. It is also rated to operate from −40 deg C. to +70 deg C. The current photocell is the Fisher-Pierce 7760-ESS.

The wiring harness connects the batteries in parallel and connects all the subsystems. All wiring is Marine-grade, UL1426 approved wire. All connectors are initially coated with dielectric grease to prevent oxidation and corrosion of the metal contacts. All main power lines (from solar collector to charge controller & from charge controller to load and batteries) are fused (5 amps).

### Example Normal Mode Operation:

As portrayed in FIG. 46, toward the end of the day, as it starts to get dark, the photocell turns on the light at 100% (factory preset) normal power. It stays at 100% for two hours (factory preset) then dims down to 25% brightness (factory preset) for the balance of the night w/ motion sensor over-ride. If motion is detected it immediately brightens up to 100% for 10 minutes after the last-detected motion. It then dims back down to the lower setting over one minute. Towards dawn, the light will brighten back up to full brightness approximately 30 minutes (factory preset) prior to dawn. When the photocell threshold for dawn is crossed, the light will turn off.

### Example Energy-Savings Mode Operation:

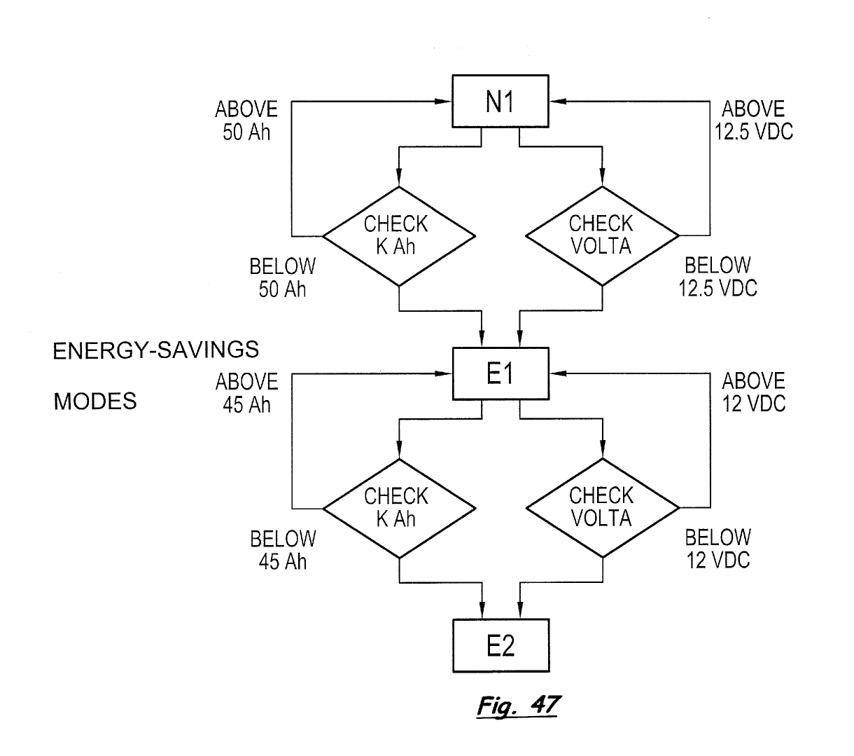

FIG. 47 portrays examples of how system conditions can be utilized to determine the appropriate energy modes based on current states to modify power delivered, to the light or other loads, beyond or instead of the “normal” changes over time shown in FIG. 46. For example, the voltage of the batteries (on the right of the figure) is one indicator of how much energy is available in the battery storage. As the battery voltage drops, the energy mode is adjusted so that energy can be conserved. On the left of the figure, the Ah decision block is referring to the solar production (in Amp-Hours, Ah) from the previous day. This Ah information is also an indicator of whether or not energy needs to be conserved. On any given day, if the energy produced is less than normal, then the energy mode is adjusted to conserve energy, over and above the adjustments shown in FIG. 46, preferably during the following night.

Energy Savings Modes are available (modes E1 through E6), and selection of the modes is determined by the measuring the battery voltage at the end of the day. During modes E1 and E2 the light is still brought up to full brightness initially & then dimmed down to less than 25% brightness down to a minimum brightness (for example, of 5-10%). During modes E3 through E5, the light is brought up to 80%, 70% and 50% of full brightness initially, and then dimmed down to less than 25% brightness down to as low as 7.5%. The time at which the light is brightened back up before dawn in also scaled back so that it is not up at full brightness for as long as normal mode. If the battery voltage drops below a minimum level (Vnb<11V), the controller enters the lowest energy savings mode, E6, and the light is turned off. It will not be allowed to turn on at all until the batteries are charged to 12V. Normal mode N1 and energy-savings modes E1-E6 are detailed below in three different programming versions.

### Example Programming for Various Energy-Savings Modes E1-E6 (Version A):

Look at daily production data from previous day: Total Amp-hours produced=Ah; and Ending battery voltage (that evening)=Veb.

If Ah>=14.4 and Veb>=12.5 then Mode=N1;
If Ah>=14.4 and 12.0<Veb<12.5 then Mode=E1;
If Ah>=14.4 and 11.5<Veb<12.0 then Mode=E2;
If Ah>=14.4 and 11.0<Veb<11.5 then Mode=E3;
If Ah>=14.4 and 10.5<Veb<11.0 then Mode=E4;
If Ah>=14.4 and 10<Veb<10.5 then Mode=E5;
If Ah>=14.4 and Veb<10.0 then Mode=E6;
If 12.8<Ah<14.4 and Veb>=12.5 then Mode=E1;
If 12.8<Ah<14.4 and 12.0<Veb<12.5 then Mode=E2;
If 12.8<Ah<14.4 and 11.5<Veb<12.0 then Mode=E3;
If 12.8<Ah<14.4 and 11.0<Veb<11.5 then Mode=E4;
If 12.8<Ah<14.4 and 10.5<Veb<11.0 then Mode=E5;
If 12.8<Ah<14.4 and Veb<10.5 then Mode=E6;
If 11.2<Ah<12.8 and Veb>=12.5 then Mode=E2;
If 11.2<Ah<12.8 and 12.0<Veb<12.5 then Mode=E3;
If 11.2<Ah<12.8 and 11.5<Veb<12.0 then Mode=E4;
If 11.2<Ah<12.8 and 11.0<Veb<11.5 then Mode=E5;
If 11.2<Ah<12.8 and Veb<11.0 then Mode=E6;
If 9.6<Ah<11.2 and Veb>=12.5 then Mode=E3;
If 9.6<Ah<11.2 and 12.0<Veb<12.5 then Mode=E4;
If 9.6<Ah<11.2 and 11.5<Veb<12.0 then Mode=E5;
If 9.6<Ah<11.2 and Veb<11.5 then Mode=E6;
If 8.0<Ah<9.6 and Veb>=12.5 then Mode=E4;
If 8.0<Ah<9.6 and 12.0<Veb<12.5 then Mode=E5;
If 8.0<Ah<9.6 and Veb<12.0 then Mode=E6;
If 6.4<Ah<8.0 and Veb>=12.5 then Mode=E5;
If 6.4<Ah<8.0 and Veb<12.5 then Mode=E6.
During the nighttime hours the battery is continuously monitored. The night battery voltage=Vnb, and If Vnb ever drops below 10 volts then turn light off and won't come on until Vnb>=10.5 volts.

### Mode N1:

Light turns on (full-brightness) at dusk & then turns down to 50% w/ time clock (time-clock factory pre-set for 2 hrs. after dusk—‘Timer’ mode); light then turns up to full-brightness 2 hrs before dawn; motion sensor over-ride turns light up to full-brightness immediately then dims down according to the following motion sensor dim-up/down rules, which apply to all modes (N1 thru E5):

If Vnb>=12.5 then increase light to 100.0% for 10 minutes & then dim down to 50% over 6 minutes; If 12.0<Vnb<12.5 then increase light to 100.0% for 8 minutes & then dim down to 50% over 4 minutes; If 11.5<Vnb<12.0 then increase light to 100.0% for 6 minutes & then dim down to 40% over 4 minutes; If 11.0<Vnb<11.5 then increase light to 100.0% for 4 minutes & then dim down to 30% over 2 minutes; If 10.5<Vnb<11.0 then increase light to 100.0% for 2 minutes & then dim down to 30% over 2 minute; If 10.0<Vnb<10.5 then increase light to 50% for 1 minute & then dim down to 20% over 1 minute; If Vnb<10.0 then light remains off.

### Mode E1:

Light turns on (full-brightness) at dusk & then turns down to 40% w/ time clock; light then turns up to full-brightness×number of hrs before dawn (if dawn timer mode set); motion sensor over-ride per listing above.

### Mode E2:

Light turns on (full-brightness) at dusk & then turns down to 30% w/ time clock; light then turns up to full-brightness×number of hrs before dawn (if dawn timer mode set); motion sensor over-ride per listing above.

### Mode E3:

Light turns on (full-brightness) at dusk & then turns down to 25% w/ time clock; light then turns up to full-brightness 0.75 times the number of hrs before dawn (if dawn timer mode set); and motion sensor over-ride per listing above.

### Mode E4:

Light turns on (full-brightness) at dusk & then turns down to 20% w/ time clock; light then turns up to full-brightness 0.5 times the number of hrs before dawn (if dawn timer mode set); motion sensor over-ride per listing above.

### Mode E5:

Light turns on (full-brightness) at dusk & then turns down to 15% w/ time clock; light then turns up to full-brightness 0.25 times the number of hrs before dawn (if dawn timer mode set); motion sensor over-ride per listing above.

### Mode E6:

Light turns off & remains off until Vnb>10.0.

### Time Clock Functions:

Time clock can be set according to two modes: a. Clock Mode; b. Timer Mode (uses the photo cell to determine pre-dawn and post-dusk times). There are two settings for Timer Mode: 1. “On”-Timer sets the amount of time the light turns on post-dusk; 2. “Off”-Timer sets the amount of time the light turns on pre-dawn. The Clock Mode allows the user to set the pre-dawn and pre-dusk ON times in hours and minutes. The lights will turn OFF based on the Timer Mode ON and OFF settings. Note that the factory default setting for the Timer Mode ON and OFF timers is 2 hrs.

### Battery Voltage Check Delay:

All battery voltages shall be verified by checking for at least 30 seconds. For example, if the battery voltage drops below 10.0 volts, it must stay below 10.0 volts for 30 seconds before turning the light off. Once the voltage goes above 10.0 volts, it must stay above 10.0 volts for at least 30 seconds before turning the light back on again (or performing actions per the rules above)

### Example 1 Under Version A Programming:

Total Watt-hours produced; Ah=15.6; Starting battery voltage (morning of November 1^{st}); Vsb=12.2V; Ending battery voltage (evening of November 1^{st}); Veb=13.1V; Time clock setting is timer on & off (dawn 2 hrs & dusk 2 hrs).

### Mode=N1, Example 1:

The light turns on at 100% at dusk & remains on for 2 hours. The light dims down to 50% and remains at 50% until the motion sensor activates the light back up to 100% for 10 minutes. The light then dims back down to 50% over the next 6 minutes. The light turns on at 100% at dawn and remains on for 2 hours then shuts off. The unit then switches to charging mode (lights off) until dusk mode. Note that both dusk and dawn modes are determined by a photocell.

### Example 2, Under Version A Programming:

Ah=11.8, Vsb=12.0V, Veb=11.7; Time clock setting is timer on & off (dawn 2 (×0.5) hours & dusk 2 hours).

Mode=E4, Example 2:

The light turns on at 100% at dusk & remains on for 2 hours. The light dims down to 20% and remains at 20% until the motion sensor activates the light back up to 100% for 2 minutes. The light then dims back down to 20% over the next 2 minutes. The light turns on at 100% at dawn and remains on for 1 hour then shuts off. The unit then switches to charging mode (lights off) until dusk mode.

### Example Programming for Various Energy-Savings Modes E1-E6 (Version B):

Look at daily production data from previous day: Total Watt-hours produced=Wh; starting battery voltage (morning of previous day)=Vsb; ending battery voltage (that evening)=Veb.

If Wh>=180 and Veb>=25.0 then Mode=N1;
If Wh>=180 and 24.0.0<Veb<25.0 then Mode=E1;
If Wh>=180 and 23.0<Veb<24.0 then Mode=E2;
If Wh>=180 and 22.0<Veb<23.0 then Mode=E3;
If Wh>=180 and 21.0<Veb<22.0 then Mode=E4;
If Wh>=180 and 20.0<Veb<21.0 then Mode=E5;
If Wh>=180 and Veb<20.0 then Mode=E6;
If 160<Wh<180 and Veb>=25.0 then Mode=N1;
If 160<Wh<180 and 24.0<Veb<25.0 then Mode=E2;
If 160<Wh<180 and 23.0<Veb<24.0 then Mode=E3;
If 160<Wh<180 and 22.0<Veb<23.0 then Mode=E4;
If 160<Wh<180 and 21.0<Veb<22.0 then Mode=E5;
If 160<Wh<180 and Veb<21.0 then Mode=E6;
If 140<Wh<160 and Veb>=25.0 then Mode=E1;
If 140<Wh<160 and 24.0<Veb<25.0 then Mode=E3;
If 140<Wh<160 and 23.0<Veb<24.0 then Mode=E4;
If 140<Wh<160 and 22.0<Veb<23.0 then Mode=E5;
If 140<Wh<160 and Veb<22.0 then Mode=E6;
If 120<Wh<140 and Veb>=25.0 then Mode=E3;
If 120<Wh<140 and 24.0<Veb<25.0 then Mode=E4;
If 120<Wh<140 and 23.0<Veb<24.0 then Mode=E5;
If 120<Wh<140 and Veb<23.0 then Mode=E6;
If 100<Wh<120 and Veb>=25.0 then Mode=E4;
If 100<Wh<120 and 24.0<Veb<25.0 then Mode=E5;
If 100<Wh<120 and Veb<24.0 then Mode=E6;
If 80<Wh<100 and Veb>=25.0 then Mode=E5;
If 80<Wh<100 and Veb<25.0 then Mode=E6;
If Wh<80 then Mode=E6;
If Veb<20.0 then Mode=E6
During the night-time hours the battery is continuously monitored. The night battery voltage=Vnb; if Vnb ever drops below 20 volts then turn light off. In any of the modes below, the low light level (when light is not at 100% per timeclock/photocell) setting shall be as follows:
If Vnb>=25 then low light level is 50%;
If 24<Vnb<25 then low light level is 50%;
If 23<Vnb<24 then low light level is 40%;
If 22<Vnb<23 then low light level is 30%;
If 21<Vnb<22 then low light level is 30%;
If 20<Vnb<21 then low light level is 20%;
If Vnb<20.0 then turn light off.

### Mode N1:

Light turns on (full-brightness) at dusk & then turns down to 50% w/ time clock (Time-clock factory pre-set for 2 hrs. after dusk—‘Timer’ mode); Light then turns up to full-brightness 2 hrs before dawn; Motion sensor over-ride turns light up to full-brightness immediately then dims down according to the following motion sensor dim-up/down rules apply to all modes (E1 thru E6):

If Vnb>=25 then increase light to 100% for 10 minutes & then dim down to 50% over 6 minutes; If 24<Vnb<25 then increase light to 100% for 8 minutes & then dim down to 40% over 4 minutes; If 23<Vnb<24 then increase light to 100% for 6 minutes & then dim down to 30% over 4 minutes; If 22<Vnb<23 then increase light to 100% for 4 minutes & then dim down to 25% over 2 minutes; If 21<Vnb<22 then increase light to 100% for 2 minutes & then dim down to 20% over 2 minute; If 20<Vnb<21 then increase light to 50% for 1 minute & then dim down to 15% over 1 minute; If Vnb<20.0 then light remains off.

### Mode E1:

Light turns on (full-brightness) at dusk & then turns down to 40% w/ time clock; Light then turns up to full-brightness×number of hrs before dawn (if dawn timer mode set); Motion sensor over-ride per chart above.

### Mode E2:

Light turns on (full-brightness) at dusk & then turns down to 30% w/ time clock; light then turns up to full-brightness×number of hrs before dawn (if dawn timer mode set); 6 Motion sensor over-ride per chart above.

### Mode E3:

Light turns on (full-brightness) at dusk & then turns down to 25% w/ time clock; Light then turns up to full-brightness 0.75×number of hrs before dawn (if dawn timer mode set); Motion sensor over-ride per chart above

### Mode E4:

Light turns on (full-brightness) at dusk & then turns down to 20% w/ time clock; Light then turns up to full-brightness 0.5×number of hrs before dawn (if dawn timer mode set); Motion sensor over-ride per chart above.

### Mode E5:

Light turns on (full-brightness) at dusk & then turns down to 15% w/ time clock; Light then turns up to full-brightness 0.25×number of hrs before dawn (if dawn timer mode set); Motion sensor over-ride per chart above.

### Mode E6:

Light turns off & remains off until Vnb>20

### Time Clock Functions:

Time clock can be set according to two modes: a. Clock Mode=time of day (lights off at 10 p.m.); b. Timer Mode=Set to turn on according to timer (2-hr. timer). There are two options in timer mode: 1. “On”-Timer sets the amount of time the light turns on post-dusk; 2. “Off”-Timer sets the amount of time the light turns on pre-dawn (for example the factory pre-set is 2 hrs. for “On” & “Off” timers). The timer can also be set in both time-clock for “on” & timer “off” mode which allows the user to set the on time at 10 p.m. & also have the light turn on for an hour pre-dawn.

### Battery Voltage Check Delay:

All battery voltages shall be verified by checking for at least 30 seconds. For example, if the battery voltage drops below 20 volts, it must stay below 20 volts for 30 seconds before turning the light off. Once the voltage goes above 20 volts, it must stay above 20 volts for at least 30 seconds before turning the light back on again (or performing actions per the rules above).

An example for the night of November 1^{st} to November 2^{nd}, Looking at daily production data from November 1^{st}: Total Watt-hours produced; Wh=195.21; Starting battery voltage (morning of Nov. 1^{st}); Vsb=24.43V; Ending battery voltage (evening of November 1^{st}); Veb=26.24V; Time clock setting is timer on & off (dawn 2 hrs & dusk 2 hrs). Light turns on to 100% at dawn & remains on for 2 hrs. At this time Vnb=25.54, so the light dims down to 50% & remains at 50% until the motion sensor activates the light back up to 100% for 10 minutes. The light then dims back down to 50%. At this time Vnb=24.96 & remains below 25 for more than 30 seconds. The light then dims down to 40% over the next 4 minutes. The motion sensor activates it again & it brings it back up to 100% for 8 minutes, then dims down 40% over the next 4 minutes. The battery voltage remains above 24 volts until 2 hrs. before dawn at which time it brings the light back up to 100%. During these 2 hrs. the voltage drops below 21 volts, so the light is dimmed down to 50% until the photocell turns the light off at dawn.

### Example Programming for Various Energy-Savings Modes E1-E6 (Version C):

Create a hidden menu that allows certain variables to be stored in non-volatile memory. User access to these variables may be restricted. These variables should include: Peak Power (Pp); Dusk Reference; Dawn Reference; and Dim Down Time, wherein: Peak Power=Pp, and is adjustable in Hidden Menu; “On” time at Dusk (in minutes)=Tk, and is adjustable in Local Programming, and default is 120; “Off” time pre-Dawn (in minutes)=Tn; and is adjustable in Local Programming, and default is 30; Night time period (# minutes it is dark at night)=Nt; Dimmed down percentage=Dp, and is adjustable in Local Programming, and default is 25; Night-time (during the night) battery voltage=Vnb; and Ending battery voltage from previous day=Veb.

If Veb>=12.5 then Mode=N1;
If 12.0=<Veb<12.5 then Mode=E1;
If 11.5=<Veb<12.0 then Mode=E2;
If 11.0=<Veb<11.5 then Mode=E3;
If 10.5=<Veb<11.0 then Mode=E4;
If 10.0=<Veb<10.5 then Mode=E5;
If Veb<10.0 then Mode=E6;
For the first full cycle, the system will operate according to the factory pre-sets. The default Nighttime period will be set to 24 hours. The photocell will “start the timer” for Future Night Timer at dusk & the photocell will “stop the timer” in the morning in order to determine what the value (Nt) will be for the second night. Nt will be saved to EEPROM so that it is not lost when the unit is reset. A check will be put in place to prevent any unusable Nt values from being saved. If a timer value is changed in local programming after it has already begun running it will not be used until the next time that timer starts.

The photocell turns on the light at dusk & keeps the light on for the pre-set time period Tk (in minutes), at which time it gradually (over one min) dims it down to a lower power level defined by Dp. Dp is the dimmed percentage from the Peak Power (Pp) setting. For example, if the ‘normal’ Peak Power (Pp) condition consumes 48 Watts (4 amps at 12 volts), and Dp=0.25, then the dimmed down percentage is 25% and would reduce the power consumed to 12 Watts (or 1 amp at 12 volts).

At Nt-x*Tn number of minutes pre-dawn, the light is turned back up to full-brightness. So if Nt=480 min., x=100% and Tn is 60 minutes, then Nt−Tn=420 minutes. So, after the light turns on at night (per the photocell), it dims down per Tk, then brightens back up to full brightness after 420 minutes until the photocell turns it off at dawn.

The photocell overrides the timer. If dawn occurs before the predawn timer has finished running the light will be turned off. The light should never be on while the sun is out. In the event that the Dawn Reference is crossed before a true dawn event (i.e. a “false dawn event”), it is possible that the Future Night Timer value becomes too short, and the light could be FULL ON for hours the following night. To prevent this from happening, a true Dawn Timer should be implemented such that after Tn minutes, if the Dawn Reference is not crossed, the light will dim back down to its appropriate dim down percentage. All other conditions and algorithms remain unchanged. If the Dawn Reference is crossed during the countdown of Tn (i.e. real dawn), the light will turn OFF. During the nighttime hours the battery is continuously monitored. The night battery voltage=Vnb. If Vnb ever drops below 10 volts then turn light off and don't turn on until Vnb>=10.5 volts.

### Mode N1:

Light turns on (full-brightness) at dusk & then turns down to lower light level (per Dp) after the time period Tk. Light then turns up to full-brightness Tn number of minutes before dawn. During the night (when in the dimmed down state), motion sensor over-ride turns light up to full-brightness immediately then dims down according to the following, wherein the following motion sensor dim-up/down rules apply to all modes (N1 thru E5):

If Mode=N1 then increase power to 100.0% for 10 minutes & then dim down over 1 minute; If Mode=E1 then increase power to 100.0% for 8 minutes & then dim down over 1 minute; If Mode=E2 then increase power to 100.0% for 6 minutes & then dim down over 1 minute; If Mode=E3 then increase power to 80.0% for 4 minutes & then dim down over 1 minute; If Mode=E4 then increase power to 70.0% for 2 minutes & then dim down over 1 minute; If Mode=E5 then increase power to 50% for 1 minute & then dim down over 1 minute; If Mode=E6 then light remains off. The program continues to monitor for motion even while running its motion detection timer. Timer will be reset each time motion is detected.

### Mode E1:

Light turns on (full-brightness) at dusk & then smoothly (over one minute) ramps down to 80% (of Dp) after Tk minutes. Light then turns up to full-brightness 80% of Tn minutes before dawn. Motion sensor over-ride per rule list above.

### Mode E2:

Light turns on (full-brightness) at dusk & then smoothly (over one minute) ramps down to 60% (of Dp) after Tk minutes. Light then turns up to full-brightness 60% of Tn minutes before dawn. Motion sensor over-ride per rule list above.

### Mode E3:

Light turns on (full-brightness) at dusk & then smoothly (over one minute) ramps down to 50% (of Dp) after Tk minutes. Light then turns up to full-brightness 50% of Tn minutes before dawn. Motion sensor over-ride per rule list above.

### Mode E4:

Light turns on (full-brightness) at dusk & then smoothly (over one minute) ramps down to 40% (of Dp) after Tk minutes. Light then turns up to full-brightness 40% of Tn minutes before dawn. Motion sensor over-ride per rule list above.

### Mode E5:

Light turns on (full-brightness) at dusk & then smoothly (over one minute) ramps down to 30% (of Dp) after Tk minutes. Light then turns up to full-brightness 30% of Tn minutes before dawn. Motion sensor over-ride per rule list above.

### Mode E6:

Light turns off & remains off until Vnb>10.5.

### Timer Function:

The timer can be set according to the following options. Timer Mode may use the photo cell to determine the time period of the night. Photocell values for dusk and dawn can be set in the Hidden Menu. Defaults are 600 for Dawn and 700 for Dusk. These will need to be more precisely determined with testing. Dawn will be determined by monitoring the photocell value at an adequate level of brightness. Dusk will be determined by monitoring the photocell value at an adequate level of darkness. A photocell value greater than the Dusk setpoint will be considered night. A photocell value less than the Dawn setpoint will be considered day. There will be a sufficiently large deadband between the two setpoints. A trigger time of one minute will be given to each Dawn/Dusk setpoint. The light will never be on when the photocell reading is below the Dawn setpoint once the trigger time criteria has been met.

There are two settings for Timer Mode, which are: 1) “On”-Timer sets the amount of time the light turns on to full brightness at dusk; and 2) “Off”-Timer sets the amount of time the light dims back up to full brightness pre-dawn. The Timer Mode allows the user to set the pre-dawn and pre-dusk ON times in minutes. The lights will turn on & off based on the Timer Mode ON and OFF settings. Note that the factory default setting for the Timer Mode ON timer is 2 hrs. (variable Tk), and the factory default setting for the Timer Mode OFF timer is 0.5 hr. (variable Tn).

### Duty Cycle to Brightness Correlation:

The relationship of PWM to the percentage of power is based on the equation 100*(1-PWM)̂2=Power %. Such that a duty cycle of 0.2=64%, 0.5=25%, and a duty cycle of 0.9=1%.

### Battery Voltage Check Delay:

All battery voltages shall be verified by checking for at least 30 seconds. For example, if the battery voltage drops below 10.0 volts, it must stay below 10.0 volts for 30 seconds before turning the light off. Once the voltage goes above 10.5 volts, it must stay above 10.5 volts for at least 30 seconds before turning the light back on again (or performing an action per the rules above).

Example 1, under Version C programming:

Starting battery voltage (morning of November 1^{st}); Vsb=12.2V; Ending battery voltage (evening of November 1^{st}); Veb=13.1V; Factory pre-sets for Tk=120 & Tn=30 (dusk 2 hrs & pre-dawn 0.5 hr.); Dp=0.25; Mode=N1; and Light is turned on & off by the photocell.

Photocell turns the light on at 100% at dusk & remains on for 2 hours, at which time the light dims down to 25% power over the next minute. The light remains at the dimmed down light level state until the motion sensor is activated, at which time the light is brought back up to 100% for 10 minutes. The light then dims back down to 25% power over the next minute. The light dims back up to 100% 30 minutes pre-dawn and remains on until the photocell shuts the light off.

### Example 2, Under Version C Programming:

Starting battery voltage Vsb=12.0 V; Ending battery voltage Veb=11.3 V; Factory pre-sets for Tk=120 & Tn=30 (dusk 2 hrs & pre-dawn 0.5 hr.); Dp=0.25; Mode=E3; and Light is turned on & off by the photocell.

Photocell turns the light on at 100% at dusk & remains on for 2 hours, at which time the light dims down to 12.5% power (50% of Dp) over the next minute. The light remains at the dimmed down light level state until the motion sensor is activated, at which time the light is brought back up to 80% for 4 minutes. The light then dims back down to 12.5% power over the next minute. The light dims back up to 100% 0.5 hr. pre-dawn and remains on until the photocell shuts the light off.

### Charging Circuit:

A minimum Ah threshold will be set to eliminate noise that could create false counts on the Ah Min and Ah Hours readings.

### Test/Diagnostic Capabilities:

The following numbered list comprises requests in firmware to facilitate testing and diagnosing problems. It is assumed that that there is a test tool available that allows communication with the control board and to pass along test and diagnostic parameters, as well as receiving responses/output from the control board.

1) Ability to provide external commands which dictate a specific duty cycle to be output from control board PWM output line to drivers in the LED engine.
2) Ability to send response from control board regarding duty cycle of PWM pulses just sent. This needs to be done either through an automatic reporting algorithm (information reported periodically or at set intervals) or on issue of a “manual” command to do so.
3) Ability to “manually override” data for the following variables and input an artificial value for that variable.
a) “On” time at Dusk (in minutes)=Tk
b) “Off” time pre-Dawn (in minutes)=Tn
c) Night time period (# minutes it is dark at night)=Nt
d) Dimmed down percentage=Dp
e) Night-time (during the night) battery voltage=Vnb
f) Ending battery voltage from day just completed=Veb
4. Ability to report the status of the variables listed in 3) above any time a command to report those variables is given.

### Data Dump:

Change Data Dump's frequency to seconds. Data Dump values can be imported into an Excel.csv file with column headings.

### Controller Operational Modes:

Nightly energy consumption for the Inovus Visia™ 100 luninaire (featuring 8 LED modules, in arrangement similar to FIG. 45A) is from 84 watt-hours to 206 watt-hours.

### Load Shedding:

The main function of the Load Shedding System is to maintain power to the most important loads as energy conservation modes are incorporated.

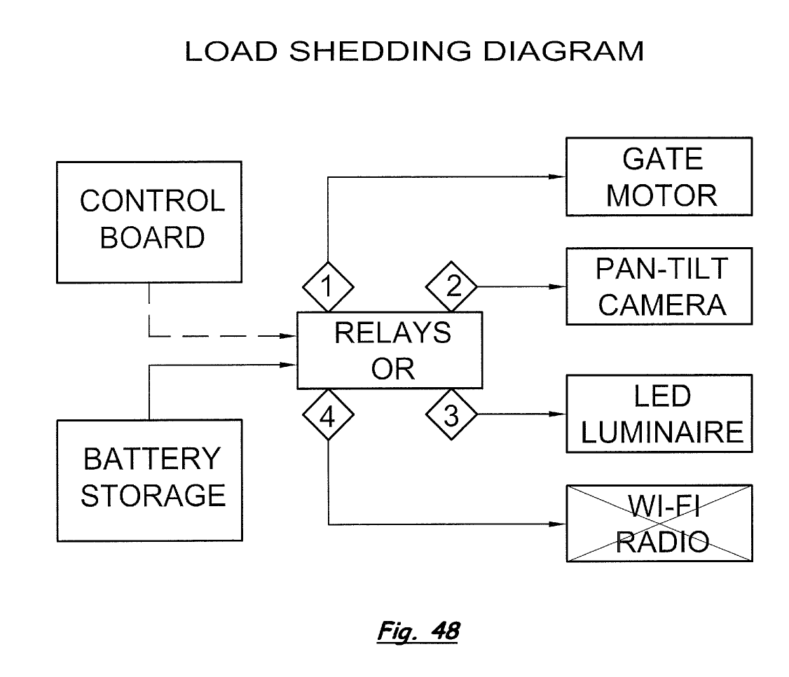

Power is retained to Primary Loads (Gate Motor and Pan-tilt Camera), which are the most critical functions in the example shown in FIG. 48. Because of this, these are the loads that will remain connected to power the longest.

When energy stores in the batteries drop below the predetermined levels, the loads will begin to be “shed” (disconnected from the power source, that is, the batteries). The Secondary Loads (First WIFI and then LED Luminaire) are shed first. The control board sends a control signal to each required load shed relay (in turn) as required to conserve energy while still maintain power to the Primary Loads.

### Efficiency and Adaptations to Last Through the Winter

Certain solar collector embodiments are amorphous, rather than a crystalline material, and, while it is fairly low in efficiency compared to many recently-developed photovoltaic cell materials, the preferred solar collector has features described herein, and the invented active control system has features described herein, that result in surprisingly effective and successful solar-powered outdoor lighting.

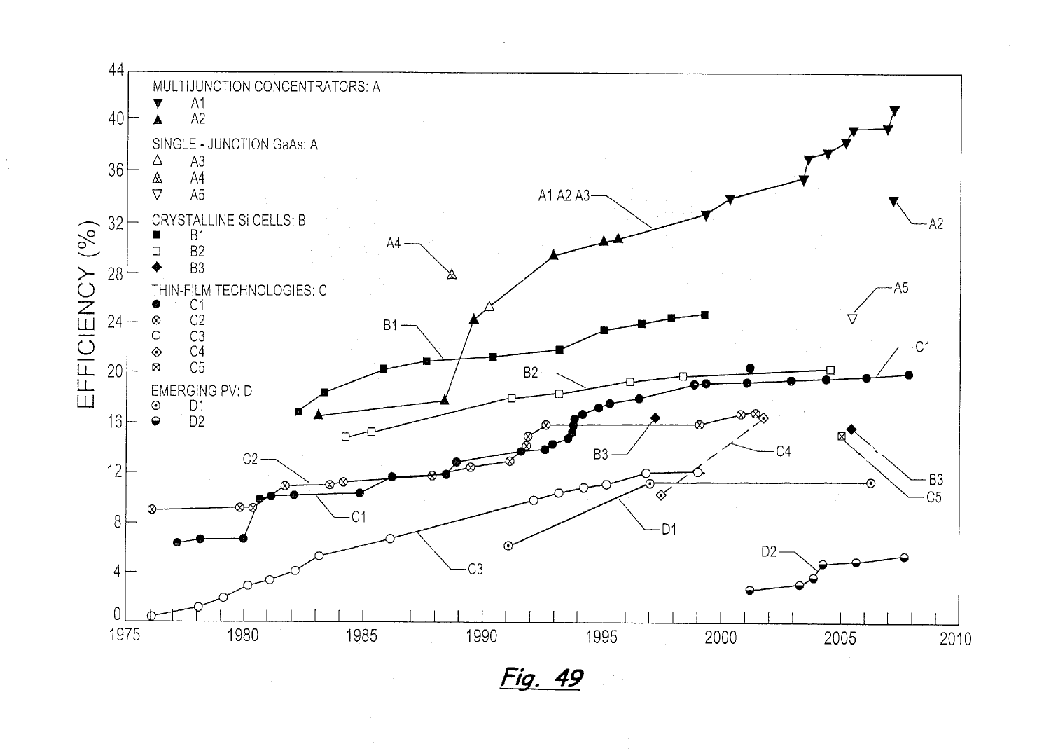

Referring to FIG. 49, research data over the years for many different photovoltaic cells is shown, with efficiencies currently ranging from approximately 5-43% for different photovoltaic cells. Efficiency in FIG. 49 is defined as the maximum watts per square meter of solar collector surface area compared to solar irradiance over the earth. The average irradiance or solar insolation over the entire earth (as an average) is approximately 164 watts per square meter. So, a solar collector that is 40% efficient would produce approximately 66 watts. The key for FIG. 49 represents various photovoltaic cells, under the general categories of A=multijunction concentrators and single junction GaAs; B=Crystalline Si Cells; C=thin-film technologies; and D=emerging PV. The subsets of the key are: A1=three-junction (2-terminal monolithic); A2=two-junction (2-terminal, monolithic); A3=single crystal; A4=concentrator; A5=thin film; B1=single crystal; B2=multicrystalline; B3=thick Si film; C1=Cu(In,Ga)Se₂; C2=CdTe; C3=amorphous SiH (stabilized); C4=Nano, micro, poly-Si; C5=multipjunction polycrystalline; D1=dye-sensitized cells; and D2=organic cells (various technologies).

FIG. 49 includes the solar collector “C1”, used in the currently-preferred embodiments of the invention. This collector is in the category of flexible thin film photovoltaic cells and has to the ability to improve to approximately 19% efficiency. The preferred solar collector material is much more shade tolerant than crystalline or polycrystalline solar panels, which is an important advantage above and beyond the advantage of being economical compared to the high-efficiency (greater than 25% efficient, for example) PV cells. It is better at collecting solar energy when it is cloudy, and it is also better at collecting scattered and incident light; see the discussion of shade-tolerance and collection of diffused light earlier in this Example. The inventors contend that cloudy/diffuse-light days are when performance of a solar-powered lighting system is most critical; when the collection opportunity is hampered by shade/diffuse light, the preferred flexible thin film PV cell material is actually is more efficient under such conditions than a crystalline PV system.

The vertically-mounted “wrapped” configuration of the solar collector on a round pole, in the preferred embodiments, is superior in two ways. First of all, the collector always has a good portion of its surface area facing the sun. So, if there is great sun in the morning, but limited sun after noon, then the total for the day is still good due to the morning collection. The system can collect much more than a conventional system because a conventional system only faces the optimum location at noon—missing out on possible opportunities in the morning or late afternoon. The second advantage of the preferred system is the fact that the angle of the sun with respect to the solar collector is optimum in the morning & late afternoon (when the sun is lower in the sky) and also in the winter. These are the times when it is typically more important to collect as much energy as possible (because the days are shorter in the winter). In the summer, there is plenty of sun, so the preferred system performs well, too, even though it is optimized (by design) for winter operation.

Because the batteries can only store a set amount of energy, there is no way that the storage system could be large enough to store energy from the summer to use in the winter. Therefore, all “overproduction” in the summer is basically wasted. By maximizing (focusing on) the winter performance in the preferred embodiments, every possible bit of solar energy is “squeezed out” and also conserved during operation over the winter nights, to keep the system operational over the winter. Even on the cloudiest day, the preferred embodiments of the invention produce about 20% of the normal (sunny day). This allows the system to always have some energy available, even if it can only turn the light on (at a lower dimmed down state) for a couple of hours at the beginning of the night. In testing, such dimmed-down operation being possible for only a couple of hours has only happened once, in Houston, Tex. testing, when a pole reached the lowest energy mode, but said lowest energy mode was due to “false motion” events. A tree with a light source behind it was shining towards the motion detector, and the wind blowing the tree was interpreted as motion (the IR detector saw the heat from the light & therefore the motion). To avoid such events, programming was changed to ignore continuous motion and treat it as an error/alert condition to be ignored after a certain period of time. “Continuous” in this context may be set by the manufacturer, for example, and preferably means in the range of motion at least every two minutes for a set time period in the range of 30-minutes. Aiming the motion detectors down, so that motion above about 10 feet high would be ignored, has also been found to be effective, so that human and vehicular traffic is sensed but not swaying trees limbs.

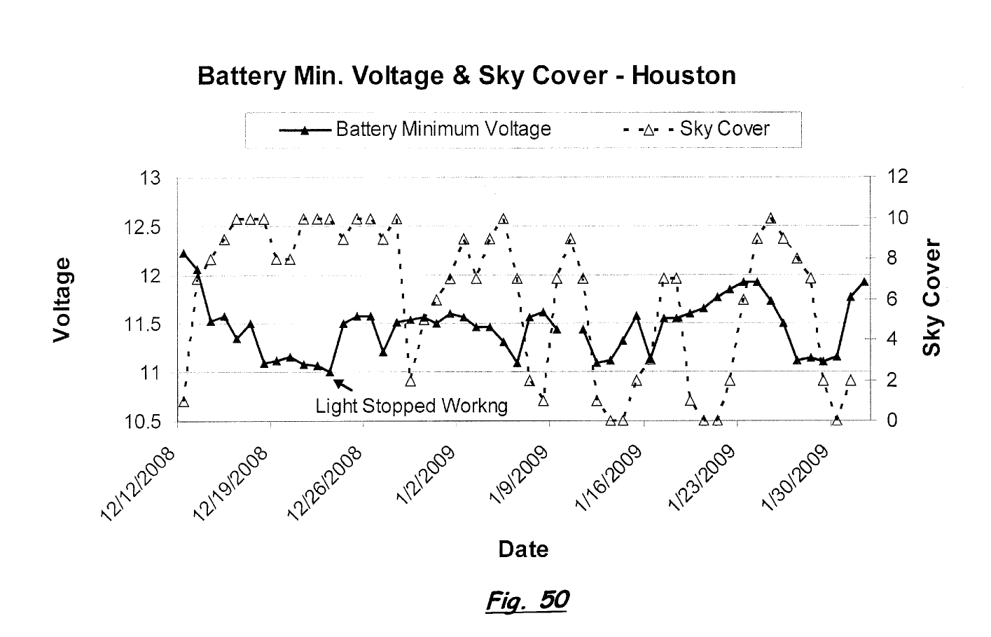

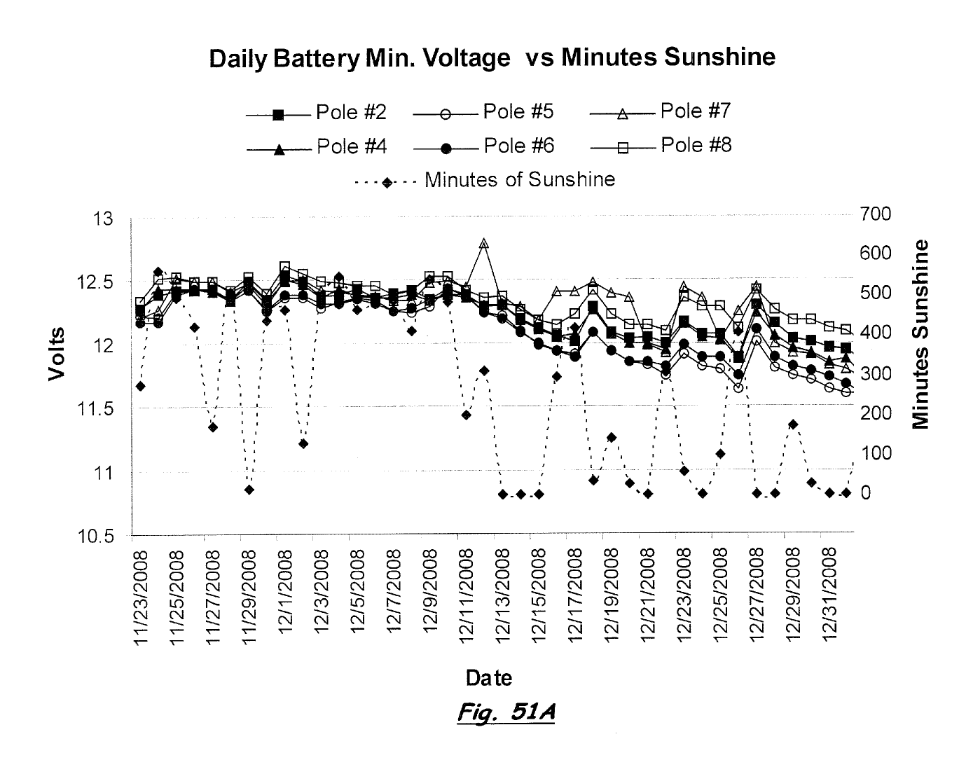

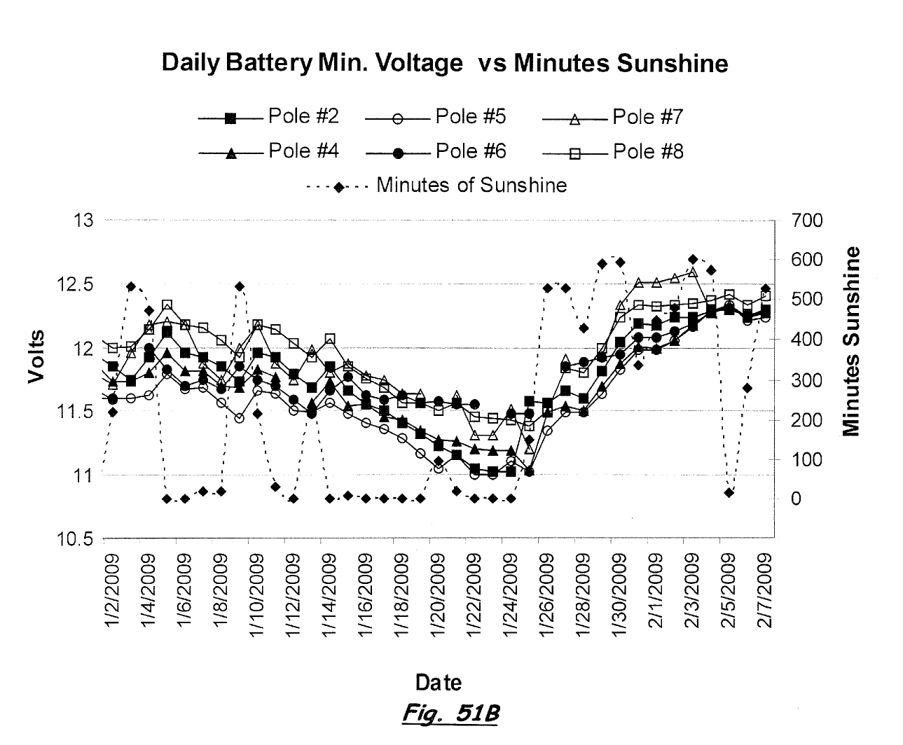

Therefore, because of the synergistic effects of the superior performance of the selected PV cell material in shade and diffused light, and the energy-saving active control discussed above, surprising results have been achieved in testing of the preferred embodiments. FIGS. 50 and 51A and B illustrate these surprising results for autonomous poles not tied to the grid that operated independently from each other (not networked for the purpose of these tests), wherein long periods of successful operation of the outdoor lighting was accomplished, without any tie to or contribution of energy from the electrical grid, without any replacement of the batteries, and without any energy input into the batteries or any part of the lighting system except from the PV cell material on each pole.

In FIG. 50, one may see long periods of days and weeks of sky cover (measured in hours during the day, defined as “cloudy” or “overcast” as judged from the local weather report), but the system maintained minimum battery voltage above the important benchmark of approximately 11 volts all through the roughly two month winter period, except for the “waving tree limb” incident in December, described above. In FIGS. 51A and B, which represent a different test, of a set of poles operating over about 2.5 winter months (the graph being split roughly in two), multiple poles operating independent of each other and not tied to the grid, all performed continuously at or above 11 volts throughout the winter, despite long stretches of little or no sunshine per day. Even during the dark days of January, only a few of the poles came near to dropping to 11 volts, at which increased dimming action per the energy-savings mode E6 kept the poles operating successfully, at least at dimmed condition, during the crucial periods after dusk and before dawn, and upon motion being sensed. Up an increase in sunshine late in January, the batteries all rebounded to a range of 12-12.5 volts.

Preferred embodiments may therefore be described as including: A solar-powered outdoor lighting system comprising: a flexible photovoltaic solar collector panel curved at least 180 degrees around a generally cylindrical light pole and attached to the light pole so that the panel is generally vertical; a lighting fixture connected to the pole and comprising multiple light emitting diodes (LEDs); at least one battery operatively connected to the solar collector panel and the LEDs; an active controller system comprising a maximum power point tracking charge controller adapted to charge said at least one battery, and a load controller adapted for management of energy delivery to said LEDs, wherein said management of energy delivery is adapted to turn on, turn off, dim and brighten said LEDs; at least one motion sensor connected to said pole and operatively connected to said load controller; wherein said load controller is adapted, in response to said motion sensor sensing motion near the pole when the LEDs are in a dimmed state, to increase power to said LEDs to brighten said LEDs at least while said motion is detected. Said active controller may be adapted to dim said LEDs when said at least one battery falls to a battery voltage in the range of 1-2 volts above a minimum safe battery voltage, said minimum safe battery voltage being a voltage below which battery damage occurs. Said solar-collector preferably is amorphous silicon (non-crystalline) photovoltaic material having an efficiency in sunshine in the range of 10-20%. Said active controller system may be adapted to determine an amount to dim said LEDs, during a nighttime at least when said at least one motion sensor is not sensing motion near the pole, based on battery voltage of said at least one battery at dusk prior to said nighttime. Or, said active control system may be adapted to determine an amount to dim said LEDs, during a nighttime at least when said at least one motion sensor is not sensing motion near the pole, based on energy production in amp-hours by said solar collector panel in a previous time period comprising one or more days. Or, said active control system may be adapted to determine an amount to dim said LEDs, during a nighttime at lease when said at least one motion sensor is not sensing motion near the pole, based on historical data of energy collection by the solar collector over a period one year earlier. The active control system may be adapted to disconnect any battery that fails, for example, by failing to hold a charge. Said active controller system may be adapted to turn on said LEDs and bring said LEDs to full brightness at said dusk, and then dim the LEDs down to 25% or less brightness down after a predetermined amount of time and throughout the nighttime except for times during the nighttime when said at least one motion sensor senses motion near said pole. Or, said active controller system may be adapted to turn on said LEDs at dusk at a reduced brightness in the range of 50%-80% of full brightness, to dim the LEDs down to less than 25% brightness after a predetermined amount of time throughout the nighttime except for times during the nighttime when said at least one motion sensor senses motion near said pole. Or, said active controller (or said load controller) may be adapted, in response to said motion sensor sensing motion near the pole when the LEDs are in a dimmed state, to increase power to said LEDs to brighten said LEDs to 50-80% of full brightness while said motion is detected. Or, said active controller system may be adapted to turn on said LEDs at dusk at a reduced brightness in the range of 50-80% of full brightness, and then dim the LEDs down to a range of 7.5%-25% of full brightness after a predetermined amount of time and throughout the nighttime except for times when said at least one motion sensor sensed motion near said pole. The lighting system may also comprise peripheral devices on said pole powered by said at least one battery, and wherein said active controller system is adapted to shed loads connected to the battery by turning off said peripheral devices to conserve battery energy. Said active controller system may be adapted to brighten said LEDs in response to said at least one motion detector only when said motion is below about 10 feet from the ground and only when said motion is not continuous. Also, the preferred embodiments of the invention may be methods of controlling an outdoor lighting system, for example, comprising: providing a flexible solar collector panel curved at least 180 degrees around a generally cylindrical light pole so that the solar collector is generally vertical; providing a lighting fixture connected to the pole and comprising multiple light emitting diodes (LEDs); providing at least one battery operatively connected to the solar collector panel and the LEDs; providing at least one motion sensor on said pole; actively controlling energy delivery from said at least one battery to said LEDs, by turning on, dimming and turning off said LEDs according to at least one mode of operation, said at least one mode of operation comprising a normal operation mode comprising turning said LEDs on at dusk to full brightness for a first predetermined amount of time, and, after said first predetermined amount of time, dimming said LEDs to a first fraction of said full brightness, until said at least one motion sensor detects a motion event near said pole and then increasing energy delivery to said LEDs for a certain time (for example, a second predetermined amount of time that is timed from the beginning of the motion event, or, timed from when said at least one motion sensor no longer detects said motion event), followed by reducing energy delivery to said LEDs to dim said LEDs, so that the LEDs are dimmed to less than full brightness in between motion events. The methods may include actively controlling energy delivery from said at least one battery to said LEDs by increasing energy delivery to said LEDs for a third predetermined amount of time before dawn so that said LEDs remain at full brightness until dawn. The methods may include dimming said LEDs when said at least one battery falls to a battery voltage in the range of 1-2 volts above a minimum safe battery voltage, said minimum safe battery voltage being a voltage below which battery damage occurs. The methods may include determining dimming based on battery voltage, previous amp-hours production, and/or historical data or weather or solar collector performance/production. The methods may include at least one mode of operation includes at least one energy-saving mode comprising turning said LEDs on at dusk to a second fraction of full brightness for said first predetermined amount of time, and then dimming said LEDs to a further-reduced third fraction of full brightness, until said at least one motion sensor detects a motion event near said pole and then increasing energy delivery to said LEDs for said second predetermined amount of time to said second fraction of full brightness, and, when said at least one motion sensor no longer detects said motion event, reducing energy delivery to said LEDs to dim said LEDs again to said third fraction of full brightness, so that the LEDs are dimmed to said third fraction of full brightness in between motion events. Said second fraction of full brightness may be in the range of 50%-80% of full brightness, and said third fraction is 7.5%-25% of full brightness. Said methods may include brightening said LEDs to said third fraction of full brightness for a third predetermined amount of time before dawn.

It will be understood from this document that active control may comprise changes in control settings other than simply turning on and turning off a light or other device may be performed in response to various signals or diagnostics. “Throttling” the power of a light of other device is included, as are more complex control actions. For example, devices may be put into sleep mode or another low-energy mode, as in the case of a WI-FI access point being put into a lower bandwidth/energy mode such as 802.11g or 802.11b, or a sleep mode, when not being used or when required by the energy balance of the utility unit/pole. For example, limits may be placed on maximum allowable full brightness time per night, or on the number of allowable low voltage disconnects and low voltage reconnects per night. Also, for example, other control settings that may be changed are the rate at which a light is dimmed down during the dimming process, or the time when (or rate at which) a light is brought back up to full brightness from a dimmed-down state when motion is detected.

### Example II

### Infrastructure Pole with Self-Diagnostics

The intelligent controller(s) of the preferred utility units or network may have the capabilities of performing self-diagnostics, which may be a portion of the apparatus and methods of the overriding systems of Example III, below. Self-diagnostics allow the system to detect potential errors and/or failures in the system. For instance, a light might be out, or a motion detection may fail, or the photosensitive device might not be working properly, or some other load may not be working properly. The result of this self-diagnosis can either be sent to a central processing/control node, or be dealt with locally inside the utility unit (individual pole) itself. Either a self-repair can be initiated, a notification/alert sent (contributing to data accumulated over time and used as a trigger), and/or a service call can be initiated.

Certain embodiments provide infrastructure poles comprising one or more PV panels and one or more devices that provide utility services. Therefore, each pole (including its associated devices and control) may be called a utility unit. Each utility unit may be adapted to detect and adjust the control and/or operation of one or more devices/systems when the behaviors of the devices/systems fall outside of standard (normal) conditions. These self-diagnostics gather data from the devices/systems to determine how they are functioning and to confirm they are operating according to given requirements and/or specifications. When aberrant or unexpected behavior is detected, the control system (broadly called “controller” herein) modifies control of the devices/systems to adjust or compensate for these conditions. This may be accomplished by a computer control board with local memory that intelligently manages the operation of pole-mounted devices/systems based on inputs such as sensor inputs, operator inputs, historical data (including pre-programmed and locally-collected data), and/or performance and/or functional data from pole-mounted devices/systems. Algorithms are programmed into the computer control board (“controller”) that intelligently control the pole-mounted devices/systems based on the input data and pre-programmed device/system parameters, said pre-programmed system parameters being the parameters that govern the default operating conditions of the devices/systems. These algorithms include feedback control loops that analyze data, make adjustments by changing the settings for behavior of the devices/systems, analyzing subsequent device/system behavior (after the change), and then further adjusting control until the required output is achieved. An interface allows connection of a computer (for example, a control station preferably including an internet interface, or portable remote-monitoring computer) to the control board for collecting stored data, changing said device/system parameters and or programming.

Said operator inputs may either be done locally by attaching a controller/computer to the pole's control board or remotely through power line communications (PLC) or wireless connection. Operators can input a new lighting profile, change any of the permissible parameters that affect operation of a load device, for example. For example, such parameters may include maximum power level, dusk/dawn detection threshold, maximum allowable full brightness time at night, maximum allowable motion sensor events, dimming percentages, pan/tilt/zoom control of video cameras, resolution of camera, amount of duration of high resolution of camera in response to detected motion, broadcast power for wireless transceivers, sensitivity settings for sensors, and/or resolution for displays (how high of resolution to display images), etc. Since these parameters are operator-driven, they are typical done on an as needed basis, which means infrequently.

Said historical data may include, for example, temperature, amount of ambient light, amount of charging to energy storage unit, amount of time spent in bulk charging mode vs absorption charging mode, amount of energy consumed, difference between energy charged vs energy consumed, number of charge/discharge cycles, depth of discharge, number of motion sensor events, number of times camera has panned to a certain location, amount of time camera has spent in high resolution vs. low resolution, or sleep mode, number of times a call box has been activated, number of low voltage disconnects (LVD) and low voltage reconnects (LVR) events, etc.

In certain embodiments, the controller is mounted inside the pole and operatively connected to each of the pole-mounted devices/systems for continual monitoring of the operation of the devices/systems. When any behavior is detected that is outside of the specified or required operation (“abnormal operation”), the controller makes adjustments to attempt to bring the operation back within the specifications. In cases where the device/system is non-responsive or cannot be brought back in line (within specifications or to “normal operation”), subsequent control adjustments are made, including larger or different adjustments. These control adjustments may be broadly called changes in “control settings” and may encompass many different actions within the mode called “detect-trigger-action”, for example. The algorithms programmed into the controller enable it to provide active and intelligent control functions for providing appropriate output (to cause said action) after receiving sensor/detection input.

The computer control board (controller) is equipped with microprocessor, on board memory, and the ability to be programmed and re-preprogrammed (for firmware updates and/or changes to the original programming). The controller is equipped with the ability to accept one to multiple inputs from pole-mounted sensors and devices for monitoring functions. It also has one to multiple outputs for control of pole-mounted devices/systems. Feedback control is utilized to dynamically control devices when required. Devices/systems are monitored both for performance (how it is working) and functionality (whether it is working at all). If a device stops working or loses power, a signal is sent back to the controller so that appropriates steps are taken in response.

An example of such actions includes addressing light sensor operation for determining when to turn a light on and off. The controller would be programmed with the acceptable parameters, for example, resistance or voltage across the photocell over a 24 hour period. If the photocell either stopped having any resistance (open circuit) or began operating outside of the normal parameters, the controller would take alternate actions to allow the system to continue the required operation of turning the light on and off. The controller would use an on-board time clock and historical on/off data recorded in memory to continue turning the light on and off; following the “historical” schedule would be sufficiently close to the actual dawn and dusk schedule until repairs could be made. Or, the controller could ask the other utility poles in its network for their determinations of dawn and dusk, which is a real-time, not historical, approach.

Another example of such actions includes addressing the condition of batteries charged by the solar panel. The controller monitors the state of charge (for example, by coulomb counting combined with temperature) of the batteries to confirm that they are being charged properly by the solar panel. If battery voltage falls below a predetermined level, the power delivered to connected devices would be limited, for example, by dimming-down or turning off a light, to conserve energy until the solar panel or other power supply is able to charge the batteries back up to the desired level. The controller could have a hierarchical strategy for managing the connected devices/systems, including the loads, according to importance to assure that the highest-priority loads are kept on-line and lower priority devices could be shed first, for example, disconnected first.

Another example of such actions include addressing motion near a pole(s) that may signal the need for lighting or security actions. In the case of poles having motion sensors as input devices, input data from the motions sensors is analyzed by the controller for applicable actions based on this input data. The controller then provides the appropriate output data that controls other pole-mounted devices(s). Any and all control functions can be adjusted/changed by the controller based on preprogrammed algorithms according to this motion sensor input data. For example, a light fixture may be turned on at dusk and then dimmed down at midnight by the controller. After midnight, when motion is detected by the motion sensor(s), the light may then be brought back up to full brightness. This allows conservation of energy by operating the light brightly only when required. An additional example is when a security camera is mounted to the pole, wherein the camera in “standard” mode may be either inactive (not turned on) or in a passive state (not at full power or full resolution). When motion is detected, the camera could then be powered on or brought back up to full resolution.

Another example is the controller logging data for comparison to future input. For example, data related to motion sensor activity may be logged by the controller. The number and frequency of motion sensor events could be used either to start and stop control functions, or be stored for future analysis in local memory. The controller could use the motion sensor data, along with preprogrammed algorithms, to determine required device/system behaviors or outputs for specific sets/types of motion sensor events. If there are continual and a high number of motion sensor events, they may judged to be abnormal relative to the historical data logged by the controller and/or preprogrammed parameters for “normal” operation. Such abnormal events may be ignored/overridden as aberrant or dysfunctional behavior. A warning (“trouble”) signal would be sent to the system log memory for analysis or adjustment. Rather than analysis “on-pole” by the pole's own controller, the motion sensor data could optionally be wirelessly sent to a central control station for further control or monitoring functions. Thus, data can be collected from the pole's controller, or system parameters or programming may be changed, by a computer connection to the pole's controller (via RS232 port or wirelessly).

The self-diagnostic system, therefore, may comprise the infrastructure pole, the control board with input ports for monitoring and output ports for control, control devices such as relays or switches, wiring and/or connections form control board to attached devices/systems, pole-mounted devices/systems, power supply, and an interface connection point such as by serial connection (which includes RS-232, RS-485, USB, etc.) or wireless device. The computer control board may be housed inside the body of the pole so that no exterior-mounted box or enclosure is required. The pole itself provides this function, protecting the computer from the elements. An exterior door wide enough to allow the removal and replacement of the system components is provided near the bottom of the pole. The door is gasketed to prevent elements such as rain and moisture from entering the interior of the pole. The controller(s) is protected thermally and from other intrusive destructive elements by insulating and conformal coating of the board.

See, for example, FIGS. 35-37 and 58-60 for portrayals of methods and equipment that are relevant to this Example. One may note that while “control board”, “charge controller”, “control capability” and “control system” are used in various contexts in this document, the term “controller” in this document and in the claims means control apparatus and methods in a broad sense, which may be embodied in one or multiple members/boards/units provided in or on a utility unit.

### Example III

### Infrastructure Pole with Override Methods

The intelligent controller(s) of the preferred utility units or networks may have the capabilities of analyzing the state of the utility units, determine if it the utility unit (devices or systems thereof) is in a wrong or erroneous state, and to either reset the device/system or put it into a proper state. The intelligent controller can also determine whether data from the sensors are anomalous or irrational, and either ignores the sensor input or override other lower level decisions. The result of these determinations can either be sent to a central processing/control node, or be dealt with locally inside the utility unit (individual pole) itself.

Thus, the utility unit controller monitors operation (one or more operational parameters) of electrical load device on the unit, and monitors operation (one or more operational parameters) of sensor on the unit, and determines whether said each of said operational parameters are in a category of normal parameters or a category of abnormal parameters. If the operational parameters of the operation of the load device, or of the sensor, are normal, the controller continues with the mode of detection (which may be detection by the sensor or detection by the controller by otherwise monitoring the device/sensor), which triggers the controller to take control actions, that is, issue or change control settings. If the parameters are in the category of abnormal parameters, the controller enters an override mode comprising executing control actions such as resetting the electrical load device, resetting the sensor, changing power to the electrical load device, resetting a timer, resetting detection thresholds of the sensor, and ignoring said detection signal.

Certain embodiments comprise apparatus and methods for an infrastructure pole or system of poles (“utility unit(s)”), to intelligently intervene in operations of an infrastructure pole (e.g. a light pole or other utility pole). The infrastructure pole has components which generate energy, consume energy, and optionally store energy. An infrastructure pole can be any utility pole, such as a power pole, a cellular tower/pole, a light pole, a security camera pole, or any pole that facilitates power transmission, data communication, or provides a service such as providing light or security services, or any utility. Thus, the term “utility” in this Example and in the claims refers to any service for the public, a community, a business, government entity, a home, or other user of the service. The term “utility pole” includes any pole, tower, wall, or upending structure that may be adapted to hold a solar panel or other energy generation component and other components of the embodiments herein.

The infrastructure pole has at least one energy generation/source component (i.e. solar panel, wind turbine, etc.) connected to it, for example, a solar panel for charging an ESD, and/or a grid-tie to the electrical grid. The infrastructure pole has at least one energy storage device (batteries, fuels cells, capacitors, thermal storage, etc.) connected to it. The infrastructure pole has at least one component that consumes energy (e.g. light, camera, cellular transmitter, etc.) connected to it.

The infrastructure pole has built-in intelligence to assess the health of the system, the impact of environmental parameters, and to intervene in the operation of the infrastructure pole to maintain the healthy or proper operation of the infrastructure pole. The objectives are met by creating an intelligent component (i.e. computer/controller and herein broadly called “controller”) that is connected to the infrastructure pole which monitors operational and environmental variables of the infrastructure pole. The intelligent component will monitor such variables as net time a load is on, net load consumption, key events such as number events (the number of times an event occurs, reaching a threshold of occurrence triggers an action) or trigger events (i.e. from a motion sensor or security camera), time intervals between key events, etc. Based on these variables, the intelligent component will decide whether some sort of intelligent intervention is required to keep the system in a healthy operating mode, or to restore the infrastructure pole to a proper operational mode.

Specifically, an infrastructure pole with intelligence may respond to certain detected events, wherein detection events may include sensing/determination of the environment around the pole, inside the pole, or conditions of components of the utility system. Therefore, the terms “detection” and “sensing” herein and in the claims broadly include sensing by chemical, electrochemical, audio, electronic, sensing membrane(s) or materials, and other conventional sensors, and/or determination by electronic, circuitry, logic, comparison, or other means of conditions. Certain action or sets of action are triggered in response to the sensing/detection. If the detection events are anomalous events, actions taken in response to those anomalous events may set the infrastructure pole into a wrong or sub-optimal state. This can lead to degraded performance of the infrastructure pole. The intelligent component can have a built in method to ignore anomalous events or to reset the system so it does not get into a wrong or sub-optimal state. One way to determine anomalous events is a priori knowledge, typically manifested as a range of acceptable parameters or conditions, wherein detected parameters that lie outside these ranges can be considered anomalous. The second way is based on either historical or learned data, wherein the intelligent controller can gather history on how the system functions, or learn trends or precursors that tend to occur prior to the system entering a wrong or sub-optimal state.

An example of overriding detection signals to prevent degrading the utility system involves false dusk/dawn detection and “hold-off”. Specifically, if an infrastructure pole uses a light sensitive sensor (such as a photocell, or a photovoltaic panel which may itself be used to signal light or lack thereof) to help sense the arrival of dusk or dawn, temporary changes in ambient light over the sensor may cause the system to think a dusk or dawn event has happened, when in fact it was just a temporary change in ambient light. The intelligent component (controller) can have a timer delay to continue to monitor the ambient light and its trend for a period of time before deciding that a true dusk or dawn event has occurred. Thus, this may be considered a “hold-off” or delay in action until the controller is more certain of the validity of the condition being detected.

Another example of overriding detection signals to prevent degrading the utility system involves a false dawn check and recovery. The intelligent component (controller) may estimate the length of the night so that it can activate a response prior to the occurrence of dawn. This estimate could be wrong if a false dawn event is recognized by the system. The system would them be fooled, and the operation would be wrong. To surmount this, the intelligent component has method(s) to check for the validity of the detected dawn event. If the detected dawn event does not pass the validity test, based on a priori data or historical data for example, the night time length estimate is reset or recovered to keep the system from entering a wrong or sub-optimal operating state.

Another example of overriding detection signals to prevent degrading the utility system involves a light sensor failure that can result in incorrect operational state. If the infrastructure pole uses a light sensitive device to execute an operation (a photocell or the PV panel itself responding to light, for example), but the light sensitive device fails, the infrastructure pole may remain in an operating mode that will be sub-optimal and risk the health of the system. Specifically, if a load is turned on as a result of the failure of the light sensitive device and remains on because the light sensitive device can no longer send a signal that triggers the load to be turned off, that load can drain the energy storage device(s). The intelligent component (controller) has method(s) to determine the health of the light sensitive device. It can do this through a direct query to the device, or it can monitor other variables to determine that the light sensitive device no longer is operating. Once it determines that the light sensitive device is no longer operating, it overrides the normal operation by turning the load off, and does not allow it to drain the energy storage device(s).

Another example of overriding detection signals to prevent degrading the utility system involves determining that motion sensor operation is anomalous based on high number/frequency of motion events only. For example, the motion sensor may be malfunctioning, or the motion sensor may be responding to anomalous motion events (such as the movement of branches and leaves on a nearby tree). The intelligent component monitors the number and frequencies of events. It also monitors the response of the system to these events. As the number and/or frequency crosses a programmed or otherwise-input threshold or a historically-based threshold, and if the response of the system risks the system entering a sub-optimal operating state, the intelligent component intervenes to reset certain variables, ignore certain events, and restore the system to an operating mode that is proper and healthy for the infrastructure pole, in other words, overriding the motion sensor signal. Thus, these controller adaptations interrupt/override the “detect-trigger-action” mode.

Another example of overriding detection signals to prevent degrading the utility system involves shutting down device(s)/system(s) in response to power cycling, to prevent damage to ESUs. For example, when a battery-powered system turns off, the sensed voltage from the battery can often rise. This can be due to two factors. First, the sensed voltage can be measured at a point where there is some resistance between the battery and the point at which the voltage is sensed. When power is removed, the ohmic losses no longer occur, and the sensed battery voltage is higher. Second, chemical reactions in the battery reach a new state of equilibrium, and the battery voltage rises slightly. Many systems that monitor battery voltages will have a low voltage disconnect (LVD, a voltage at which the system will disconnect the load from the battery, for example, 20 VDC) to prevent excessive drainage of the battery. Those systems will also have a low voltage reconnect (LVR, a voltage at which the system will reconnect the battery to the load, for example, 22 VDC) because it thinks the battery has sufficient charge and will not be damaged. If the voltage recovery after disconnect is significant, the LVR threshold may be too low. If LVR is reached, but the battery does not have sufficient charge, the battery will cycle through many cycles of on/off (reconnect/disconnect) until the battery is not only drained but generally permanently impaired for holding charge. Setting too high of an LVR may mean that the system does not turn back on until the battery system is nearly fully charged, which may mean the system will not function during times when the customer/user needs it to function. The intelligent controller allows a reasonable level of LVR to be set to avoid this lack of function. It also detects when and if the system is starting to cycle between LVD and LVR thresholds and shuts the system down before permanent damage can be done to the battery, or overrides the LVD and LVR values based on historical data.

Monitoring one or more operational parameters of electrical load devices and entering an override mode when abnormal load operation is detected may comprise comparing said operational parameters to normal load operation by comparisons selected from the group consisting of: comparing electrical load device operation to manufacturer-specifications for operation of the electrical load device; comparing electrical load device operation to historical data regarding said electrical load device; comparing electrical load device operation to operator-input data, and comparing electrical load device operations to other like load device operations within the network. These methods apply equally well to electrical load devices (LED luminaire, video camera, Wi-Fi access point, digital display) and system components (motion sensors, ESU). For example, LED luminaire specs shows how the lumens/watt decrease over time as the electrical load device ages. For example, AGM battery specs shows how charging and discharging are affected by temperature. Therefore, in certain embodiments, one can monitor operational parameters (lumens/watt, state of charge) and compare them to manufacturer spec and raise a flag of “abnormal operation”. State of Charge (SOC) may be expressed as a percentage of the total charge capacity of the energy storage unit; SOC of 100% means the energy storage unit is fully charged to its charge holding capacity and SOC of 30% means it is charged to only 30% of its charge holding capacity, etc. Historical information is statistical, for example, after watching/recording the same manufacturer's LED luminaire connected to many poles over multiple years, any LED luminaire that operates outside of this historical envelope may be flagged as “abnormal”.

Utility unit embodiments adapted for such overriding methods may comprise the apparatus (portrayed and called-out by references numbers in various drawings of this document) and methods listed below:
1. An infrastructure pole (as discussed above, pole, tower, or upending structure) that acts as a structural element on which to attach or hang components, or in which to house components;
2. At least one energy generator such as a photovoltaic solar panel, a wind turbine, etc.; at least one ESU such as a battery, a fuel cell, a capacitor, a thermal reservoir;
3. At least one energy-consuming load, such as a light, a camera, a sensor, a transmitter, etc.;
4. An intelligent component in the infrastructure pole, such as a computer or controller (the intelligent broadly called a “controller”) that:
   a. monitors variables from the energy generator(s) like power, current, voltage;
   b. monitors variables from the energy storage unit(s) like voltage, temperature, current, certain electrochemical characteristics;
   c. monitors variables from the load(s) like current, temperature, position, operational state, certain diagnostic parameters, etc.;
   d. manages the amount of and how energy flows from generator to storage device(s) and load(s);
   e. compensates for the impact of certain variables (such as temperature, electrolyte density, storage unit's internal resistance, state of charge, number of charge-discharge cycles) on the ESU's ability to convert incoming energy into stored energy;
   f. monitors input from sensors that collect data on the environment around the infrastructure pole, such as amount of ambient light, motion of objects nearby, chemicals in the air, audio signals (voices, sirens, etc.), video signals from cameras;
   g. manages the flow of energy from the generator and/or to the loads based on the data from the sensors;
   h. can communicate with other intelligent components (computer, controllers, broadly called “controller”), for example, provided in one or more other infrastructure poles, one or more master poles if present, and/or a control station, as discussed elsewhere in this document, to interpret commands to override or augment preprogrammed algorithms and further enhance energy management of the infrastructure pole;
   i. has intelligent method(s) and algorithms to review data from the energy generator, energy storage device(s), load(s) and sensor(s), determine if the events will put the infrastructure pole in a wrong or suboptimal operating state, and intervene to ignore certain events, and/or reset the system to a proper operating state;
5. Sensors that collect information on the environment around or inside the infrastructure pole; and
6. Communication pathways between the intelligent component and all other components of the infrastructure pole.

Regarding item “h” above, utility systems/poles that have communication to a central control station (including a sub-station controlling a segment of networks in a region, for example) can have commands sent to the infrastructure pole to augment the preprogrammed energy management algorithms. For instance, an operator central control station can remotely monitor a pole to see its batteries' state of charge and how much energy it is consuming. The operator may choose to further dim the light on the pole, or dim every other light in a group of lights, or put a different type of load into another energy saving state that is not normally accessed under the current conditions.

The term “State of Charge” (SOC) will be understood by those of skill in the art, as a way of indicating the state of the energy storage unit as a portion of the total charge capacity of the energy storage unit. For example, percentage is typically used; SOC of 100% means the energy storage unit is fully charged to its charge holding capacity and SOC of 30% means it is charged to only 30% of its charge holding capacity, etc.

Regarding item “i” above, a reset action can take on at least three different levels. At one level are counters that count events; these can be reset. At another level is a state or condition, such as what energy saving modes the system is in, or what charging mode the charging system is in; both these levels can be reset without a power cycle. The last level is a reset at the system level; this can be either done by setting the parameters back to the factory default settings (does not require a power cycle), or if for some reason the system is hung-up or has downloaded a new version of firmware, it may require a power cycle.

### Example IV

### Infrastructure Pole Network with Coordinated Activities

Coordinated activities may take place among a population of solar-powered utility poles (“utility units”) that are connected wirelessly via a peer-to-peer network (e.g., wireless mesh). Each solar-powered pole can sense a variety of environmental triggers such as ambient light level (day or night) motion, noise level, temperature, relative humidity, wind speed and direction, rain, etc. Each pole also hosts one or more loads such as luminaires for lighting, video cameras for safety and security, Wi-Fi access points for end user connectivity, chemical sensors for air quality and toxin detection, etc. Individual poles may or may not have the same configuration of environmental sensors and peripherals, but each pole is a distinct node in a peer-to-peer network. Each node can send a message to another node, group of nodes or the entire network. This nearly-instant peer-to-peer communication allows nodes to share information, all while minimizing the amount of energy used via solar-powered batteries (or other ESUs) when off-grid or solar generation offsetting consumption when on-grid.

Shared information enables coordinated activities. For example, a motion trigger at the entrance to a college quad is broadcast to all poles throughout the quad, indicating the presence of a pedestrian or biker. A second motion trigger at the next pole along the path is also broadcast. Both messages include the precise global position of the pole being triggered and the time of the trigger, so the direction and speed of the passerby can be determined and used to coordinate further activities. In addition to a peer-to-peer communications protocol with precise time, location and trigger or event details, each solar-powered pole includes firmware that knows how to interpret the protocol messages and respond accordingly. In this way, a population of these poles exhibits coordinated behavior.

An example of coordinated activities is a light “halo” system 1400 provided for a boardwalk pedestrian, as illustrated in FIGS. 52A-D. A 5-mile boardwalk along the beach is frequented by walkers, bikers, roller bladers, stroller pushers and the like. At midnight, the amount of traffic slows to a trickle, nowhere near enough to warrant full time lighting. So, every 75 feet along the entire length of the boardwalk, solar-powered poles are installed with light level sensors, motions sensors and LED luminaires optimized for pathway lighting. A pedestrian enters the boardwalk and begins walking south. As he/she walks past the first solar-powered light pole (light A in FIGS. 52A-D), the light level sensor triggers nighttime and the motion sensor triggers the presence of a passerby, so the luminaire on the first solar-powered light pole is turned on 100 percent and the pedestrian can see. A message is broadcast to the other poles in the network that a motion trigger occurred, with time and precise location.

Then the pedestrian passes a second solar-powered light (light B) pole 75 feet south of the first one. The second pole's luminaire turns on 100 percent and broadcasts another message with time and precise location of the motion trigger. Now all poles in the network have sufficient information to determine a direction and an estimated speed for the pedestrian. This information is used to create a light “halo” that follows the pedestrian along the boardwalk, for example, as may be seen by the varying amounts of light in FIGS. 52A-D, as suggested by different lengths and numbers of dashed “light lines” in the figures. The light halo includes several of the solar-powered light poles at a time (for example, equal to or greater than 3 poles but typically not all the poles, or 3, 4, 5, or 6 poles). Specifically, light A is at full power in FIG. 52A, lights A and B are at full power and light C is raising to about half power in FIG. 52B. By the time the pedestrian is near light D in FIG. 52C, light C (behind the pedestrian) is lowering to about half power, lights D and E are all full power, and light F is about to be raised.

Thus, the light halo may include the one whose motion sensor just triggered, indicating where the pedestrian is at the moment, plus one or two poles in the leading direction and one or two in the following direction, for example. Light output is adjusted across the several lights to optimize lighting levels for safety while minimizing energy consumption. The light pole closest to the pedestrian is typically lighted to about 100 percent, for example. The light poles ahead of and behind the pedestrian are typically lighted to about 50-75 percent, for example. The light poles that are two ahead of and two behind the pedestrian are lighted to about 25 percent, for example. As each light pole is passed, updated motion triggers occur followed by broadcast messages so that all poles in the network can update their lighting levels and estimates for direction and speed.

In this way, a halo of light follows the pedestrian down the boardwalk. Should the pedestrian leave the boardwalk (see FIG. 52D), light E is still higher than the rest of the lights, from the latest detection of the pedestrian, and light halo will turn off after the next expected light pole motion trigger does not occur, plus a reasonable time delay to accommodate changes in pace or shoe tying or the like.

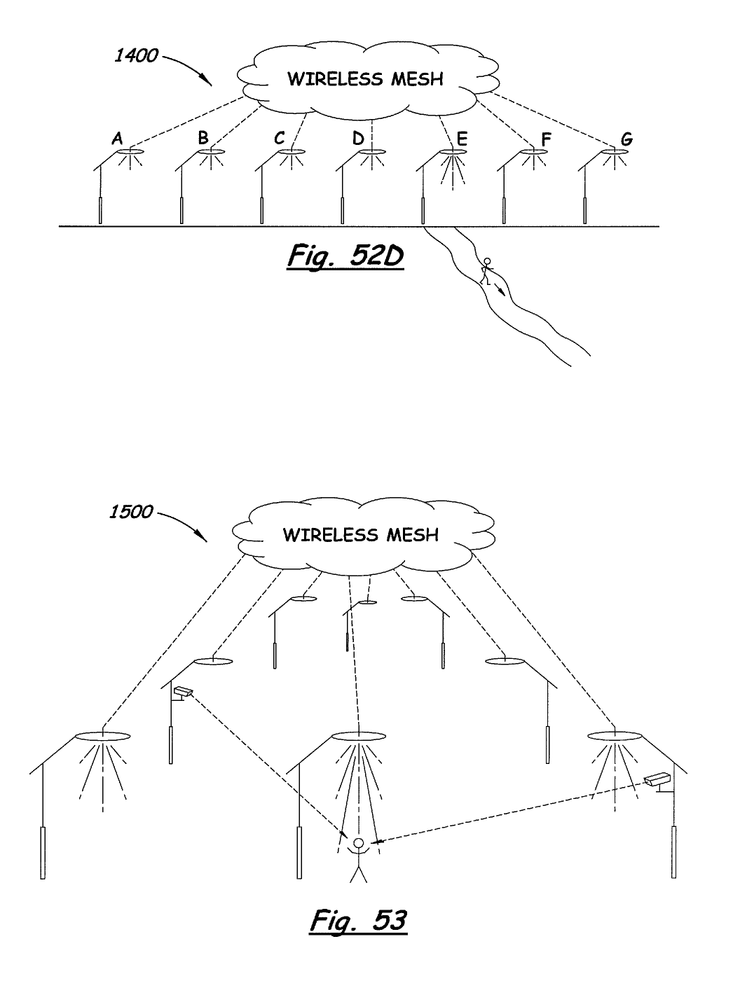

Another example of coordinated activities is a “video following” system 1500, for example, as illustrated in FIG. 53 where dashed lines represent communication between the utility units (poles) and the mesh network of “cloud”. For example, a college campus quad has four entrances, a network of paths crisscrossing the quad and a circular fountain in the middle. Along all of the pathways, every 35 feet, are solar-powered poles with LED luminaires, light level sensors and motion sensors. Plus, the first light poles inside each of the four entrances have a pan-tilt-zoom (PTZ) video camera mounted to the pole. The cameras also are connected to power and control inside the pole. Anytime activity occurs in the quad, indicated by motion triggers on nearby solar-powered peripheral poles, messages are broadcast to other poles in the network. These messages include the time and precise locations of the pole sensing the activity. If it is nighttime, nearby LED luminaire peripherals turn on. Then whether day or night the PTZ video cameras use the activity location and their own location to calculate a viewing direction and distance to focus the cameras, then increase the resolution to insure full fidelity for the event. A schematic portrayal of one embodiment of video following is in FIG. 53, wherein two camera are pointed at the “motion event”, which is a pedestrian, and the lights that are closest to the motion event/pedestrian are raised to light the motion event area. It may be noted that the poles with camera may be poles without lights, but all the poles may coordinate together for the security and safety services.

The solar-powered poles with video cameras send messages to the other video camera devices that include their calculated distance to the activity. These additional messages are used to determine the closest camera in cases where multiple activities occur in the quad simultaneously. Pan/tilt/zoom cameras (PTZ, as are known in the security field) each zoom in on and follow the closest activity. As activities move and motion trigger messages are broadcast, the video camera devices continually update their distance to the activities and follow the closest one.

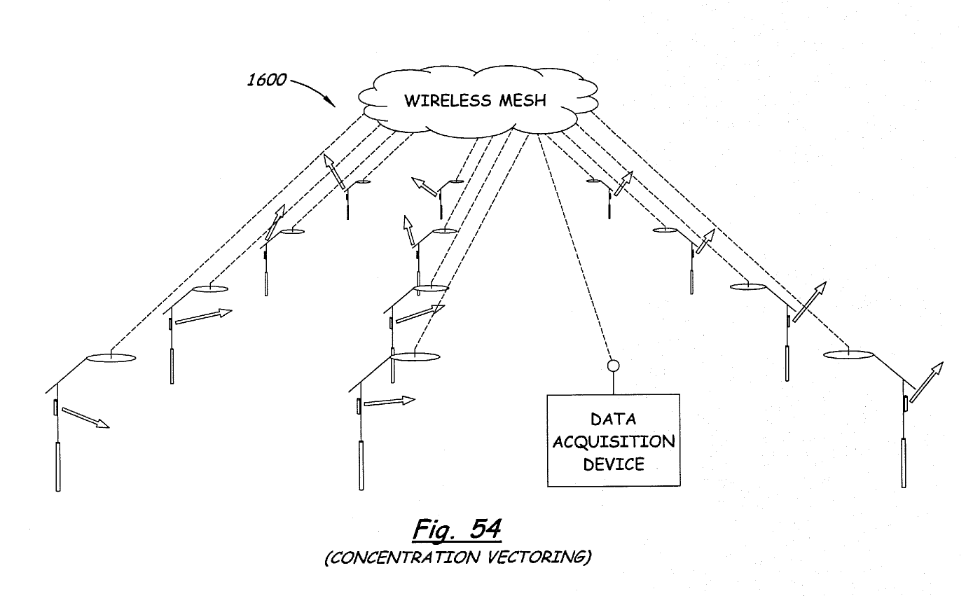

Another example of coordinated activities is a pollutant mapping system 1600 as schematically represented in FIG. 54, wherein dashed lines represent communication of the networked poles, and the arrows represent concentration vectoring. For example, throughout an intermountain west city, located in a valley that makes it susceptible to temperature inversions with associated poor air quality, most of the outdoor street, area and pathway lighting is delivered via solar-powered poles with LED luminaires and air quality sensors. These air quality sensors measure the concentrations of a host of airborne pollutants including carbon oxides, nitrogen oxides, sulfur oxides, aerosols and other particulates. At periodic predetermined intervals, each of these sensors measures a complete array of pollutant concentrations and then broadcasts these concentrations, along with a date/time and the sensor's precise location. A separate base station/control station subscribes to and receives all of these pollutant concentration messages, logs them over time and uses them to create near real time concentration vectoring maps for all pollutants as well as for each individual pollutant. This information feeds into an air quality alert system as well as to local weather modelers.

Another example of coordinated activities is coordination of lighting “on and off” times. Light level detection is the best way to determine dawn and dusk at a particular location, but doing this over a population of lights creates mild timing differences for on at dusk, off at dawn, between the lights. Using the mesh network, each solar-powered pole broadcasts its dawn and dusk detection times. All poles use these values from the last transition to calculate an average, which it uses for the next transition. This allows dawn/dusk to vary seasonally while also allowing all lights in population to turn on and off at exactly the same time.

Another example of coordinated activities involves a shared energy budget. A population of off-grid solar-powered poles in a remote location (e.g., a high-value well head) can be wired together in a way that enables the battery capacity of all of the poles to be shared to power a load device, like a security gate or electrified fence. Here the network is a wired power network rather than a wireless mesh network.

Another example of coordinated activities involves campus security dispatch. A subset of solar-power poles throughout campus include emergency call buttons. When a call button is pressed, the light on that pole and nearby poles are raised to 100% brightness, the pole with the button strobes, the precise location of the pole is wirelessly sent to the campus security office and a speaker integrated with the button opens up two-way voice communications between the pole and campus security over the wireless mesh.

Another example of coordinated activities involves what may be called “wide area power quality”. Net-metering chips inside on-grid solar-powered poles track granular power values like power, current, voltage, power factor and others and then shares this information with other poles in its network so that aggregate values and standard deviations can be calculated and tracked over time, providing early indications of impending electricity grid issues.

Coordinated activity objectives may be met by combining a solar engine for power with a wireless network for peer-to-peer communications and an intelligent controller that implements the coordination algorithms. The solar engine provides power to the wireless peer-to-peer network radio residing on each solar-powered peripheral pole, as well as power to the intelligent controller and any load devices needed for the service being performed. An off-grid solar engine is comprised of a solar collector, a charge controller and an energy storage unit (ESU) such as batteries or a super capacitor. Solar energy is captured and stored in the energy storage device and then used to power the pole and any attached loads. An on-grid solar engine also includes a solar collector, but instead of storing its collected energy in an ESU, the energy gets inverted back onto the energy grid using a micro-inverter and voltage matching transformer, thereby offsetting the energy consumption of the peripheral pole and any attached peripherals. Combining the best of both on and off-grid, the on-grid solar engine with energy storage backup utilizes both an ESU and a micro-inverter. Whenever on-grid energy is inexpensive, it gets used to top off the backup storage device. Then, when grid energy is unavailable, the backup energy in the ESU gets used to maintain peripheral service. Otherwise, the pole and attached loads use energy directly from the grid while the solar collector and micro-inverter offsets this energy consumption with energy production inverted back onto the grid.

A wireless mesh network may be peer-to-peer and therefore, a good example. In certain embodiments, any node in the network can communicate with any other node or group of nodes. This capability is integral to enabling coordinated activity algorithms since more than one node must participate. While the amount of data being transmitted for coordinated activity is small (for example, day, time, latitude, longitude, event type) transmission speed and reliability are important. Narrowband transmission expectations are for about 2 Mbit/s, as this speed can handle basic command and control capabilities. Broadband transmission expectations are consistent with 802.11n throughput or about 54 to about 600 Mbit/s. Calculations of speed and direction need to be quick in order to keep up. Therefore, each node in the wireless peer-to-peer network can be both a transmitter and a receiver so that the signal does not attenuate with each hop. The wireless radio shares an interface with the intelligent controller, which uses the radio to send, receive and interpret messages to and from other solar-powered peripheral poles. The intelligent controller does all the “heavy lifting” for coordinated activities. The intelligent controller draws its power from the solar engine, maintains an interface to the wireless radio (e.g., UART) for communications and then through interfaces with each peripheral, turns them on and off, performs other functions (e.g., pan and tilt and PTZ video camera) and reads data. The intelligent controller can also process environmental triggers such as the level of light outside, motion, temperature, etc. Inside each intelligent controller lives a processor with firmware. This firmware implements the coordinated behavior algorithms including sending and receiving messages, interpreting environmental conditions, performing calculations and taking actions like turning on a light to 25% brightness or tilting and zooming a PTZ video camera.

Many embodiments require a wirelessly connected population of solar-powered poles, each containing these main components:
1. A pole with physical mounting interfaces for various types of loads;
2. An off-grid, on-grid, or on-grid with energy backup (by ESU), solar engine;
3. A wireless radio supporting peer-to-peer networking (e.g., wireless mesh);
4. Environmental sensors such as ambient light level (day or night) motion, noise level, temperature, relative humidity, wind speed and direction, rain, etc.;
5. A processor running firmware that implements coordination algorithms; and
6. Control interface(s) to peripherals for the purpose of turning them on, off and other peripheral-specific actions.
   Data interface(s) to peripherals for the purpose of acquiring information necessary to perform the coordination algorithms such as the concentration of nitrous oxides or other pollutants in the air.

### Example V

### Portable Device and Methods for Temporary Monitoring of Infrastructure Pole

A device and methods may provide temporary wireless connectivity to a solar-powered light pole for the purpose of remotely monitoring and troubleshooting issues that arise in the field, for infrastructure poles that do not have wireless control natively inside the pole. Thus, the temporary device 1700 may be a temporary add-on for monitoring a pole's operation for a period of time, followed by removal of the device and transfer of the device to another pole. In certain embodiments, poles are installed without said “native” wireless control capability, for example, because there are just a few poles installed (and the expense of permanent wireless capability may not be justified) and/or some customers do not want continuous wireless capability on their property (for example, because of security concerns). Still, there may be a need for temporary, occasional monitoring of the pole from a control station, and certain embodiments of this device and methods may need these needs.

A schematic showing features, functions, and connections of certain embodiments of the temporary monitoring device is shown in FIG. 55, wherein the portion of the schematic normally provided natively in the pole are circled. A schematic representing one embodiment of the temporary monitoring is shown in FIGS. 56A and B.

The temporary monitoring device 1700 is placed inside the light pole, connected to pole power and other internal or external components being monitored and/or controlled, and then turned on. Additional internal and external components that are not part of the solar-powered light pole can also be connected to the device such as a Global Positioning System (GPS) component for precise coordinates or environmental sensors like temperature and humidity for correlation with other information while monitoring and troubleshooting. Once running, the device provides an Internet Protocol (IP) address that can be used with software anywhere on the Internet to remotely control, monitor and troubleshoot the solar-powered light pole having the temporary monitoring device. After monitoring and troubleshooting is complete, the device is disconnected from pole power and other internal and external components, removed from the light pole and then reused for the next infield troubleshooting or monitoring session on the same or other poles.

An additional objective of the temporary monitoring device involves only data collection. Using the temporary monitoring device, data about solar energy generation in a specific location over a period of time can be collected and compared with similar data collected at other locations. Other operational parameters can be collected centrally as well, over meaningful stretches of time, like energy consumption, power factor, harmonics, overall system net metering (consumption plus production) and temperature both inside and outside of the solar-powered light pole.

The device is capable of operating in areas where there are no data communication lines available (i.e., no a “hard-wired” system or “land-line”) as long as the device is reachable by a wireless signal such as cellular or satellite or various directed radio frequencies (e.g., 900 MHz, 2.4 GHz.). The wireless antenna is mounted outside the pole, within easy reach of the ground to alleviate the need for a ladder or lift.

Objectives of this device and methods are met by combining wireless connectivity that supports IP addressability with interfaces for communicating with solar-powered light pole components, plus power from the pole. IP-based wireless connectivity is provided in at least three ways: a cellular modem provisioned with a static IP address from a mobile carrier network, a satellite modem similarly provisioned with a static IP address and a wireless Ethernet solution that extends a nearby building's Local Area Network (LAN) out to the solar-powered light pole over a Radio Frequency (RF) signal—e.g., 900 MHz when there are a lot of obstructions, 2.4 GHz when the distance is substantial. Cellular and satellite modems have the advantage of being standalone. No nearby LAN is required and the IP address is accessible from anywhere on the Internet, but it requires airtime charges. Airtime charges can be expensive, especially when large amounts of data are being monitored over lengthy durations. Alternatively, a wireless Ethernet solution requires a nearby LAN that may or may not allow access, and the IP address is managed by the router managing the LAN, but there are no airtime charges.

Whether the wireless connectivity is cellular/satellite based or something else, the device needs an antenna with cable that meets the frequency, power and directionality of the wireless technology being used. Additionally, the antenna needs to run from the temporary monitoring device (temporarily located inside the solar-powered light pole) to the outside of the pole for successful transmit and receive operations.

Components inside and outside the solar-powered light pole have a variety of physical interfaces and communications protocols—e.g., RS-232 supporting serial communications, RJ-11 supporting MODBUS communications, Ethernet RJ-45 supporting HTML communications, etc. The device provides interfaces to physically connect to and communicate with a wide variety of components, each of which can then be accessed remotely using the IP address of the device from anywhere on the Internet.

Power for the device must come from the solar-powered light pole. Therefore, the device supports AC input power sources from 110 to 600 volts and DC input power sources from 9 to 48 volts for easy power connections. Additionally, when the solar-powered light pole is tied to the energy grid it can also track overall system consumption and production, then calculate net metering information like net watts-hours and net amp-hours.

Certain embodiments comprise:
1. An enclosure for the device that fits inside the pole;
2. An IP addressable wireless solution (e.g., cellular modem w/telemetry data plan);
3. Device-specific configuration web page;
4. Firmware to manage configuration, connection points, and power calculations;
5. Component connection points:
   a. RS-232 serial connection point;
   b. RJ-11 MODBUS connection point;
   c. RJ-45 Ethernet connection point
   d. Antenna connection point;
6. Power connection points:
   a. AC input power from 110 to 600 volts;
   b. DC input power from 9 to 48 volts;
7. Power line performance monitor for on-grid solar-powered light poles (e.g., power, current, voltage, power factor, voltage and current harmonics);
8. Net metering calculator (i.e., measure consumption and production then sum the two); and State of charge calculator for off-grid solar-powered light poles (e.g., voltage, temperature, coulomb counter).
   See the device 1700 in FIGS. 56A and B, including enclosure 1720, Serial RS-232 connector 1730, Serial/Modbus RJ-11 connector 1740, antenna 1750 (for mounting outside the unit/pole) with antenna cable, 12-24 VDC power connector 1760, power to the cellular modem 1771, and power to the MODUS adapter 1772.

### Example VI

### Metering of Energy-Usage by Loads on/in Infrastructure Pole

The intelligent controller(s) of the preferred utility units or networks may have the capabilities of monitoring the power consumed (including day/night/peak rate differentials for each electrical load device (“peripheral” utility devices added to the unit/pole), so that power consumption can be accurately billed. This also helps to provide more accurate estimates for end-of-life replacements cycles.

Certain embodiments comprise metering of energy-usage by various loads on an infrastructure pole. For example, see the metering system 1800 portrayed in FIG. 57, which comprises multiple power meters 1810. The primary objective is to capitalize on the unique streetscape advantages of on-grid outdoor lighting or other utility systems/services to provide solar-generated and metered power to offset the power consumed by a variety of peripheral devices (loads that, in addition or instead of lighting, provide a service). For example, the device may be an outdoor lighting pole, tied to the energy grid, wrapped with a flexible solar skin, and topped by a luminaire for lighting. In addition to these features, however, the pole provides connection points, at various heights or locations on the pole, with Alternating Current (AC) and Direct Current (DC) voltages and currents. Each load peripheral device, whether requiring AC or DC power, connects to one of these connection points and then physically mounts to the pole.

Solar energy generated during the day is metered as it gets inverted back onto the energy grid. Similarly, energy consumed by the luminaire and energy consumed by each of the other connected peripheral devices are individually metered. Then, the overall net energy is calculated and tracked over time, as well as the net energy attributed to each peripheral device. Adding in the local energy rates over time, yields precise net energy costs or credits for each peripheral device as well as overall net energy costs for the entire pole/system. See FIG. 57 for a schematic of the system with multiple peripheral devices and a metering system providing metering of energy for each peripheral device.

In addition to accurately tracking energy usage and cost, the metering system also tracks hours of operation. Hours of operation information is used to monitor lifetime characteristics against the peripheral devices' manufacturers' specifications. Combining hours of operation information with energy usage information can be used to predict when the peripheral device will fail or fall below some predetermined performance metric. Together, this accurate, granular usage tracking per peripheral, is used to generate billable events. The metering system stores 30 or more days-worth of data and billable events that can be retrieved locally using the Ethernet port, or remotely by plugging a connectivity device into the Ethernet port (e.g., in-ground fiber, cellular modem, RF radio.)

These objectives may be met by providing connection points, each for a peripheral device, at various locations throughout the pole, and then insuring that each connection point delivers accurately tracked and metered power in a variety of voltages and currents to meet the requirements of a wide variety of peripheral devices. Power delivered to each connection point is then offset by accurately tracked and metered solar energy generated and inverted back onto the grid.

Two ports are provided at each peripheral device connection point, with IP65 (or better) compatible plugs when not used or glands when used. The first port provides power. The second port is for data, when necessary. At the base of the pole behind the service door are terminal strips for both AC and DC power. The power ports for each live connection point are tied into the appropriate bay in either the AC or DC terminal strips depending upon voltage. The available AC voltage ranges from 110 to 600 volts while the DC voltage ranges from 9 to 48 volts.

For example, a 480 volt AC luminaire would leverage an internal connection point since the luminaire has its own built-in attach point called a tenon arm. A 480 volt power cable would run from the luminaire, through the tenon arm and down the length of the pole until it terminates behind the service door. There, the black and white AC wires would terminate at the 480 volt terminal strip and the ground to the pole's common AC grounding harness.

Or, a video camera that supports the Power Over Ethernet (POE) protocol would leverage the video connection point. Behind the service door, a POE injector would terminate its power at the 110 VAC terminal strip and its inbound Ethernet cable would be connected to a broadband radio leveraging an antenna at the antenna connection point. Then the powered Ethernet cable coming out of the POE injector would penetrate the pole using the data port at the video connection point.

Each power bay on the terminal strip is individually metered. The solar energy generation circuit is also metered, though that metering is for production rather than consumption. The net metering processor and firmware system tallies the energy produced as well as each connected peripheral's consumed energy, performs net metering calculations and stores the information in non-volatile memory for 30 or more days based on a configurable logging profile. This processor and firmware system also keeps track of hours of operation for the luminaire and each additional peripheral device and stores this information (along with net metering information), in non-volatile memory according to the logging profile.

Certain embodiments of the metering system comprise: The main components of the device are:
1. An on-grid solar-powered outdoor light;
2. An AC module comprised of a:
   a. Micro-inverter
   b. Transformer for 110 to 277 VAC
   c. Transformer for 208 to 600 VAC
   d. Metering chip and connections for solar energy generation;
3. An AC peripheral power circuit with:
   a. Transformers to match 110 to 600 VAC input power
   b. Terminal strips with bays for various voltages
   c. Metering chip and connections for each bay;
4. A DC peripheral power circuit with:
   a. AC to DC power supplies for 9 to 48 VDC
   b. Terminal strips with bays for various voltages
   c. Metering chip and connections for each bay;
5. 32-bit processor and control board with:
   a. Removable memory slot for logging (e.g., SD Micro)
   b. Ethernet port with IP addressability
   c. Firmware with algorithms for calculating absolute and net energy usage by terminal strip bay/peripheral and logging hours of operation; and
6. Connections points with power and data ports at several locations throughout the solar-powered outdoor light.

In certain embodiments, the utility system may further comprise a metering system operatively connected to the controller that is adapted to monitor power quality metrics such as power, voltage, current and power factor with high precision, as part of a wide-area measurement system. One of skill in the art will understand how to implement such a high-precision power monitoring unit (PMUs), for example, by details described at http://en.wikipedia.org/wiki/Smart grid#Phasor measurement units regarding PMUs.

### Example VII

### Wireless Infrastructure for Various Services and Multiple Energy Source Options

FIGS. 58-60 portray certain embodiments of utility units (“poles”) that provide modular or “ready-made” infrastructure for support and operation of various utility devices and services, for example, various electrically-powered loads that may be used singly or in combination for public or private services. The utility units are networked for sharing of data and/or control and/or for coordinated activities, for example, as discussed below.

FIG. 58 shows an example of wirelessly-meshed multiple utility units, wherein a selection of utility units 2010 are shown communicating as a broadband wireless mesh 2030, and a selection of utility units 2020 are shown communicating as a narrowband wireless mesh 2040. The wireless mesh network comprises multiple wireless nodes (said utility units/poles) that communicate bi-directionally with each other and/or with the control station (see multiple-protocol gateway 2050) using narrowband data transmission rates (2040) of about 2 Mbit/s, or broadband data transmission rates (2030) in the range of about 54 to about 600 Mbit/s. These communications are peer-to-peer. Any wireless node can communicate with any other wireless node, including the control station, for two-way gathering and dissemination of data and/or analysis of data. In turn, the control station communicates bi-directionally with the Internet 2060 over a cellular modem provisioned with a static IP address from a mobile carrier network 2080. These communications are point-to-point, cellular modem to the Internet. As each unit/pole/wireless node may have one or more load devices that may sense or otherwise gather data, and because the units may be spread out over large regions and operate over large expanses of time, the data-gathering capabilities of these networks are great.

Each unit/pole 2010, 2020 includes a controller located on or in the utility unit that conducts two-way communication (typically wired) with the electrical load device(s) and two-way wireless mesh communications with one or more other units/poles in a network as well as the control station, or multi-protocol gateway. Load devices like LED luminaires and pollution sensors do not require high data rates during two-way communications. The amount of data being monitored is small, and the frequency at which data needs to be communicated is low, so these wireless mesh communications can utilize a narrowband protocol that consumes less energy. Load devices like streaming video cameras and digital displays, on the other hand, do require high data rates when streaming real time video or digital display content. The amount of data being moved and the frequency (i.e., real time) requires the wireless mesh communications to utilize a broadband protocol. The control station or multi-protocol gateway is a wireless mesh node too. It participates in two-way communications among units/poles in a network. Furthermore, the multi-protocol gateway may have a narrowband wireless radio and a broadband wireless radio, allowing it to communication with two separate wireless mesh networks over two different wireless protocols, but it will always have at least one wireless radio. The multi-protocol gateway also can communicate bi-directionally with the Internet 2060 over a cellular modem provisioned with a static IP address from a mobile carrier network 2080. These wireless communications utilize yet another type of wireless protocol called a cellular protocol. There are a number of different cellular protocols depending upon the mobile carrier and the country involved. So the multi-protocol gateway always communicates using two wireless protocols (e.g., narrowband wireless and cellular) and sometimes more. The mobile carrier network connects the two-way communications over the cellular protocol with the Internet and any cloud services 2070 residing there. Cloud services 2070 such as scheduling on and off times of load devices on many units/poles and monitoring operational data from load devices on many units/poles leverage these two-way communications over multiple protocols in order to perform their functions.

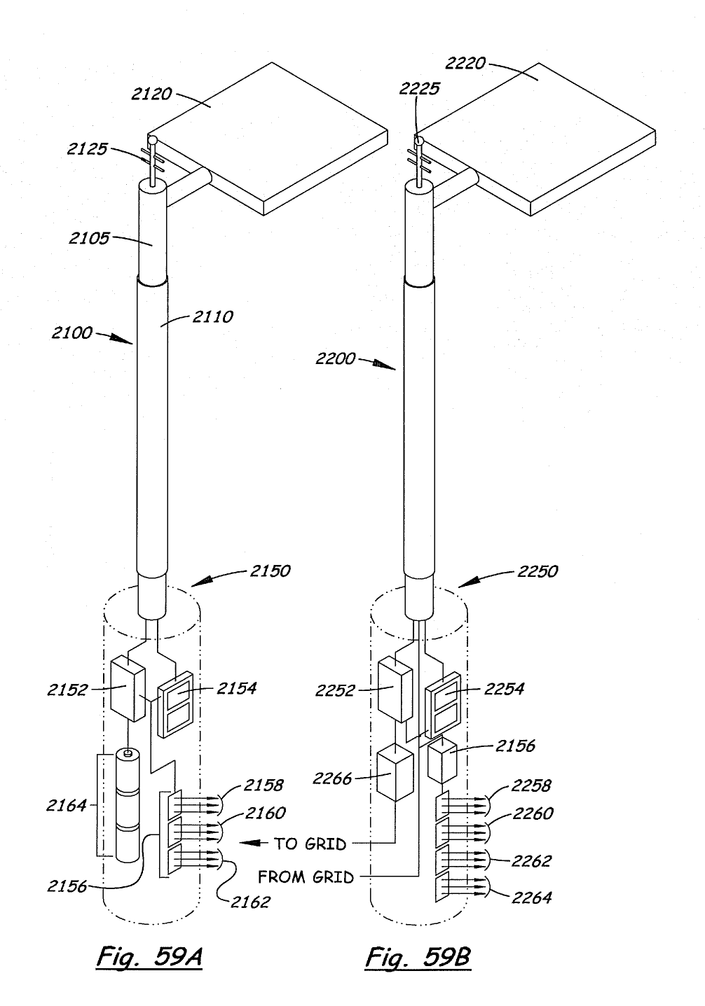

FIGS. 59A and B portray in more detail examples of the utility units of FIG. 58. The utility unit 2100 in FIG. 59A is not tied to the grid, while the utility unit 2200 is tied to the grid. Either of these types of units 2100, 2200 may be installed in the network system of FIG. 58, for example.

Unit 2100 comprises a pole member 2105 having a PV panel 2110 wrapped around it from a level above the base 2150 (dash-dot lines) to near the top of the pole member. A luminaire 2120 and an antenna 2125 are provided at the top of the pole member. Inside the base 2150 are a charge controller 2152, a peripheral device (load) controller 2154, and terminal blocks 2156, specifically for 9 VDC (2158), for 12 VDC (2160) and for 24 VDC (2162). Also in the base of unit 2100 are batteries 2164, which may be AGM and Lithium Iron-Phosphate batteries, for example. In certain embodiments, the peripheral device controller 2154 may be considered “the controller”, but in other embodiments, the peripheral device controller 2154 plus the charge controller 2152 combined may be considered “the controller”, and in certain embodiments, the peripheral device controller 2154 plus the charge controller 2152 plus any control capability in or on or adjacent to the pole may be considered “the controller”.

Unit 2200 comprises a pole member, PV panel, base 2250, a luminaire 2220, and an antenna 2225, that are similar or the same as those in unit 2100. Inside base 2250 are a micro-inverter 2252, a peripheral device (load) controller 2254, and a power supply 2156 (AC to 9/12/24/48 VDC), and 9 VDC terminal 2258, 12 VDC terminal 2260, 24 VDC terminal 2262, and 48 VDC terminal 2264, and a transformer (120-480 VAC) 2266, One may especially note, in unit 2200, the grid-tie lines labeled “to grid” and “from grid”.

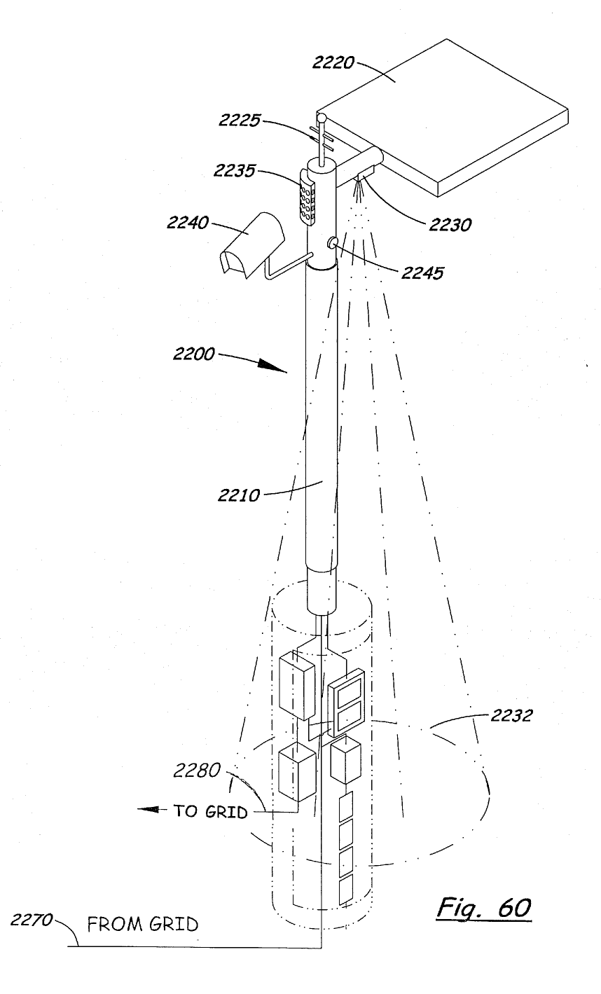

FIG. 60 shows one of the grid-tied units 2200 supporting multiple loads, in this case, all above the PV panel 2210, to illustrate the point that the utility units and networks of utility units are versatile and “modular” in that they can provide multiple services customized for many client and environments. For example, a motion sensor 2230 is shown under the arm of the luminaire 2220, wherein the generally cone-shaped region of motion-detection 2232 (not necessarily to scale) is shown in dash-dot lines. A sensor unit 2235 that comprises one or more chemical/element sensors, water/moisture sensors, for example, is installed near the top of the pole member. A video security camera 2240 is installed above the top of the PV panel. “Currently-unused” connection point 2245, in capped and sealed condition, is also shown above the top of the PV panel, and is available for yet another load. Connection point 2245 is representative of how a unit may be provided with multiple connection points, which provide access to internal wiring in the pole, for example, and to which different loads may be connected depending on the particular use, client, or environment of the utility unit 2200. As in FIG. 59B, one may note the grid-tie lines of the unit 2200, a from-grid line 2270 and a to-grid line 2280.

It will be understood by those of skill in the art after reading and viewing this document including the figures, that the apparatus and network of Example VII may be used in many of the embodiments described in the other Examples and methods of this document, for example, self-diagnosis, overriding, coordinated activities, and energy metering.

In view of the foregoing description, certain embodiments of the invention may be described as a utility system for powering at least one electrical load device, the utility system comprising at least one utility unit comprising: a pole; at least one power source comprising a photovoltaic (PV) panel curved at least part way around a generally vertical surface of the pole; a controller operatively connecting said electrical load device to said at least one power source; wherein the controller is adapted for two-way communication between the controller and said electrical load device; and wherein the controller is adapted to control consumption by said electrical load device of energy from said at least one power source.

The PV panel may be a flexible, thin-film photovoltaic material(s) curved at least 90 degrees around the generally vertical surface of the pole. The PV panel may have an efficiency in sunshine in the range of 5%-50%. In certain embodiments, the controller may be adapted to throttle (reduce power) or otherwise reduce energy consumption of the utility unit when the ESU falls to a state of charge (SOC) in the range of 5-20% above a minimum safe SOC, said minimum safe SOC being a charge level below which damage occurs to the ESU. wherein the utility unit further comprises a motion sensor and a light sensor and wherein said load device is an outdoor light, said controller being adapted to turn on said light at about dusk as determined by a light sensor at a reduced brightness in the range of 50-80% of full brightness, and then to dim the outdoor light down to a range of 5%-25% of full brightness after a predetermined amount of time and throughout the nighttime except for times when said motion sensor senses motion near said pole.

The load device may be selected, for example, from a group of: a luminaire, a light emitting diode (LED), an HID light source, a fluorescent light source, a mercury vapor light source, a gas light source, a glow discharge light source, a solid state light, an organic-compound light-emitting light, an OLED light source, a security device, a camera, a security camera, an audio recorder, a video recorder, a wireless network radio, an antenna, a low bandwidth radio, a high bandwidth radio, a radio transmitting in multiple bandwidths, a WIFI modem, a wireless transceiver, an alarm, an electronic sign, an electronic display, a power line communication modem that enables two-way communications over power line electrical wires, emergency call box or button, two-way voice transmitter; a Wi-fi access point, a sound sensor, an environmental sensor, a temperature sensor, a humidity sensor, a wind speed sensor, a wind direction sensor, an air quality sensor, and a sensor of one or more air pollutants. The utility unit may further comprise a sensor selected from a group consisting of: a light-sensitive sensor, a motion sensor, a sensor of one or more chemical compounds, a temperature sensor, a wind speed sensor, a wind direction sensor, a humidity/moisture sensor, a sound sensor, a sensor of physical contact by an object or person with the pole, wherein said sensor is operatively connected to the controller to send a detection signal to said controller when the sensor detects a change in the environment of the pole, that triggers the controller to change a control setting for said load device so that the first electrical load device operates differently after said trigger. The change in control setting may be selected, for example, from the group consisting of one or more of: turning on said load device, reducing power to said load device, raising power to said load device, moving said load device, moving a portion of said load device, executing one or more subroutines in said load device, and turning off said load device.

Two-way communication between a controller and control station may comprise transmissions of data from the control station to the controller selected from the group consisting of: sensor signals; error signals; set-points for controlling said load device; firm-ware; soft-ware; one or more executable subroutines; instructions for overriding a sensor; instructions and set-points for protecting an ESU from damage; system reset instructions; component reset instructions; reset motion event count; clear sensor reading; light sensor thresholds for dawn and dusk; motion sensor thresholds for motion event trigger; hysteresis and maximum triggers per time; override commands for on and off; commands for reducing energy consumption; and commands for scheduled-event changes. Said two-way communication between the controller and the control station may be done by narrowband at a data transmission rate in the range of about 2 Mbit/s or by broadband at a data transmission rate in the range of about 54 to about 600 Mbit/s, typically depending on the communication rate requirements of the load(s). A control station may comprise an internet connection, wherein said utility system comprises multiple of said utility units in a wireless mesh network with said control station, wherein the control station is adapted to wireless two-way communication with one or more of the multiple utility units; said two-way communication being selected from a group consisting of: sensor signals; energy usage data for a load; error signals; set-points for controlling said load device; firm-ware; soft-ware; one or more executable subroutines; instructions for overriding a sensor; instructions and set-points for protecting an ESU from damage; system reset instructions; component reset instructions; reset motion event count; clear sensor reading; light sensor thresholds for dawn and dusk; motion sensor thresholds for motion event trigger; hysteresis and maximum triggers per time; override commands for on and off; commands for reducing energy consumption; and commands for scheduled-event changes. The wireless mesh network may be adapted for coordinated activities between said multiple utility units, wherein a sensor signal from at least one of the utility units causes the controller of at least one other utility unit to change a control setting for one or more electrical load devices of said at least one other utility units to change performance of the one or more electrical load devices.

Certain embodiments may be described as a utility system for powering electrical load devices, the utility system comprising a plurality of utility units networked for coordinated activities, wherein each utility unit comprises a pole having at least one electrical load device powered by at least one power source, said at least one power source comprising a photovoltaic (PV) panel curved at least part way around a generally vertical surface of each pole; each utility unit further having a controller and a sensor adapted to send a sensor signal to the controller; wherein the controllers of the plurality of utility units are wirelessly connected in a mesh network adapted so that the sensor of one of the utility units detecting a change in the environment of that utility unit triggers the controller of that utility unit to signal controllers of other of the utility units in the mesh network so that selected utility units operate differently after said trigger. Triggered controllers may modify operation of the electrical load devices of said selected utility units by changing at least one control setting for said electrical load devices of the selected utility units. The wireless mesh network is a peer-to-peer network wherein each of the utility units are all nodes of the network. A utility system may also comprise a control station in two-way communication with each of the utility units, the wireless mesh network being a peer-to-peer network wherein each of the utility units and the control station are all nodes of the network.

Certain embodiments may be described as a utility system comprising at least one utility unit comprising: a pole; at least one source comprising a photovoltaic (PV) panel curved at least part way around a generally vertical surface of the pole; an electrical load device connected to the pole; a controller operatively connecting said electrical load device to said at least one power source; a sensor operatively connected to the controller to send a detection signal to said controller when the sensor detects a change in the environment of the infrastructure pole; wherein the controller is adapted to monitor one or more operational parameters of said electrical load device and the sensor and to determine whether said operational parameters are in a category of normal parameters or a category of abnormal parameters; wherein, when the parameters are in the category of normal parameters, the controller is adapted to be triggered by the detection signal or by said operational parameters of the electrical load device to change control settings for the electrical load device; and wherein, when the parameters are in the category of abnormal parameters, the controller enters an override mode comprising executing control actions selected from the group consisting of: resetting the electrical load device, resetting the sensor, changing power to the electrical load device, resetting a timer, resetting detection thresholds of the sensor, and ignoring said detection signal. The operational parameters may be selected, for example, from the group of: amount of time said electrical load device is turned on; time of day the electrical load device is turned on; consumption of energy by said electrical load device; number of times said controller is triggered to change a control setting of said electrical load device by the operational parameters of the electrical load device; frequency of the sensor sending a detection signal; time between detection signals. Determining whether said operational parameters are in a category of normal parameters or a category of abnormal parameters may comprise comparing said operational parameters to normal operating parameters by comparisons selected from the group consisting of: comparing electrical load device operation to manufacturer-specifications for the electrical load device; comparing electrical load device operation to historical data regarding said electrical load device; comparing electrical load device operation to operator-input data; comparing sensor operation to manufacturer-specifications for the sensor; comparing sensor operation to historical data regarding said sensor; comparing sensor operation to operator-input data; and comparing electrical load device operations to other like load device operations within the network.

The at least one power source for powering an electrical load device (one or more) preferably comprises a PV panel that is operatively connected to the electrical load device. Said operative connection is typically an indirect operative connection, for example, wherein the PV panel charges an energy storage unit(s) and the energy storage unit(s) power(s) the electrical load device. This is preferred (compared to a direct connection between the PV panel and the load device) because PV panel power generation is currently not sufficiently consistent to directly power most of the loads such as desired for the utility; in other words, for consistency of load operation, an indirect operation connection through an energy storage device is desired. The at least one power source may also comprise a grid tie to the electrical grid, and/or an energy storage unit (ESU), for example, the one involved in an indirect operative connection of the PV panel to the load and optionally charged by one or more other power sources, and/or an ESU provided in addition to that used for the PV panel power. An operative connection, therefore, in this document including in the claims, may be a direct operative connection or an indirect operative connection, for example, includes intermediate (intervening) equipment or control.

Certain embodiments have been described herein mainly in terms of apparatus, while other embodiments have been described herein mainly in terms of methods. Those of skill in the art will recognize that methods of using the apparatus and/or methods of providing the apparatus and/or using the control actions, controller adaptations, utility services, diagnostics, overriding techniques, and/or cooperated activities to accomplish the disclosed results and/or other results, are included as embodiments of the invention and may be claimed as such.

Other embodiments of the invention will be apparent to one of skill in the art after reading this disclosure and viewing the drawings. Although this invention is described herein and in the drawings with reference to particular means, methods, materials and embodiments, it is to be understood that the invention is not limited to these disclosed particulars, but extends instead to all equivalents within the broad scope of the following claims.

1. A utility system for powering at least one electrical load device, the utility system comprising at least one utility unit comprising:
a pole;
at least one power source comprising a photovoltaic (PV) panel curved at least part way around a generally vertical surface of the pole an electrical load device connected to the pole;
a controller operatively connecting said electrical load device to said at least one power source;
wherein the controller is adapted for two-way communication between the controller and said electrical load device; and
wherein the controller is adapted to control consumption by said electrical load device of energy from said at least one power source.

2. A utility system as in claim 1, further comprising:
a control station comprising a computer having an internet connection, wherein the controller is adapted for two-way communication between the controller and the control station.

3. A utility system as in claim 1, wherein said operative connection of the electrical load device to said at least one power source comprises the PV panel charging an energy storage unit (ESU) and the ESU being connected to the electrical load device.

4. A utility system as in claim 1, wherein said PV panel is a flexible, thin-film photovoltaic material(s) curved at least 90 degrees around the generally vertical surface of the pole, and has an efficiency in sunshine in the range of 5%-50%.

5. A utility system as in claim 2, wherein the two-way communication between the controller and the control station, and the controller and the load device comprises narrowband communication at a data transmission rate in the range of about 2 Mbit/s, or broadband communication at a data transmission rate in the range of about 54 to about 600 Mbit/s.

6. A utility system as in claim 1, wherein said at least one power source comprises a grid tie to the electrical grid, and the controller is adapted to provide power from the PV panel to the electrical grid through the grid tie during at least some daylight hours, and said controller is adapted to provide power from the electrical grid through said grid tie to said load device during at least some nighttime hours.

7. A utility system as in claim 1, wherein said at least one power source comprises an energy storage unit (ESU), and the controller is adapted to provide power from the PV panel to charge the ESU during at least some daylight hours, and the controller is adapted to provide power from the ESU to said load device during at least some nighttime hours.

8. A utility system as in claim 1, wherein said at least one power source further comprises an energy storage unit (ESU) and a grid tie to the electrical grid, and wherein the controller is adapted to provide power from the PV panel to charge the ESU and to the electrical grid through the grid tie during at least some daylight hours, and the controller is adapted to provide power to said load device from the ESU.

9. A utility system as in claim 8, wherein the controller is further adapted to provide power to said load device from the electrical grid through the grid tie during at last some of hours that are non-peak-demand hours of the electrical grid.

10. A utility system as in claim 8, wherein the controller is further adapted to charge the ESU from power from the electrical grid through the grid tie.

11. A utility system as in claim 7, wherein the first electrical load device comprises an outdoor light and wherein said controller is adapted to dim or turn off said outdoor light when said ESU falls to a state of charge (SOC) in the range of 5-20% above a minimum safe SOC, said minimum safe SOC being a charge level below which damage occurs to the ESU.

12. A utility system as in claim 7, wherein the utility unit further comprises a motion sensor on said pole, the controller being adapted to determine an amount of power reduction for said load device when the motion sensor is not sensing motion near the pole, the amount of power reduction based on state of charge of said ESU.

13. A utility system as in claim 7, comprising multiple energy storage units (ESUs) and wherein the controller is adapted to disconnect any of said multiple ESUs that fail.

14. A utility system as in claim 7, wherein the utility unit further comprises at least one additional electrical load device at or near said pole powered by said at least one power source, and wherein the controller is adapted to shed at least one of the load devices, by turning off power to said at least one of the load devices based on state of charge of said ESU.

15. A utility system as in claim 7, wherein the utility unit further comprises a motion sensor and a light sensor and wherein said load device is an outdoor light, said controller being adapted to turn on and bring said outdoor light to full brightness at about dusk as determined by a light sensor, and then to dim the outdoor light down to 50% or less brightness down after a predetermined amount of time and throughout the nighttime except for times during the nighttime when said motion sensor senses motion near said pole.

16. A utility system as in claim 7, wherein the utility unit further comprises a motion sensor and a light sensor and wherein said load device is an outdoor light, said controller being adapted to turn on said light at about dusk as determined by a light sensor at a reduced brightness in the range of 50-80% of full brightness, and then to dim the outdoor light down to a range of 5%-25% of full brightness after a predetermined amount of time and throughout the nighttime except for times when said motion sensor senses motion near said pole.

17. A utility system as in claim 1, wherein said load device is selected from a group consisting of: a luminaire, a light emitting diode (LED), an HID light source, a fluorescent light source, a mercury vapor light source, a gas light source, a glow discharge light source, a solid state light, an organic-compound light-emitting light, an OLED light source, a security device, a camera, a security camera, an audio recorder, a video recorder, a wireless network radio, an antenna, a low bandwidth radio, a high bandwidth radio, a radio transmitting in multiple bandwidths, a WIFI modem, a wireless transceiver, an alarm, an electronic sign, an electronic display, a power line communication modem that enables two-way communications over power line electrical wires, emergency call box or button, two-way voice transmitter; a Wi-fi access point, a sound sensor, an environmental sensor, a temperature sensor, a humidity sensor, a wind speed sensor, a wind direction sensor, an air quality sensor, and a sensor of one or more air pollutants.

18. A utility system as in claim 1, wherein the utility unit further comprises a sensor selected from a group consisting of: a light-sensitive sensor, a motion sensor, a sensor of one or more chemical compounds, a temperature sensor, a wind speed sensor, a wind direction sensor, a humidity/moisture sensor, a sound sensor, a sensor of physical contact by an object or person with the pole, wherein said sensor is operatively connected to the controller to send a detection signal to said controller when the sensor detects a change in the environment of the pole, that triggers the controller to change a control setting for said load device so that the first electrical load device operates differently after said trigger.

19. A utility system as in claim 18, wherein said change in control setting is selected from the group consisting of one or more of: turning on said load device, reducing power to said load device, raising power to said load device, moving said load device, moving a portion of said load device, executing one or more subroutines in said load device, and turning off said load device.

20. A utility system as in claim 17, wherein the utility unit further comprises a wireless transceiver and a control station comprising a computer having an internet connection, wherein said controller is adapted for two-way communication between the controller and the control station; and wherein said detection signal triggers the controller to cause the transceiver to transmit information to the control station.

21. A utility system as in claim 20, wherein said information is selected from the group consisting of: real-time data from said sensor, and data from the sensor logged over a period of time by the controller.

22. A utility system as in claim 1, wherein the utility unit further comprises a motion sensor on said pole and operatively connected to said controller;
wherein said controller is adapted, in response to said motion sensor sensing motion near the pole, to change a control setting for said electrical load device so that said load device operates differently at least while said motion is detected compared to how said load device operates before motion is detected.

23. A utility system as in claim 1, wherein the pole is an existing infrastructure pole and the PV panel is provided on an outer surface of a retrofit-collar that is hung on the outside of said existing infrastructure pole, wherein the retrofit-collar extends at least part way round said existing infrastructure pole.

24. A utility system as in claim 6, wherein the pole is an existing infrastructure pole and the PV panel is provided on an outer surface of a retrofit-collar that is hung on the outside of said existing infrastructure pole, wherein the retrofit-collar extends at least part way round said existing infrastructure pole.

25. A utility system as in claim 7, wherein the pole is an existing infrastructure pole and the PV panel is provided on an outer surface of a retrofit-collar that is hung on the outside of said existing infrastructure pole, wherein the retrofit-collar extends at least part way round said existing infrastructure pole and comprising said ESU, wherein the ESU is selected from the group consisting of: one or more energy storage units, one or more batteries, one or more capacitors, one or more fuel cells, and one or more devices that store and release hydrogen.

26. A utility system as in claim 8, wherein the pole is an existing infrastructure pole and the PV panel is provided on an outer surface of a retrofit-collar that is hung on the outside of said existing infrastructure pole, the retrofit-collar extending at least part way round said existing infrastructure pole and comprising said ESU, wherein the ESU is selected from the group consisting of: one or more energy storage units, one or more batteries, one or more capacitors, one or more fuel cells, and one or more devices that store and release hydrogen.

27. A utility system as in claim 26, wherein said existing infrastructure pole is an existing street light pole connected to an electrical grid, and said load device is a light on the existing street light pole.

28. A utility system as in claim 1, wherein said load device is a security camera, and the utility system further comprises a motion sensor, wherein said controller is adapted, in response to said motion sensor sensing motion near the pole, to change a control setting for said security camera, the change in control setting being one or more of the group consisting of: turning on the security camera, moving the security camera to point generally toward said motion, and focusing at a distance generally corresponding to said motion.

29. A utility system as in claim 6, wherein the utility unit further comprises a metering system operatively connected to the controller that is adapted to measure amount of energy delivered from the PV panel to the electrical grid, and adapted to measure amount of energy delivered from the electrical grid to said load device.

30. A utility system as in claim 7, wherein the utility unit further comprised a metering system operatively connected to the controller that is adapted to measure amounts of energy delivered from the PV panel and the ESU to said load device.

31. A utility system as in claim 10, wherein the utility unit further comprises a metering system operatively connected to the controller that is adapted to measure amount of energy delivered from the PV panel to the electrical grid, and adapted to measure amounts of energy delivered from the electrical grid to said load device and to the ESU.

32. A utility system as in claim 8, wherein the utility unit further comprises a metering system operatively connected to the controller that is adapted to monitor power quality metrics such as power, voltage, current and power factor with high precision, as part of a wide-area measurement system.

33. A utility system as in claim 29, further comprising a control station comprising a computer having an internet connection, wherein the controller is adapted for two-way communication between the controller and the control station, and wherein said two-way communication of the controller with the control station comprises transmission of the measured amounts of energy to the control station.

34. A utility system as in claim 30, further comprising a control station comprising a computer having an internet connection, wherein the controller is adapted for two-way communication between the controller and the control station, and wherein said two-way communication of the controller with the control station comprises transmission of the measured amounts of energy to the control station.

35. A utility system as in claim 31, further comprising a control station comprising a computer having an internet connection, wherein the controller is adapted for two-way communication between the controller and the control station, and wherein said two-way communication of the controller with the control station comprises transmission of the measured amounts of energy to the control station.

36. A utility system as in claim 1, wherein the utility unit further comprises at least one additional electrical load device attached to the pole, where the controller operatively connects said at least one additional electrical load device to said at least one power source;
wherein the controller is adapted for two-way communication between the controller and said at least one additional electrical load device;
wherein the controller is adapted to control consumption by said at least one additional electrical load device of energy from said at least one power sources; and
wherein the utility unit further comprises a metering system operatively connected to the controller that is adapted to separately measure amounts of energy delivered to each of the load devices from said at least one power source.

37. A utility system as in claim 36, further comprising a control station comprising a computer having an internet connection, wherein the controller is adapted for two-way communication between the controller and the control station, and wherein said two-way communication of the controller with the control station comprises transmission of the measured amounts of energy to the control station.

38. A utility system as in claim 37, wherein said two-way communication between the controller and the control station further comprises transmissions of data from the control station to the controller selected from the group consisting of: sensor signals; error signals; set-points for controlling said load device; firm-ware; soft-ware; one or more executable subroutines; instructions for overriding a sensor; instructions and set-points for protecting an ESU from damage; system reset instructions; component reset instructions; reset motion event count; clear sensor reading; light sensor thresholds for dawn and dusk; motion sensor thresholds for motion event trigger; hysteresis and maximum triggers per time; override commands for on and off; commands for reducing energy consumption; and commands for scheduled-event changes.

39. A utility system as in claim 37, wherein said two-way communication between the controller and the control station is done by narrowband at a data transmission rate in the range of about 2 Mbit/s or by broadband at a data transmission rate in the range of about 54 to about 600 Mbit/s.

40. A utility system as in claim 1, further comprising a control station comprising an internet connection, wherein said utility system comprises multiple of said utility units in a wireless mesh network with said control station, wherein the control station is adapted to wireless two-way communication with one or more of the multiple utility units; said two-way communication being selected from a group consisting of: sensor signals; energy usage data for a load; error signals; set-points for controlling said load device; firm-ware; soft-ware; one or more executable subroutines; instructions for overriding a sensor; instructions and set-points for protecting an ESU from damage; system reset instructions; component reset instructions; reset motion event count; clear sensor reading; light sensor thresholds for dawn and dusk; motion sensor thresholds for motion event trigger; hysteresis and maximum triggers per time; override commands for on and off; commands for reducing energy consumption; and commands for scheduled-event changes.

41. A utility system as in claim 40, wherein said wireless mesh network is adapted for coordinated activities between said multiple utility units, wherein a sensor signal from at least one of the utility units causes the controller of at least one other utility unit to change a control setting for one or more electrical load devices of said at least one other utility units to change performance of the one or more electrical load devices.

42. A utility system for powering electrical load devices, the utility system comprising a plurality of utility units networked for coordinated activities,
wherein each utility unit comprises a pole having at least one electrical load device powered by at least one power source, said at least one power source comprising a photovoltaic (PV) panel curved at least part way around a generally vertical surface of each pole;
each utility unit further having a controller and a sensor adapted to send a sensor signal to the controller;
wherein the controllers of the plurality of utility units are wirelessly connected in a mesh network adapted so that the sensor of one of the utility units detecting a change in the environment of that utility unit triggers the controller of that utility unit to signal controllers of other of the utility units in the mesh network so that selected utility units operate differently after said trigger.

43. A utility system as in claim 42, wherein the triggered controllers modify operation of the electrical load devices of said selected utility units by changing at least one control setting for said electrical load devices of the selected utility units.

44. A utility system as in claim 43, wherein the electrical load devices of said selected utility units comprise luminaires and the triggered controllers increase power to the luminaires.

45. A utility system as in claim 43, wherein the electrical load devices of said selected utility units comprise security cameras and said sensor signal is a motion sensor signaling a detected motion, and the triggered controllers change operation of the security cameras by one or more actions selected from a group consisting of: turning on, panning, tilting, and zooming.

46. A utility system as in claim 42, wherein the wireless mesh network is a peer-to-peer network wherein each of the utility units are all nodes of the network.

47. A utility system as in claim 42, further comprising a control station in two-way communication with each of the utility units, the wireless mesh network being a peer-to-peer network wherein each of the utility units and the control station are all nodes of the network.

48. A utility system for powering at least one electrical load device, the utility system comprising at least one utility unit comprising:
a pole;
at least one power source comprising a photovoltaic (PV) panel curved at least part way around a generally vertical surface of the pole;
an electrical load device connected to the pole;
a controller operatively connecting said electrical load device to said at least one power source;
a sensor operatively connected to the controller to send a detection signal to said controller when the sensor detects a change in the environment of the infrastructure pole;
wherein the controller is adapted to monitor one or more operational parameters of said electrical load device and the sensor and to determine whether said operational parameters are in a category of normal parameters or a category of abnormal parameters;
wherein, when the parameters are in the category of normal parameters, the controller is adapted to be triggered by the detection signal or by said operational parameters of the electrical load device to change control settings for the electrical load device; and
wherein, when the parameters are in the category of abnormal parameters, the controller enters an override mode comprising executing control actions selected from the group consisting of: resetting the electrical load device, resetting the sensor, changing power to the electrical load device, resetting a timer, resetting detection thresholds of the sensor, and ignoring said detection signal.

49. A utility system as in claim 48, wherein said operational parameters are selected from the group consisting of: amount of time said electrical load device is turned on; time of day the electrical load device is turned on; consumption of energy by said electrical load device; number of times said controller is triggered to change a control setting of said electrical load device by the operational parameters of the electrical load device; frequency of the sensor sending a detection signal; time between detection signals.

50. A utility system as in claim 48, wherein said electrical load device of the utility unit comprises a luminaire and said override mode comprises reducing power to or turning off the electrical load device to conserve energy from said at least one power source.

51. A utility system as in claim 48, wherein determining whether said operational parameters are in a category of normal parameters or a category of abnormal parameters comprises comparing said operational parameters to normal operating parameters by comparisons selected from the group consisting of: comparing electrical load device operation to manufacturer-specifications for the electrical load device; comparing electrical load device operation to historical data regarding said electrical load device; comparing electrical load device operation to operator-input data; comparing sensor operation to manufacturer-specifications for the sensor; comparing sensor operation to historical data regarding said sensor; comparing sensor operation to operator-input data; and comparing electrical load device operations to other like load device operations within the network.
